(19) United States
(12) Patent Application Publication
(10) Pub. No.: US 2016/0116445 A1
(43) Pub. Date: Apr. 28, 2016

(54) Photoacoustic Imager and Photoacoustic Image Construction Method

(71) Applicant: PreXion Corporation, Tokyo (JP)

(72) Inventor: Toshitaka AGANO, Tokyo (JP)

(21) Appl. No.: 14/919,877

(22) Filed: Oct. 22, 2015

(30) Foreign Application Priority Data
Oct. 23, 2014 (JP) 2014-216519
Oct. 23, 2014 (JP) 2014-216599
Oct. 23, 2014 (JP) 2014-216685

(51) Int. Cl. G01N 29/44; G01N 29/24; G01N 29/06

(52) U.S. Cl. CPC G01N 29/4463; G01N 29/0654; G01N 29/2418

(57) ABSTRACT

A photoacoustic imager includes a light source portion, a detection portion that detects a photoacoustic wave signal caused by a photoacoustic wave generated from a detection object in a specimen that absorbs light applied from the light source portion, and a signal processing portion that corrects a reduction in the signal intensity of the photoacoustic wave signal resulting from attenuation of the photoacoustic wave and generates a photoacoustic wave image by prescribed signal processing.

### BACKGROUND OF THE INVENTION

1. Field of the Invention

The present invention relates to a photoacoustic imager and a photoacoustic image construction method.

2. Description of the Background Art

An ultrasonic diagnostic apparatus that obtains an image of the inside of a specimen caused by an ultrasonic wave reflected in the specimen is known in general, as disclosed in Japanese Patent Laying-Open No. 2001-104303.

Japanese Patent Laying-Open No. 2001-104303 discloses an ultrasonic diagnostic apparatus including a plurality of vibrating elements that emits ultrasonic pulses into a specimen and detects ultrasonic waves reflected in the specimen, a probe including the plurality of vibrating elements, and a signal processing portion that acquires received signals (ultrasonic signals) of the ultrasonic waves reflected in the specimen through the probe and obtains an image of the inside of the specimen caused by the reflected ultrasonic waves. This ultrasonic diagnostic apparatus is configured to perform phasing addition on the ultrasonic signals when obtaining the image of the inside of the specimen. Thus, the S/N ratio (signal/noise ratio) of the ultrasonic signals is improved, and a clear image can be obtained.

Furthermore, a photoacoustic imager is known as an apparatus that obtains an image of the inside of a specimen in general. This photoacoustic imager is configured to obtain the image of the inside of the specimen by applying light into the specimen through a surface of the specimen and detecting a photoacoustic wave (ultrasonic wave) generated from a detection object in the specimen. The photoacoustic wave denotes an ultrasonic wave generated by light absorption into the detection object in the specimen.

Even if a technology of signal processing such as phasing addition in the ultrasonic diagnostic apparatus described in the aforementioned Japanese Patent Laying-Open No. 2001-104303 is applied to the conventional photoacoustic imager, for example, a clear image might be obtained.

In the conventional photoacoustic imager, however, the intensity of the photoacoustic wave generated by light application is small. The signal intensity of detected photoacoustic wave signals is disadvantageously enormously reduced by attenuation of the photoacoustic wave generated between generation of the photoacoustic wave in the specimen and detection of the photoacoustic wave as compared with that of ultrasonic signals detected by the ultrasonic diagnostic apparatus. Therefore, in the conventional photoacoustic imager, a sufficiently clear image cannot be obtained simply by applying the signal processing such as phasing addition in the ultrasonic diagnostic apparatus.

### SUMMARY OF THE INVENTION

The present invention has been proposed in order to solve the aforementioned problem, and an object of the present invention is to provide a photoacoustic imager and a photoacoustic image construction method each capable of obtaining a clear photoacoustic wave image.

In order to attain the aforementioned object, a photoacoustic imager according to a first aspect of the present invention includes a light source portion, a detection portion that detects a photoacoustic wave signal caused by a photoacoustic wave generated from a detection object in a specimen that absorbs light applied from the light source portion, and a signal processing portion that corrects a reduction in the signal intensity of the photoacoustic wave signal resulting from attenuation of the photoacoustic wave and generates a photoacoustic wave image by prescribed signal processing.

As hereinabove described, the photoacoustic imager according to the first aspect of the present invention is provided with the signal processing portion that corrects a reduction in the signal intensity of the photoacoustic wave signal resulting from attenuation of the photoacoustic wave and generates the photoacoustic wave image by the prescribed signal processing. Thus, a reduction in the signal intensity of the photoacoustic wave signal resulting from attenuation of the photoacoustic wave is corrected, and a clear photoacoustic wave image can be obtained.

In the aforementioned photoacoustic imager according to the first aspect, the signal processing portion is preferably configured to correct a reduction in the signal intensity of the photoacoustic wave signal resulting from attenuation of the photoacoustic wave on the basis of at least one of a detection time required for the detection portion to detect the photoacoustic wave signal and the signal frequency of the photoacoustic wave signal. A reduction (the amount of reduction) in the signal intensity of the photoacoustic wave signal resulting from attenuation of the photoacoustic wave varies according to the detection time or the signal frequency. According to the above structure, therefore, a reduction in the signal intensity of the photoacoustic wave signal resulting from attenuation of the photoacoustic wave can be reliably corrected on the basis of a reduction (the amount of reduction) in the signal intensity of the photoacoustic wave signal resulting from attenuation of the photoacoustic wave.

In this case, the signal processing portion is preferably configured to correct a reduction in the signal intensity of the photoacoustic wave signal resulting from attenuation of the photoacoustic wave by increasing the signal intensity of the photoacoustic wave signal according to an increase in the value of at least one of the detection time and the signal frequency. According to this structure, the signal intensity of photoacoustic wave signal reduced by attenuation of the photoacoustic wave can be increased according to a reduction (the amount of reduction) in the signal intensity increased as the value of at least one of the detection time and the signal frequency is increased. Consequently, a reduction in the signal intensity of the photoacoustic wave signal resulting from attenuation of the photoacoustic wave can be more reliably corrected according to a reduction (the amount of reduction) in the signal intensity of the photoacoustic wave signal resulting from attenuation of the photoacoustic wave.

In the aforementioned photoacoustic imager according to the first aspect, the prescribed signal processing preferably includes phasing addition, and the signal processing portion is preferably configured to correct a reduction in the signal intensity of the photoacoustic wave signal resulting from attenuation of the photoacoustic wave and to generate the photoacoustic wave image by performing phasing addition on the photoacoustic wave signal that is corrected. According to this structure, even if the photoacoustic wave generated in the specimen attenuates before reaching the detection portion, a reduction in the signal intensity of the photoacoustic wave signal resulting from attenuation of the photoacoustic wave can be corrected. Consequently, phasing addition can be performed on the photoacoustic wave signal in which a reduction in the signal intensity is corrected, and hence the clear photoacoustic wave image can be obtained by phasing addition.

In this case, the signal processing portion is preferably configured to increase the signal intensity of the photoacoustic wave signal according to increases in the values of a detection time required for the detection portion to detect the photoacoustic wave signal and the signal frequency of the photoacoustic wave signal by multiplying the photoacoustic wave signal by a correction coefficient Z1 expressed by the following formula (1), Z1=10^{k1×t×f} . . . (1), where the detection time is t, the signal frequency is f, a constant related to the detection time and the signal frequency is k1, a unit of the detection time t is μs, a unit of the signal frequency f is MHz, and the constant k1 is at least 0.002 and not more than 0.009.

According to this structure, the signal intensity of the photoacoustic wave signal can be increased according to both the detection time and the signal frequency by the aforementioned formula (1). Consequently, a reduction in the signal intensity of the photoacoustic wave signal resulting from attenuation of the photoacoustic wave can be still more reliably corrected according to a reduction (the amount of reduction) in the signal intensity of the photoacoustic wave signal resulting from attenuation of the photoacoustic wave. Furthermore, the constant k1 is at least 0.002 and not more than 0.009, whereby the correction coefficient Z1 can be properly acquired.

In the aforementioned structure in which the prescribed signal processing includes phasing addition, the detection portion preferably includes a detection element configured to receive the photoacoustic wave and detect the photoacoustic wave signal caused by the photoacoustic wave, and the signal processing portion is preferably configured to correct a reduction in the signal intensity of the photoacoustic wave signal resulting from the sensitivity of the detection element on the basis of the sensitivity caused by the incident direction of the photoacoustic wave with respect to the detection element in addition to correcting a reduction in the signal intensity of the photoacoustic wave signal resulting from attenuation of the photoacoustic wave. According to this structure, even if the signal intensity of the detected photoacoustic wave signal is reduced by a difference in the sensitivity of the detection element caused by the incident direction of the photoacoustic wave with respect to the detection element, a reduction in the signal intensity of the photoacoustic wave signal resulting from the sensitivity of the detection element can be corrected. Consequently, a reduction in the signal intensity of the photoacoustic wave signal resulting from the sensitivity of the detection element can be corrected in addition to correcting a reduction in the signal intensity of the photoacoustic wave signal resulting from attenuation of the photoacoustic wave. Therefore, a reduction in the signal intensity of the photoacoustic wave signal can be more properly corrected.

In the aforementioned photoacoustic imager according to the first aspect, the prescribed signal processing preferably includes processing employing a statistical method for making an approximation while repetitively performing signal conversion processing for generating an evaluation image with which an evaluation is made by comparison with the photoacoustic wave signal and converting the evaluation image that is generated into a projection signal to be compared with the photoacoustic wave signal and processing for generating the evaluation image that is new by performing imaging processing for imaging a signal based on a result of comparison between the projection signal of the evaluation image and the photoacoustic wave signal, and the signal processing portion is preferably configured to correct the signal intensity of the projection signal of the evaluation image to respond to a reduction in the signal intensity of the photoacoustic wave signal resulting from attenuation of the photoacoustic wave during the signal conversion processing and to generate the photoacoustic wave image by the statistical method.

The photoacoustic wave has a property of significantly attenuating when propagating in the specimen, as compared with a radial ray. Therefore, a reduction in the signal intensity of the photoacoustic wave signal is generated by attenuation of the photoacoustic wave. In the signal conversion processing performed to convert the evaluation image into the projection signal during the processing employing the statistical method, on the other hand, no reduction in the signal intensity of the projection signal of the evaluation image is generated. Thus, a comparison result including an inaccurate difference is obtained when the above projection signal of the evaluation image is simply compared with the above photoacoustic wave signal. In this case, the photoacoustic wave image generated by the processing employing the statistical method includes the inaccurate difference.

The inventor has found that the signal processing portion is configured to correct the signal intensity of the projection signal of the evaluation image to respond to a reduction in the signal intensity of the photoacoustic wave signal resulting from attenuation of the photoacoustic wave during the signal conversion processing, as described above, focusing on the above phenomenon. According to this structure, the signal intensity of the projection signal of the evaluation image is corrected to respond to a reduction in the signal intensity of the photoacoustic wave signal resulting from attenuation of the photoacoustic wave, and hence an accurate comparison result can be acquired when the projection signal of the evaluation image is compared with the photoacoustic wave signal. Consequently, the clear photoacoustic wave image can be generated. Furthermore, the photoacoustic wave image is generated by the processing employing the statistical method, whereby resolution related to imaging is improved in addition to be capable of generating the clear photoacoustic wave image, and hence an increase in the number of detection elements can be significantly reduced or prevented. In addition, the resolution is improved, and hence a clearer photoacoustic wave image can be generated even when a wide angular detection range is detected, as compared with the case where the photoacoustic wave image is generated by processing employing an analytical method.

In this case, the signal processing portion is preferably configured to correct the signal intensity of the projection signal of the evaluation image to respond to a reduction in the signal intensity of the photoacoustic wave signal resulting from attenuation of the photoacoustic wave by reducing the signal intensity of the projection signal of the evaluation image according to an increase in the value of at least one of a detection time required for the detection portion to detect the photoacoustic wave signal and the signal frequency of the photoacoustic wave signal during the signal conversion processing. The signal intensity of the photoacoustic wave signal resulting from attenuation of the photoacoustic wave is reduced as the detection time or the signal frequency is increased. Therefore, according to the structure of correcting the signal intensity of the projection signal of the evaluation image according to the detection time or the signal frequency, the signal intensity of the projection signal of the evaluation image can be more properly corrected to respond to a reduction in the signal intensity of the photoacoustic wave signal resulting from attenuation of the photoacoustic wave according to a reduction (the amount of reduction) in the signal intensity of the photoacoustic wave signal resulting from attenuation of the photoacoustic wave.

In the aforementioned photoacoustic imager according to the first aspect, the prescribed signal processing preferably includes a backprojection method, and the signal processing portion is preferably configured to correct a reduction in the signal intensity of the photoacoustic wave signal resulting from attenuation of the photoacoustic wave and to generate the photoacoustic wave image by the backprojection method on the basis of the photoacoustic wave signal that is corrected. According to this structure, even if the photoacoustic wave generated in the specimen attenuates before reaching the detection portion, a reduction in the signal intensity of the photoacoustic wave signal resulting from attenuation of the photoacoustic wave can be corrected. Consequently, the signal processing employing the backprojection method can be performed on the photoacoustic wave signal in which a reduction in the signal intensity is corrected, and hence the clear photoacoustic wave image can be obtained by the backprojection method.

In this case, the signal processing portion is preferably configured to increase the signal intensity of the photoacoustic wave signal according to increases in the values of a detection time required for the detection portion to detect the photoacoustic wave signal and the signal frequency of the photoacoustic wave signal by multiplying the photoacoustic wave signal by a correction coefficient Z1 expressed by the following formula (2), Z1=h×t×10^{k1×t×f} . . . (2), where a constant related to the velocity of sound is h, the detection time is t, the signal frequency is f, a constant related to the detection time and the signal frequency is k1, a unit of the detection time t is μs, a unit of the signal frequency f is MHz, and the constant k1 is at least 0.002 and not more than 0.009.

According to this structure, the signal intensity of the photoacoustic wave signal can be increased according to both the detection time and the signal frequency by the aforementioned formula (2). Consequently, a reduction in the signal intensity of the photoacoustic wave signal can be still more reliably corrected according to a reduction (the amount of reduction) in the signal intensity of the photoacoustic wave signal resulting from attenuation of the photoacoustic wave. Furthermore, the constant k1 is at least 0.002 and not more than 0.009, whereby the correction coefficient Z1 can be properly acquired. In the aforementioned formula (1), the term of (h×t) is provided, whereby signal processing can be properly performed according to the characteristics of the backprojection method.

In the aforementioned photoacoustic imager according to the first aspect, the signal processing portion is preferably configured to correct a reduction in the signal intensity of the photoacoustic wave signal resulting from attenuation of the light applied from the light source portion according to an increase in a distance from the position of the light applied from the light source portion to the specimen to a prescribed position in the specimen in addition to correcting a reduction in the signal intensity of the photoacoustic wave signal resulting from attenuation of the photoacoustic wave. According to this structure, even if the light applied from the light source portion attenuates before reaching the detection object in the specimen, a reduction in the signal intensity of the photoacoustic wave signal resulting from attenuation of the light applied from the light source portion can be corrected. Consequently, a reduction in the signal intensity of the photoacoustic wave signal resulting from attenuation of the light applied from the light source portion can be corrected in addition to correcting a reduction in the signal intensity of the photoacoustic wave signal resulting from attenuation of the photoacoustic wave. Therefore, a reduction in the signal intensity of the photoacoustic wave signal can be more properly corrected.

In this case, the signal processing portion is preferably configured to correct a reduction in the signal intensity of the photoacoustic wave signal resulting from attenuation of the light applied from the light source portion according to an increase in the distance from the position of the light applied from the light source portion to the prescribed position in the specimen by multiplying the photoacoustic wave signal by a correction coefficient Z2 expressed by the following formula (3), Z2=10^{k2×d} . . . (3), where a constant related to the position of the light applied from the light source portion is k2 and the distance from the position of the light applied from the light source portion to the prescribed position in the specimen is d.

According to this structure, a reduction in the signal intensity of the photoacoustic wave signal resulting from attenuation of the light applied from the light source portion can be reliably corrected according to a reduction (the amount of reduction) in the signal intensity resulting from attenuation of the light applied from the light source portion by the aforementioned formula (3).

In the aforementioned structure in which the constant related to the position of the light applied from the light source portion is k2, the constant k2 is preferably at least 0.2 and not more than 0.8 when the position of the light applied from the light source portion is on a side closer to the detection portion and a unit of the distance d from the position of the light applied from the light source portion to the prescribed position in the specimen is cm, and the constant k2 is preferably at least −0.8 and not more than −0.2 when the position of the light applied from the light source portion is on a side opposite to the detection portion, the distance from the position of the light applied from the light source portion to the prescribed position in the specimen in the case where the position of the light applied from the light source portion is on the side closer to the detection portion is d, and the unit of the distance d from the position of the light applied from the light source portion to the prescribed position in the specimen is cm. According to this structure, the correction coefficient Z2 can be properly acquired according to the position of the light applied from the light source portion. Consequently, the signal intensity of the photoacoustic wave signal reduced by attenuation of the light applied from the light source portion can be properly increased.

In the aforementioned photoacoustic imager according to the first aspect, a plurality of detection elements configured to receive the photoacoustic wave and detect the photoacoustic wave signal caused by the photoacoustic wave are preferably arranged in the detection portion, and the width of the light source portion in an arrangement direction in which the plurality of detection elements are arranged is preferably larger than the width of the plurality of detection elements in the arrangement direction. According to this structure, the light from the light source portion can be reliably applied to an entire region of the plurality of detection elements in the arrangement direction. Consequently, insufficient generation of the photoacoustic wave from the detection object in a range detectable by the plurality of detection elements caused by a small amount of applied light in the range detectable by the plurality of detection elements can be significantly reduced or prevented. Thus, the plurality of detection elements can properly detect the detection object in the range detectable by the plurality of detection elements.

In the aforementioned photoacoustic imager according to the first aspect, the light source portion preferably includes at least one of a light-emitting diode element, a semiconductor laser element, and an organic light-emitting diode element as a light source. According to this structure, advantageously, the power consumption of the light source can be reduced while the light source portion can be downsized, as compared with the case where a solid-state laser light source is employed. When the light-emitting diode element, the semiconductor laser element, or the organic light-emitting diode element is employed as the light source, an output of light applied from the light source is reduced as compared with the case where the solid-state laser light source is employed. Thus, the signal intensity of the photoacoustic wave signal detected by the detection portion is further reduced. Therefore, when the light-emitting diode element, the semiconductor laser element, or the organic light-emitting diode element is employed as the light source, the present invention that can obtain the clear photoacoustic wave image by correcting a reduction in the signal intensity is particularly effective.

A photoacoustic imager according to a second aspect of the present invention includes a light source portion that applies light to a specimen, a detection portion that detects a photoacoustic wave signal caused by a photoacoustic wave generated by absorption of the light applied from the light source portion to the specimen by a detection object in the specimen, and a signal processing portion that generates a photoacoustic wave image by processing employing a statistical method for making an approximation while repetitively performing signal conversion processing for generating an evaluation image with which an evaluation is made by comparison with the photoacoustic wave signal and converting the evaluation image that is generated into a projection signal to be compared with the photoacoustic wave signal and processing for generating the evaluation image that is new by performing imaging processing for imaging a signal based on a result of comparison between the projection signal of the evaluation image and the photoacoustic wave signal. Furthermore, the signal processing portion is configured to correct the signal intensity of the projection signal of the evaluation image to respond to a reduction in the signal intensity of the photoacoustic wave signal resulting from attenuation of the photoacoustic wave during the signal conversion processing.

The photoacoustic wave has a property of significantly attenuating when propagating in the specimen, as compared with a radial ray. Therefore, a reduction in the signal intensity of the photoacoustic wave signal is generated by attenuation of the photoacoustic wave. In the signal conversion processing performed to convert the evaluation image into the projection signal during the processing employing the statistical method, on the other hand, no reduction in the signal intensity of the projection signal of the evaluation image is generated. Thus, a comparison result including an inaccurate difference is obtained when the above projection signal of the evaluation image is simply compared with the above photoacoustic wave signal. In this case, the photoacoustic wave image generated by the processing employing the statistical method includes the inaccurate difference.

The inventor has found that the signal processing portion is configured to correct the signal intensity of the projection signal of the evaluation image to respond to a reduction in the signal intensity of the photoacoustic wave signal resulting from attenuation of the photoacoustic wave during the signal conversion processing, as described above, focusing on the above phenomenon. According to this structure, the signal intensity of the projection signal of the evaluation image is corrected to respond to a reduction in the signal intensity of the photoacoustic wave signal resulting from attenuation of the photoacoustic wave, and hence an accurate comparison result can be acquired when the projection signal of the evaluation image is compared with the photoacoustic wave signal. Consequently, a clear photoacoustic wave image can be generated. Furthermore, the photoacoustic wave image is generated by the processing employing the statistical method, whereby resolution related to imaging is improved in addition to be capable of generating the clear photoacoustic wave image, and hence an increase in the number of detection elements can be significantly reduced or prevented. In addition, the resolution is improved, and hence a clearer photoacoustic wave image can be generated even when a wide angular detection range is detected, as compared with the case where the photoacoustic wave image is generated by processing employing an analytical method.

In the aforementioned photoacoustic imager according to the second aspect, the signal processing portion is preferably configured to correct the signal intensity of the projection signal of the evaluation image to respond to a reduction in the signal intensity of the photoacoustic wave signal resulting from attenuation of the photoacoustic wave by reducing the signal intensity of the projection signal of the evaluation image according to an increase in the value of at least one of a detection time required for the detection portion to detect the photoacoustic wave signal and the signal frequency of the photoacoustic wave signal during the signal conversion processing. The signal intensity of the photoacoustic wave signal resulting from attenuation of the photoacoustic wave is reduced as the detection time or the signal frequency is increased. Therefore, according to the structure of correcting the signal intensity of the projection signal of the evaluation image according to the detection time or the signal frequency, the signal intensity of the projection signal of the evaluation image can be more properly corrected to respond to a reduction in the signal intensity of the photoacoustic wave signal resulting from attenuation of the photoacoustic wave according to a reduction (the amount of reduction) in the signal intensity of the photoacoustic wave signal resulting from attenuation of the photoacoustic wave.

In this case, the signal processing portion is preferably configured to reduce the signal intensity of the projection signal of the evaluation image according to increases in the values of the detection time and the signal frequency by multiplying the projection signal of the evaluation image by a correction coefficient Z1 expressed by the following formula (4), Z1=10^{-(k1×t×f)} . . . (4), where the detection time is t, the signal frequency is f, a constant related to the detection time and the signal frequency is k1, a unit of the detection time t is μs, a unit of the signal frequency f is MHz, and the constant k1 is at least 0.002 and not more than 0.009.

According to this structure, the signal intensity of the projection signal of the evaluation image can be easily corrected by multiplying the projection signal of the evaluation image by the correction coefficient Z1 obtained by the aforementioned formula (4) during the signal conversion processing. Furthermore, the constant k1 is at least 0.002 and not more than 0.009, whereby the correction coefficient Z1 can be properly acquired.

In the aforementioned photoacoustic imager according to the second aspect, the signal processing portion is preferably configured to generate an initial evaluation image that is a first evaluation image by performing processing employing an analytical method on the photoacoustic wave signal. According to this structure, the processing employing the statistical method can be started from a state where the initial evaluation image is further approximated to the photoacoustic wave image, unlike the case where the initial evaluation image is set to a prescribed image not based on the photoacoustic wave signal. Consequently, the time required for the processing employing the statistical method can be reduced, and hence the photoacoustic wave image can be generated in less time.

A photoacoustic image construction method according to a third aspect of the present invention includes detecting, by a detection portion, a photoacoustic wave signal caused by a photoacoustic wave generated from a detection object in a specimen that absorbs light applied from a light source portion, and correcting, by a signal processing portion, a reduction in the signal intensity of the photoacoustic wave signal resulting from attenuation of the photoacoustic wave and generating, by the signal processing portion, a photoacoustic wave image by prescribed signal processing.

As hereinabove described, the photoacoustic image construction method according to the third aspect of the present invention is provided with correcting, by the signal processing portion, a reduction in the signal intensity of the photoacoustic wave signal resulting from attenuation of the photoacoustic wave and generating, by the signal processing portion, the photoacoustic wave image by the prescribed signal processing. Thus, a reduction in the signal intensity of the photoacoustic wave signal resulting from attenuation of the photoacoustic wave can be corrected, and a clear photoacoustic wave image can be obtained.

In the aforementioned photoacoustic imager according to the first aspect, another structure described below is conceivable.

More specifically, in the aforementioned structure of employing the correction coefficient Z1, in which the prescribed signal processing includes the backprojection method, the constant h is preferably set to at least 0.1 and not more than 0.2 when a unit of the constant h is cm/μs, and when a value obtained by multiplying the constant h by the detection time t is smaller than a prescribed value, the value obtained by multiplying the constant h by the detection time t is preferably set to the prescribed value. According to this structure, the value of the constant h is properly set, and hence the correction coefficient Z1 can be more properly acquired.

In this case, the prescribed value is preferably at least 0.5 and not more than 1.5. According to this structure, the value of the constant h is more properly set, and hence the correction coefficient Z1 can be still more properly acquired.

In the aforementioned structure in which the prescribed signal processing includes the backprojection method, the detection portion preferably includes a detection element configured to receive the photoacoustic wave and detect the photoacoustic wave signal caused by the photoacoustic wave, and the signal processing portion is preferably configured to generate the photoacoustic wave image by the backprojection method in consideration of sensitivity caused by the incident direction of the photoacoustic wave with respect to the detection element in addition to correcting a reduction in the signal intensity of the photoacoustic wave signal resulting from attenuation of the photoacoustic wave. According to this structure, a difference in the sensitivity of the detection element caused by the incident direction of the photoacoustic wave can be considered when the photoacoustic wave image is generated by the backprojection method, and hence the photoacoustic wave image closer to an actual condition in the specimen can be obtained. Consequently, the photoacoustic wave image closer to the actual condition in the specimen can be obtained by considering the sensitivity caused by the incident direction of the photoacoustic wave with respect to the detection element while the sharpness of the photoacoustic wave image is improved by correcting a reduction in the signal intensity of the photoacoustic wave signal resulting from attenuation of the photoacoustic wave.

In the aforementioned photoacoustic imager according to the second aspect, another structure described below is conceivable.

More specifically, in the aforementioned photoacoustic imager according to the second aspect, the signal processing portion is preferably configured to correct the signal intensity of the projection signal of the evaluation image to respond to a reduction in the signal intensity of the photoacoustic wave signal resulting from attenuation of the light applied from the light source portion by correcting the signal intensity of the projection signal of the evaluation image according to a distance from the position of the light applied from the light source portion to the specimen to a prescribed position in the specimen in addition to correcting the signal intensity of the projection signal of the evaluation image to respond to a reduction in the signal intensity of the photoacoustic wave signal resulting from attenuation of the photoacoustic wave. According to this structure, even if the light from the light source portion attenuates before reaching the detection object in the specimen, the signal intensity of the projection signal of the evaluation image can be corrected to respond to a reduction in the signal intensity of the photoacoustic wave signal resulting from attenuation of the light applied from the light source portion. Consequently, a more accurate comparison result can be acquired when the projection signal of the evaluation image is compared with the photoacoustic wave signal, and hence the clear photoacoustic wave image can be more reliably generated.

In this case, the signal processing portion is preferably configured to correct the signal intensity of the projection signal of the evaluation image according to the distance from the position of the light applied from the light source portion to the prescribed position in the specimen by multiplying the projection signal of the evaluation image by the correction coefficient Z2 expressed by the following formula (5), Z2=10^{-(k2×d)} . . . (5), where the constant related to the position of the light applied from the light source portion is k2 and the distance from the position of the light applied from the light source portion to the prescribed position in the specimen is d. According to this structure, the signal intensity of the projection signal of the evaluation image can be easily corrected according to a reduction (the amount of reduction) in the signal intensity resulting from attenuation of the light applied from the light source portion by the aforementioned formula (5).

In the aforementioned photoacoustic imager configured to reduce the signal intensity of the projection signal of the evaluation image by multiplying the projection signal of the evaluation image by the correction coefficient Z2, the constant k2 is preferably set to at least 0.2 and not more than 0.8 when the position of the light applied from the light source portion is on a side closer to the detection portion and a unit of the distance d from the position of the light applied from the light source portion to the prescribed position in the specimen is cm. Furthermore, the constant k2 is preferably set to at least −0.8 and not more than −0.2 when the position of the light applied from the light source portion is on a side opposite to the detection portion, the distance from the position of the light applied from the light source portion to the prescribed position in the specimen in the case where the position of the light applied from the light source portion is on the side closer to the detection portion is set to d, and a unit of the distance d from the position of the light applied from the light source portion to the prescribed position in the specimen is cm. According to this structure, the correction coefficient Z2 can be properly acquired according to the position of the light applied from the light source portion. Consequently, the signal intensity of the projection signal of the evaluation image can be more properly corrected to respond to a reduction in the signal intensity of the photoacoustic wave signal resulting from attenuation of the light applied from the light source portion.

In the aforementioned photoacoustic imager according to the second aspect, the detection portion preferably includes a detection element configured to receive the photoacoustic wave and detect the photoacoustic wave signal caused by the photoacoustic wave, and the signal processing portion is preferably configured to correct the signal intensity of the projection signal of the evaluation image to respond to a reduction in the signal intensity of the photoacoustic wave signal resulting from the sensitivity of the detection element on the basis of the sensitivity caused by the incident direction of the photoacoustic wave with respect to the detection element in addition to correcting the signal intensity of the projection signal of the evaluation image to respond to a reduction in the signal intensity of the photoacoustic wave signal resulting from attenuation of the photoacoustic wave. According to this structure, even if the signal intensity of the detected photoacoustic wave signal is reduced by a difference in the sensitivity of the detection element caused by the incident direction of the photoacoustic wave with respect to the detection element, the signal intensity of the projection signal of the evaluation image can be corrected to respond to a reduction in the signal intensity of the photoacoustic wave signal resulting from the sensitivity of the detection element.

In the aforementioned photoacoustic imager according to the second aspect, the detection portion is preferably configured to generate the photoacoustic wave signal including an RF signal on the basis of the detected photoacoustic wave, and the signal processing portion is preferably configured to generate the photoacoustic wave image by the processing employing the statistical method based on the photoacoustic wave signal including the RF signal. Generally, fine information (such as information indicating the phase of the signal) contained in the RF (radio frequency) signal may be lost when the RF signal is demodulated (detected). If the photoacoustic wave image is generated by the processing employing the statistical method based on the photoacoustic wave signal including the RF signal, as in the present invention, on the other hand, the photoacoustic wave image can be generated without losing the fine information contained in the RF signal. Thus, the clearer photoacoustic wave image can be generated. The RF signal generally denotes a high-frequency signal, but in this description, the RF signal denotes a high-frequency signal that is a non-demodulated (non-detected) RF signal.

In the aforementioned photoacoustic imager according to the second aspect, the detection portion is preferably configured to generate the RF signal on the basis of the detected photoacoustic wave, the photoacoustic imager is preferably configured to generate the photoacoustic wave signal including a demodulation (detection) signal obtained by demodulating (detecting) the RF signal, and the signal processing portion is preferably configured to generate the photoacoustic wave image by the processing employing the statistical method based on the photoacoustic wave signal including the demodulation signal. According to this structure, the data capacity of the demodulation signal is smaller than that of the RF signal, and hence due to a reduction in data capacity, the capacity of a memory included in the photoacoustic imager can be reduced.

In the aforementioned photoacoustic image construction method according to the third aspect, another structure described below is conceivable.

More specifically, in the aforementioned photoacoustic image construction method according to the third aspect, correcting, by the signal processing portion, a reduction in the signal intensity of the photoacoustic wave signal resulting from attenuation of the photoacoustic wave and generating, by the signal processing portion, the photoacoustic wave image by the prescribed signal processing preferably includes correcting, by the signal processing portion, a reduction in the signal intensity of the photoacoustic wave signal resulting from attenuation of the photoacoustic wave and generating, by the signal processing portion, the photoacoustic wave image by performing phasing addition on the photoacoustic wave signal that is corrected. According to this structure, even if the photoacoustic wave generated in the specimen attenuates before reaching the detection portion, a reduction in the signal intensity of the photoacoustic wave signal resulting from attenuation of the photoacoustic wave can be corrected. Consequently, phasing addition can be performed on the photoacoustic wave signal in which a reduction in the signal intensity is corrected, and hence the clear photoacoustic wave image can be obtained by phasing addition.

In the aforementioned photoacoustic image construction method according to the third aspect, correcting, by the signal processing portion, a reduction in the signal intensity of the photoacoustic wave signal resulting from attenuation of the photoacoustic wave and generating, by the signal processing portion, the photoacoustic wave image by the prescribed signal processing preferably includes generating, by the signal processing portion, the photoacoustic wave image by processing employing a statistical method for making an approximation while repetitively performing signal conversion processing for generating an evaluation image with which an evaluation is made by comparison with the photoacoustic wave signal and converting the evaluation image that is generated into a projection signal to be compared with the photoacoustic wave signal and processing for generating the evaluation image that is new by performing imaging processing for imaging a signal based on a result of comparison between the projection signal of the evaluation image and the photoacoustic wave signal and correcting the signal intensity of the projection signal of the evaluation image to respond to a reduction in the signal intensity of the photoacoustic wave signal resulting from attenuation of the photoacoustic wave during the signal conversion processing. According to this structure, the signal intensity of the projection signal of the evaluation image is corrected to respond to a reduction in the signal intensity of the photoacoustic wave signal resulting from attenuation of the photoacoustic wave, and hence an accurate comparison result can be acquired when the projection signal of the evaluation image is compared with the photoacoustic wave signal. Consequently, the clear photoacoustic wave image can be generated. Furthermore, the photoacoustic wave image is generated by the processing employing the statistical method, whereby resolution related to imaging is improved in addition to be capable of generating the clear photoacoustic wave image, and hence an increase in the number of detection elements can be significantly reduced or prevented. In addition, the resolution is improved, and hence a clearer photoacoustic wave image can be generated even when a wide angular detection range is detected, as compared with the case where the photoacoustic wave image is generated by processing employing an analytical method.

In the aforementioned photoacoustic image construction method according to the third aspect, correcting, by the signal processing portion, a reduction in the signal intensity of the photoacoustic wave signal resulting from attenuation of the photoacoustic wave and generating, by the signal processing portion, the photoacoustic wave image by the prescribed signal processing preferably includes correcting, by the signal processing portion, a reduction in the signal intensity of the photoacoustic wave signal resulting from attenuation of the photoacoustic wave and generating, by the signal processing portion, the photoacoustic wave image by a backprojection method on the basis of the photoacoustic wave signal that is corrected. According to this structure, even if the photoacoustic wave generated in the specimen attenuates before reaching the detection portion, a reduction in the signal intensity of the photoacoustic wave signal resulting from attenuation of the photoacoustic wave can be corrected. Consequently, the signal processing employing the backprojection method can be performed on the photoacoustic wave signal in which a reduction in the signal intensity is corrected, and hence the clear photoacoustic wave image can be obtained by the backprojection method.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the overall structure of a photoacoustic imager according to first to third embodiments of the present invention;

FIG. 2 illustrates acquisition of photoacoustic wave signals by the photoacoustic imager according to the first embodiment of the present invention;

FIG. 3 illustrates light-emission cycles of the photoacoustic imager according to the first embodiment of the present invention and acquisition of photoacoustic wave signals corresponding to the light-emission cycles;

FIG. 4 illustrates N-M coordinate data before correction in the photoacoustic imager according to the first embodiment of the present invention;

FIG. 5 illustrates N-M coordinate data after correction in the photoacoustic imager according to the first embodiment of the present invention;

FIG. 6 illustrates a correspondence between an imaging region and K-L coordinates in the photoacoustic imager according to the first embodiment of the present invention;

FIG. 7 illustrates phasing addition based on N-M coordinates in the photoacoustic imager according to the first embodiment of the present invention;

FIG. 8 illustrates K-L coordinate data generated by phasing addition in the photoacoustic imager according to the first embodiment of the present invention;

FIG. 9 is a flowchart for illustrating photoacoustic wave image construction processing performed by the photoacoustic imager according to the first embodiment of the present invention;

FIG. 10 illustrates a case where the position of light applied from a light source portion of the photoacoustic imager according to the second embodiment of the present invention is on a side closer to a detection portion;

FIG. 11 illustrates N-M coordinate data after correction in the photoacoustic imager according to the second embodiment of the present invention;

FIG. 12 illustrates a case where the position of the light applied from the light source portion of the photoacoustic imager according to the second embodiment of the present invention is on a side opposite to the detection portion;

FIG. 13 is a graph for illustrating light attenuation by the photoacoustic imager according to the second embodiment of the present invention;

FIG. 14 is a flowchart for illustrating photoacoustic wave image construction processing performed by the photoacoustic imager according to the second embodiment of the present invention;

FIG. 15 illustrates sensitivity caused by incident directions with respect to detection elements in the photoacoustic imager according to the third embodiment of the present invention;

FIG. 16 illustrates K-L coordinate data generated by phasing addition in the photoacoustic imager according to the third embodiment of the present invention;

FIG. 17 is a flowchart for illustrating photoacoustic wave image construction processing performed by the photoacoustic imager according to the third embodiment of the present invention;

FIG. 18 is a block diagram showing the overall structure of a photoacoustic imager according to a fourth embodiment of the present invention;

FIG. 19 is a block diagram of a portion of a photoacoustic imager according to fourth to sixth embodiments of the present invention, involved in generation of a photoacoustic wave image;

FIG. 20 illustrates acquisition of photoacoustic wave signals by a detection portion according to the fourth embodiment of the present invention;

FIG. 21 illustrates the photoacoustic wave signals in the photoacoustic imager according to the fourth embodiment of the present invention;

FIG. 22 illustrates imaging processing performed by the photoacoustic imager according to the fourth embodiment of the present invention;

FIG. 23 illustrates signal conversion processing and correction processing performed by the photoacoustic imager according to the fourth embodiment of the present invention;

FIG. 24 is a flowchart for illustrating entire generation processing for a photoacoustic wave image according to the fourth embodiment of the present invention;

FIG. 25 is a flowchart for illustrating generation processing for a photoacoustic wave image employing a statistical method according to the fourth embodiment of the present invention;

FIG. 26 illustrates the arrangement relationship between a detection portion and a light source portion when the position of light applied from the light source portion is on a side closer to the detection portion according to the fifth embodiment of the present invention;

FIG. 27 illustrates correction processing performed by the photoacoustic imager according to the fifth embodiment of the present invention;

FIG. 28 illustrates the arrangement relationship between the detection portion and the light source portion when the position of the light applied from the light source portion is on a side opposite to the detection portion according to the fifth embodiment of the present invention;

FIG. 29 illustrates results of an experiment conducted in order to determine a constant k2 of the photoacoustic imager according to the fifth embodiment of the present invention;

FIG. 30 illustrates sensitivity caused by incident directions with respect to detection elements in the photoacoustic imager according to the sixth embodiment of the present invention;

FIG. 31 illustrates signal conversion processing and correction processing performed by the photoacoustic imager according to the sixth embodiment of the present invention;

FIG. 32 is a block diagram showing the overall structure of a photoacoustic imager according to seventh to ninth embodiments of the present invention;

FIG. 33 illustrates acquisition of photoacoustic wave signals by the photoacoustic imager according to the seventh embodiment of the present invention;

FIG. 34 illustrates light-emission cycles of the photoacoustic imager according to the seventh embodiment of the present invention and acquisition of photoacoustic wave signals corresponding to the light-emission cycles;

FIG. 35 illustrates N-M coordinate data before correction in the photoacoustic imager according to the seventh embodiment of the present invention;

FIG. 36 illustrates N-M coordinate data after correction in the photoacoustic imager according to the seventh embodiment of the present invention;

FIG. 37 illustrates imaging processing employing a backprojection method in the photoacoustic imager according to the seventh embodiment of the present invention;

FIG. 38 illustrates a method for determining signal values in an imaging region by the backprojection method in the photoacoustic imager according to the seventh embodiment of the present invention;

FIG. 39 is a flowchart for illustrating photoacoustic wave image construction processing performed by the photoacoustic imager according to the seventh embodiment of the present invention;

FIG. 40 illustrates sensitivity caused by incident directions with respect to detection elements in the photoacoustic imager according to the eighth embodiment of the present invention;

FIG. 41 illustrates signal processing employing a backprojection method in consideration of the sensitivity caused by the incident directions with respect to the detection elements in the photoacoustic imager according to the eighth embodiment of the present invention;

FIG. 42 is a flowchart for illustrating photoacoustic wave image construction processing performed by the photoacoustic imager according to the eighth embodiment of the present invention;

FIG. 43 illustrates a case where the position of light applied from a light source portion of the photoacoustic imager according to the ninth embodiment of the present invention is on a side closer to a detection portion;

FIG. 44 illustrates N-M coordinate data after correction in the photoacoustic imager according to the ninth embodiment of the present invention;

FIG. 45 illustrates a case where the position of the light applied from the light source portion of the photoacoustic imager according to the ninth embodiment of the present invention is on a side opposite to the detection portion;

FIG. 46 is a graph for illustrating light attenuation by the photoacoustic imager according to the ninth embodiment of the present invention;

FIG. 47 is a flowchart for illustrating photoacoustic wave image construction processing performed by the photoacoustic imager according to the ninth embodiment of the present invention; and

FIG. 48 is a block diagram showing the overall structure of a photoacoustic imager according to a modification of the fourth embodiment of the present invention.

### DESCRIPTION OF THE PREFERRED EMBODIMENTS

Embodiments of the present invention are hereinafter described with reference to the drawings.

### First Embodiment

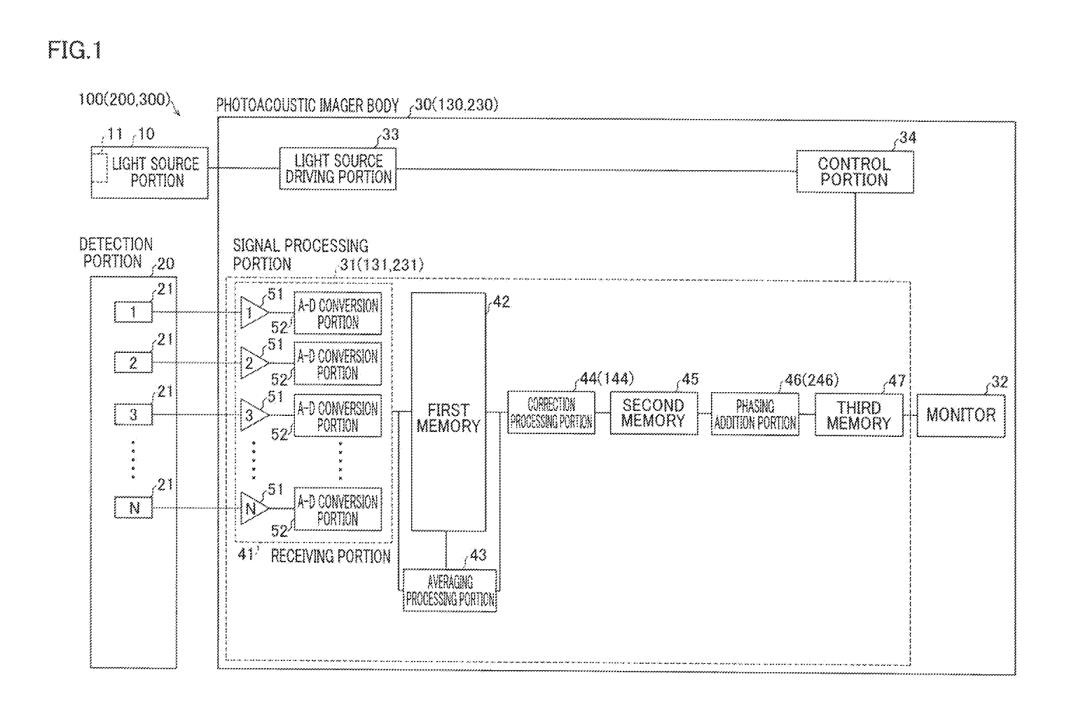

The structure of a photoacoustic imager 100 according to a first embodiment of the present invention is now described with reference to FIGS. 1 to 8.

The photoacoustic imager 100 according to the first embodiment of the present invention includes a light source portion 10, a detection portion 20, and a photoacoustic imager body (hereinafter referred to as the imager body) 30, as shown in FIG. 1. The light source portion 10 and the detection portion 20 are provided outside the imager body 30 and are connected to the imager body 30 by unshown wires. The photoacoustic imager 100 is configured to be capable of performing signal transmission such as output of a control signal from the imager body 30 to the light source portion 10 and output of photoacoustic wave signals detected by the detection portion 20 from the detection portion 20 to the imager body 30 through these wires.

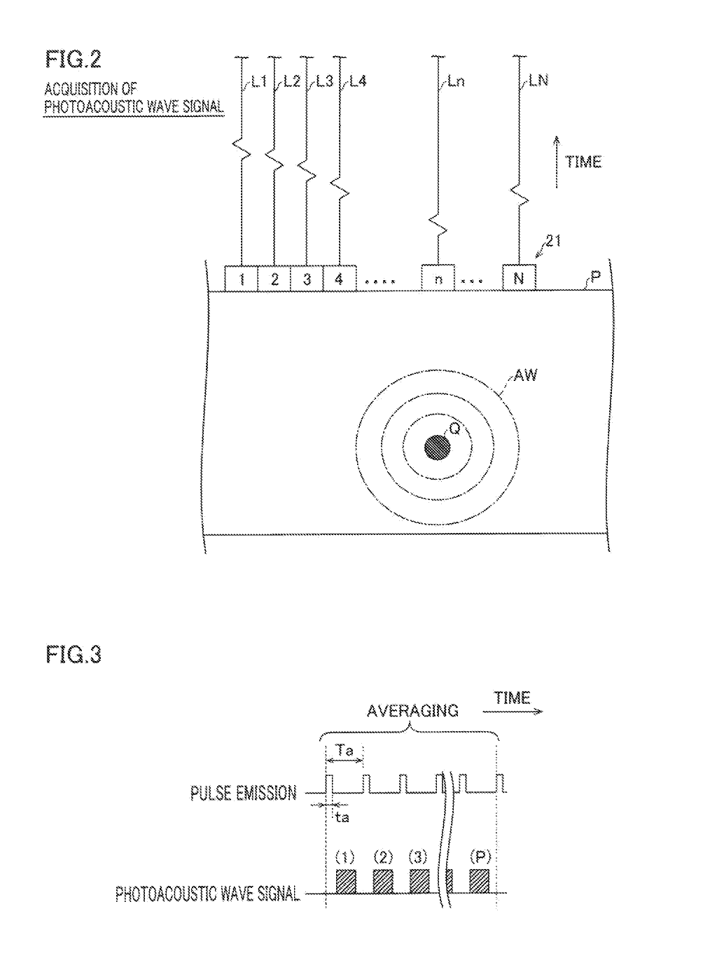

As shown in FIG. 1, the light source portion 10 is a light source unit configured to apply light to a specimen P (see FIG. 2). During measurement of a photoacoustic wave AW (see FIG. 2), the light source portion 10 is brought into contact with a surface of the specimen P.

The light source portion 10 includes a light source 11 and is configured to apply light for measurement from the light source 11 to the specimen P. The light source 11 of the light source portion 10 is configured to repetitively emit pulsed light with a pulse width to (see FIG. 3) in a light-emission cycle Ta (see FIG. 3) on the basis of a control signal from a light source driving portion 33, described later, of the imager body 30. Photoacoustic wave signals in a prescribed period after emission of pulsed light and before subsequent emission of pulsed light are repetitively acquired by the imager body 30. The light source 11 is configured to generate light (light with a center wavelength at about 700 nm to about 1000 nm, for example) with a measurement wavelength of an infrared region suitable for measuring the specimen P (see FIG. 2) such as a human body. As the light source 11, a semiconductor light-emitting element such as a light-emitting diode element, a semiconductor laser element, or an organic light-emitting diode element can be employed, for example. In this case, the light source portion 10 can be downsized, and hence the photoacoustic wave AW can be measured while the light source portion 10 provided with the light source 11 is brought into direct contact with the specimen P. The measurement wavelength of the light source 11 may be properly determined according to a detection object Q desired to be detected.

As shown in FIG. 1, the detection portion 20 is a probe configured to receive the photoacoustic wave AW (see FIG. 2). The detection portion 20 can be configured to transmit and receive an ultrasonic wave in addition to receiving the photoacoustic wave AW. During measurement of the photoacoustic wave AW, the detection portion 20 is brought into contact with the surface of the specimen P.

The detection portion 20 includes a plurality of detection elements 21. The plurality of detection elements 21 include piezoelectric elements and are arranged in an array in the vicinity of a tip end of an internal portion of an unshown housing. According to the first embodiment, N (also referred to as N channels) detection elements 21 are provided. The number N of detection elements 21 can be 64, 128, 192, or 256, for example.

The detection portion 20 is configured to receive the photoacoustic wave AW and detect photoacoustic wave signals by vibration of the detection elements 21 resulting from the photoacoustic wave AW generated from the detection object Q (see FIG. 2) in the specimen P (see FIG. 2) that absorbs light applied from the light source portion 10. The detection portion 20 is further configured to output the detected photoacoustic wave signals to the imager body 30.

According to the first embodiment, the imager body 30 is provided with a signal processing portion 31. The signal processing portion 31 is configured to correct the photoacoustic wave signals output from the detection portion 20 and to generate a photoacoustic wave image based on the photoacoustic wave signals by phasing addition. Specifically, the signal processing portion 31 is configured to correct a reduction in the signal intensity of the photoacoustic wave signals resulting from attenuation of the photoacoustic wave AW and to generate the photoacoustic wave image by performing phasing addition on the corrected photoacoustic wave signals. Schematically, the signal processing portion 31 is configured to perform signal processing involved in acquisition of the photoacoustic wave signals, correction of the photoacoustic wave signals, phasing addiction of the corrected photoacoustic wave signals, and generation of the photoacoustic wave image based on the photoacoustic wave signals on which phasing addition is performed. The structure of the signal processing portion 31 is now described in detail. The phasing addition is an example of the “prescribed signal processing” in the present invention.

As shown in FIG. 1, the signal processing portion 31 includes a receiving portion 41, a first memory 42, an averaging processing portion 43, a correction processing portion 44, a second memory 45, a phasing addition portion 46, and a third memory 47. The function of the signal processing portion 31 can be attained by a combination of hardware such as a dedicated circuit, a general-purpose CPU, an FPGA (field programmable gate array), a non-volatile memory, and a volatile memory and software such as various programs, for example.

The receiving portion 41 is provided with a plurality of (N) amplification portions 51 and a plurality of (N) analog-digital conversion portions (hereinafter referred to as the A-D conversion portions) 52 corresponding to the plurality of (N) detection elements 21 of the detection portion 20. Detection of the photoacoustic wave signals by the detection portion 20 through reception of the photoacoustic wave signals by the receiving portion 41 is now described with reference to FIG. 2. When the light source portion 10 (see FIG. 1) applies pulsed light to the specimen P, the photoacoustic wave AW is generated from the detection object Q in the specimen P, as shown in FIG. 2. At this time, the photoacoustic wave AW is generated from a wide range at a time by light application. In FIG. 2, only one detection object Q is illustrated for ease of understanding.

Then, the detection portion 20 (see FIG. 1) receives the photoacoustic wave AW generated from the detection object Q and detects the photoacoustic wave signals by the N respective detection elements 21. In FIG. 2, the photoacoustic wave signals detected by the detection elements 21 are shown as photoacoustic wave signals L1 to LN. The photoacoustic wave signals L1 to LN detected by the detection elements 21 are output from the detection portion 20 to the imager body 30 and are received by the receiving portion 41 of the imager body 30. The photoacoustic wave signals are hereinafter referred to as the photoacoustic wave signals L1 to LN properly.

The receiving portion 41 is configured to receive a photoacoustic wave signal Ln (L1 to LN) detected by an n^{th} (1≦n≦N) detection element 21 with an n^{th} amplification portion 51 and a corresponding n^{th} A-D conversion portion 52.

The respective amplification portions 51 are configured to amplify (about 300 times to about 30000 times, for example) the received photoacoustic wave signals L1 to LN and to output the same to the A-D conversion portions 52.

The respective A-D conversion portions 52 are configured to convert the photoacoustic wave signals L1 to LN amplified by the amplification portions 51 from analog signals into digital signals with a prescribed sampling frequency and prescribed bit resolution. The A-D conversion portions 52 are configured to output the photoacoustic wave signals L1 to LN as digital signals to the first memory 42.

The first memory 42 is configured to store the photoacoustic wave signals L1 to LN output from the respective A-D conversion portions 52. As shown in FIG. 4, the first memory 42 stores the photoacoustic wave signals L1 to LN as N-M coordinate data.

The N-M coordinate data is data obtained by configuring information about the width direction of the detection portion 20 and information about a depth direction from the surface of the specimen P in a matrix. Specifically, the N-M coordinate data is configured by a matrix of the number N of detection elements 21 (detection element number N) and the sample number M. The sample number M is a sample number for a signal up to a depth desired to be imaged in each of the photoacoustic wave signals L1 to LN. When a depth desired to be imaged is 6 cm (0.06 m) from the surface of the specimen P, the velocity of sound in the human body is 1530 m/s, and the prescribed sampling frequency of the A-D conversion portions 52 is 20×10⁶ Hz, for example, the sample number M is obtained by M=(0.06/1530)×20×10⁶=about 800. The sample number M indicates the number of pixels in the depth direction, and in the case of the aforementioned calculation example, for example, there are about 800 pixels in the depth direction.

In the N-M coordinate data, each point of an M-coordinate is arranged at a time interval corresponding to a sampling time p. The sampling time p is a time corresponding to one cycle of the prescribed sampling frequency of the A-D conversion portions 52. When the prescribed sampling frequency of the A-D conversion portions 52 is 20×10⁶ Hz, for example, the sampling time p is 0.05 μs. In other words, in the N-M coordinate data, the M-coordinate corresponds to a detection time t of each of the detected photoacoustic wave signals L1 to LN. When the M-coordinate is m (1≦m≦M), for example, the detection time t is obtained by the following formula: t=m×p. Therefore, this N-M coordinate data can be said to be data having information about the detection time t of each of the photoacoustic wave signals L1 to LN detected by the respective detection elements 21. For example, a coordinate point (n, m) in the N-M coordinate data has information about a signal value Xₙₘ in the detection time t (=m×p) of the photoacoustic wave signal Ln. One piece of N-M coordinate data is obtained per pulsed light emission by the light source 11 of the light source portion 10.

The averaging processing portion 43 (see FIG. 1) is configured to average a plurality of (P) pieces of N-M coordinate data corresponding to a plurality of (P sets of) respective photoacoustic wave signals L1 to LN received on the basis of a plurality of (P) pulsed light emissions and stored in the first memory 42, as shown in FIG. 3. Thus, the photoacoustic wave image (image data) can be generated in a state where the S/N ratio (signal/noise ratio) of the photoacoustic wave signals L1 to LN is improved by averaging, and hence the photoacoustic wave image that accurately reflects a state inside the specimen P can be generated. The averaging processing portion 43 is configured to store the averaged N-M coordinate data in the first memory 42. The first memory 42 is configured to be capable of outputting the stored N-M coordinate data to the correction processing portion 44.

According to the first embodiment, the correction processing portion 44 is configured to correct a reduction in the signal intensity of the photoacoustic wave signals L1 to LN resulting from attenuation of the photoacoustic wave AW on the basis of the detection time t and a signal frequency f. The detection time t is a time from a time point when the light source portion 10 applies pulsed light to a time point when the detection portion 20 detects each of the photoacoustic wave signals L1 to LN. The starting point of the detection time t may not be strictly the time point when the light source portion 10 applies pulsed light. For example, the starting point of the detection time t may be a time point when sampling of the photoacoustic wave signals L1 to LN is started after the time point when the light source portion 10 applies pulsed light, as shown in FIG. 3. According to the first embodiment, as the detection time t, a value obtained by multiplying the M-coordinate m of the N-M coordinate data by the sampling time p is employed, as described above. The signal frequency f is the signal frequency of the photoacoustic wave signals L1 to LN. According to the first embodiment, as the signal frequency f, the signal frequency at a prescribed coordinate point in the N-M coordinate data is employed. This signal frequency f can be obtained by analyzing the photoacoustic wave signals L1 to LN by a Fourier transform method or the like, for example.

According to the first embodiment, the correction processing portion 44 is configured to increase the signal intensity of the photoacoustic wave signals according to increases in the values of the detection time t and the signal frequency f by multiplying the photoacoustic wave signals L1 to LN by a correction coefficient Z1 expressed by the following formula (1) where a constant related to the detection time t (μs: microsecond) and the signal frequency f (MHz: megahertz) is k1.

Z1=10^{k1×t×f} (1)

The constant k1 is a constant for correcting attenuation of the photoacoustic wave AW (a reduction in the signal intensity) generated in the specimen P in relation to the detection time t and the signal frequency f and can be properly determined according to measurement conditions for the specimen P (the human body or another animal), a measurement site of the specimen P, or the like. In consideration of this point, the constant k1 is preferably at least 0.002 and not more than 0.009.

When a living body (human body) soft tissue is measured, for example, the constant k1 is obtained as described below as an example. When the attenuation in the living body soft tissue is −0.6 dB/(cm×MHz) and a time required for sound (photoacoustic wave AW) to travel a distance of 1 cm in the living body soft tissue is 6.536 μs (=0.01 m/1530 m/s=1 cm/velocity of sound), the attenuation in the living body soft tissue can be expressed by 10^{-0.00459×t×f} (=10^{(((-0.6/20)/6.536)×t×f)}). The constant k1 is obtained as k1=((0.6/20)/6.536)=0.00459 (1/(1 μs×MHz)) in correspondence to the above formula. In other words, the constant k1 can be said to be a constant for correcting attenuation of the photoacoustic wave AW (a reduction in the signal intensity) generated per the detection time t and the signal frequency f. The correction coefficient Z1 obtained by the aforementioned formula (1) can be said to be a correction coefficient for increasing the signal intensity by an amount corresponding to attenuation of the photoacoustic wave AW (a reduction in the signal intensity) generated in the specimen P. Therefore, even if the photoacoustic wave AW (see FIG. 2) generated in the specimen P (see FIG. 2) attenuates before reaching the detection elements 21 of the detection portion 20, a reduction in the signal intensity of the photoacoustic wave signals L1 to LN resulting from the attenuation of the photoacoustic wave AW can be corrected by multiplying the photoacoustic wave signals by the correction coefficient Z1.

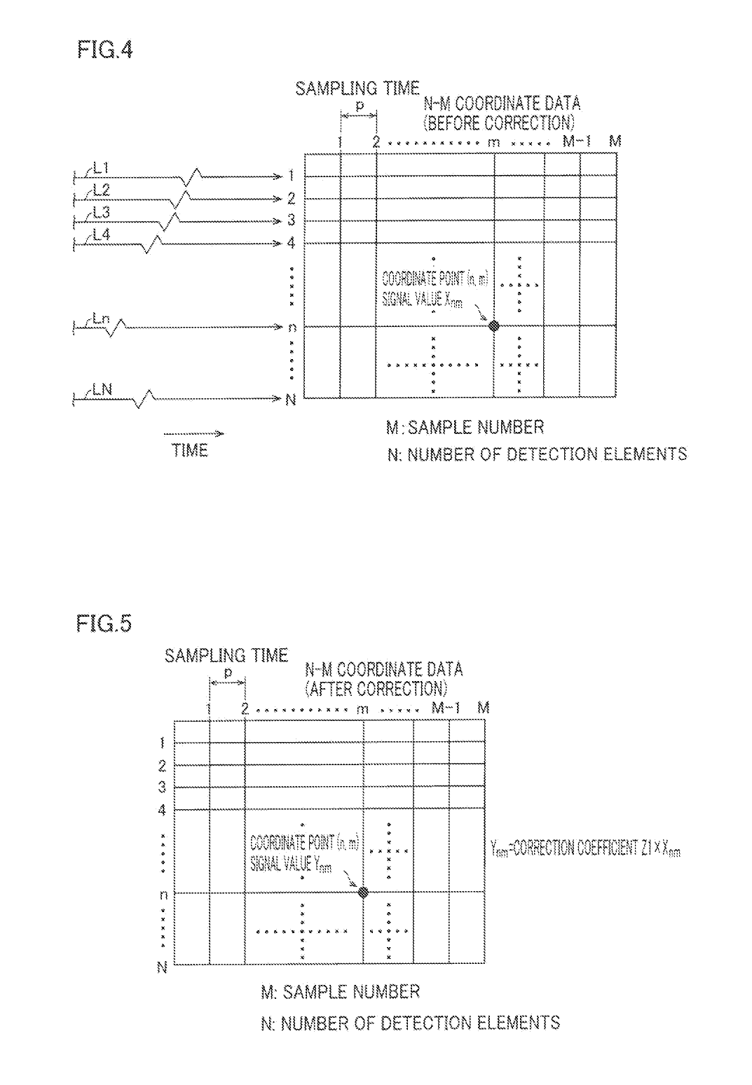

The correction processing portion 44 is configured to acquire the N-M coordinate data stored in the first memory 42 and to multiply a signal value (signal intensity) at each coordinate point in the acquired N-M coordinate data by the correction coefficient Z1 as specific correction processing with respect to attenuation of the photoacoustic wave AW of the photoacoustic wave signals L1 to LN. Thus, the correction processing portion 44 is configured to increase the signal intensity of the photoacoustic wave signals L1 to LN according to increases in the values of the detection time t and the signal frequency f. For example, a signal value Yₙₘ (=Z1×Xₙₘ) after correction at the coordinate point (n, m) is obtained by multiplying a signal value Xₙₘ at the coordinate point (n, m) in the N-M coordinate data by the correction coefficient Z1 at the coordinate point (n, m), as shown in FIGS. 4 and 5. Similarly, the correction processing portion 44 acquires the N-M coordinate data after correction shown in FIG. 5 by multiplying a signal value at each of all coordinate points from a coordinate point (1, 1) to a coordinate point (N, M) in the N-M coordinate data by the correction coefficient Z1 at each of all the coordinate points. As shown in FIG. 1, the correction processing portion 44 is configured to output the acquired N-M coordinate data after correction to the second memory 45.

The photoacoustic wave signals L1 to LN corrected by the correction processing portion 44 may be either RF (radio frequency) signals (high-frequency signals) or RF signals obtained by demodulating (detecting) the original RF signals. In other words, the correction processing performed by the correction processing portion 44 may be performed on either the RF signals or the demodulated (detected) RF signals. When the correction processing is performed on the demodulated RF signals, a demodulation (detection) processing portion is provided in a stage preceding the correction processing portion 44 so that the correction processing can be performed on the demodulated RF signals.

The second memory 45 is configured to store the N-M coordinate data (see FIG. 5) after correction output from the correction processing portion 44. The second memory 45 is configured to be capable of outputting the stored N-M coordinate data to the phasing addition portion 46.

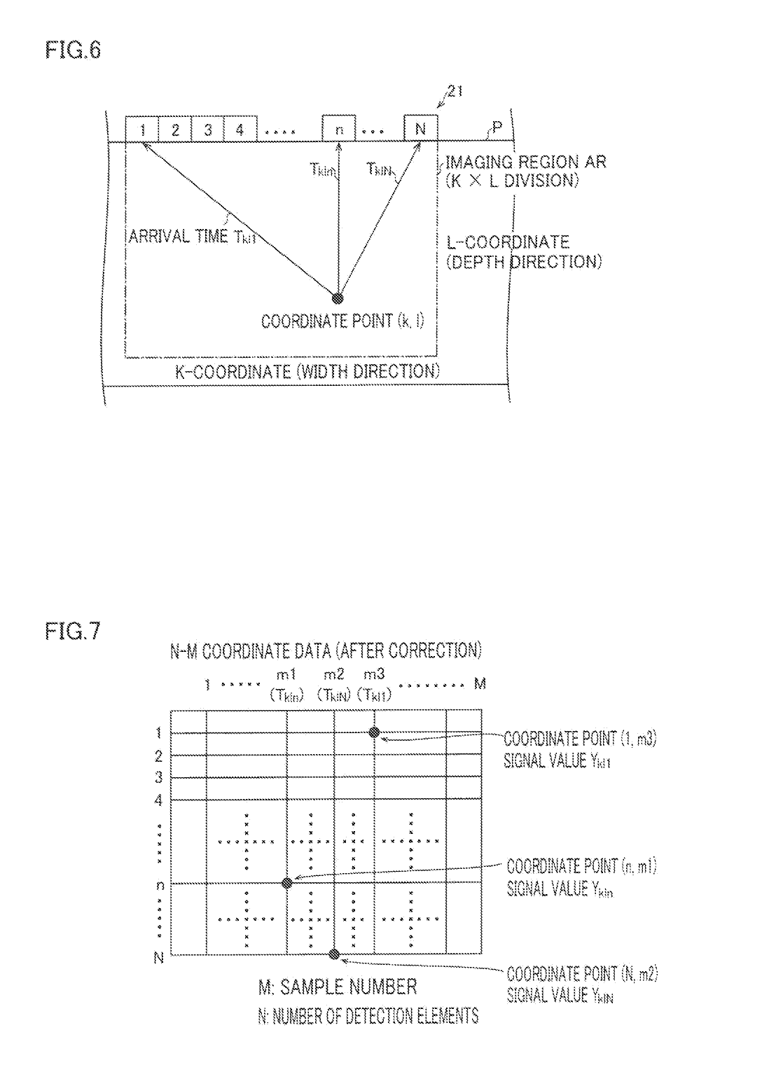

The phasing addition portion 46 is configured to perform phasing addition on the basis of the N-M coordinate data after correction and to generate K-L coordinate data (see FIG. 8). Generation of the K-L coordinate data through phasing addition performed by the phasing addition portion 46 is now described with reference to FIGS. 6 to 8.

As shown in FIGS. 6 to 8, the phasing addition portion 46 is configured to generate the K-L coordinate data (see FIG. 8) in which an imaging region AR corresponding to the inside of the specimen P is divided into K×L by performing phasing addition on the basis of the N-M coordinate data after correction. As shown in FIG. 8, the K-L coordinate data is data obtained by configuring the information about the width direction of the detection portion 20 and the information about the depth direction from the surface of the specimen P in a matrix, similarly to the N-M coordinate data. The K-L coordinate data is configured by a matrix of K (i.e. N=K) that is equal to the detection element number N and the number of pixels (monitor pixel count) L of a monitor 32, described later, of the imager body 30 in the depth direction.

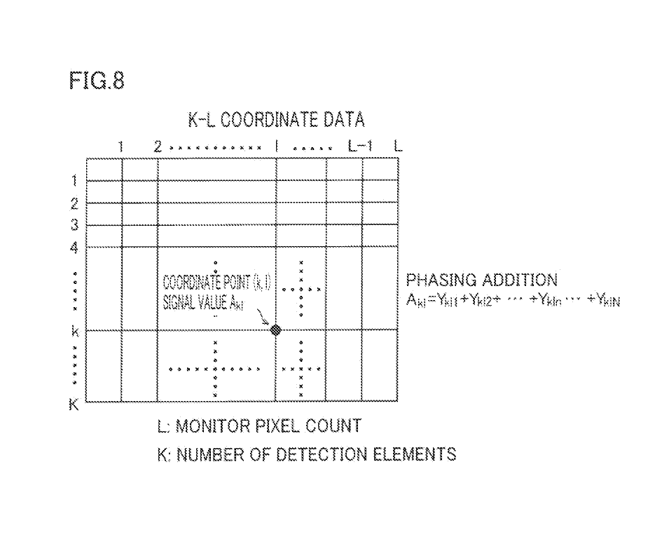

More specifically, the phasing addition portion 46 is configured to acquire a signal value (signal intensity) at each coordinate point in the K-L coordinate data on the basis of the N-M coordinate data after correction by phasing addition. When acquiring a signal value Aₖₗ at a coordinate point (k, l) in K-L coordinates as shown in FIG. 8, for example, the phasing addition portion 46 first acquires arrival times Tₖₗ₁ to T_{klN} (see FIG. 6) supposedly required for the photoacoustic wave AW (see FIG. 2) to reach the respective detection elements 21 from the coordinate point (k, l) in the imaging region AR (see FIG. 6). The arrival times Tₖₗ₁ to T_{klN} can be obtained by dividing distances from the coordinate point (k, l) to the respective detection elements 21 by the velocity of sound, for example. Then, the phasing addition portion 46 acquires signal values Yₖₗ₁ to Y_{klN} at coordinate points corresponding to the acquired arrival times Tₖₗ₁ to T_{klN} and the detection elements 21 (1 to N) in the N-M coordinate data, as shown in FIG. 7. Then, the phasing addition portion 46 acquires the signal value Aₖₗ (=Yₖₗ₁+Yₖₗ₂+ . . . +Yₖₗₙ+ . . . +Y_{klN}) at the coordinate point (k, l) by adding the acquired signal values Yₖₗ₁ to Y_{klN}. In this manner, the phasing addition portion 46 acquires the signal value at the coordinate point (k, l) by phasing addition. Then, similarly, the phasing addition portion 46 acquires signal values at all coordinate points from a coordinate point (1, 1) to a coordinate point (K, L) in the K-L coordinate data by phasing addition. Thus, the K-L coordinate data (see FIG. 8) is generated. Then, the photoacoustic wave image is constructed (generated) on the basis of the generated K-L coordinate data. In other words, the constructed photoacoustic wave image is an image obtained by performing phasing addition on the signal values corrected by the correction processing portion 44. Then, the phasing addition portion 46 is configured to output the photoacoustic wave image (image data) based on the K-L coordinate data to the third memory 47, as shown in FIG. 1.

The third memory 47 is configured to store the photoacoustic wave image (image data) output from the phasing addition portion 46. The third memory 47 is further configured to be capable of outputting the stored photoacoustic wave image to the monitor 32. Consequently, the monitor 32 displays a clear photoacoustic wave image based on the photoacoustic wave signals in which a reduction in the signal intensity is corrected. An image processing portion that performs image processing such as gradation adjustment can be further provided between the third memory 47 and the monitor 32.

The imager body 30 is provided with the monitor 32 including a common liquid crystal monitor. The monitor 32 is configured to be capable of displaying the photoacoustic wave image, various operation screens, etc.

The imager body 30 is further provided with the light source driving portion 33. The light source driving portion 33 is configured to control the light source 11 of the light source portion 10 provided outside the imager body 30 to emit pulsed light. Specifically, the light source driving portion 33 is configured to control the light source 11 of the light source portion 10 to repetitively emit the pulsed light with the pulse width ta in the light-emission cycle Ta. The light source driving portion 33 is further configured to be capable of adjusting the pulse width ta, the light-emission cycle Ta, and a current value for driving the light source 11 on the basis of control signals from a control portion 34 of the imager body 30. In other words, the photoacoustic imager 100 is configured to be capable of changing conditions for light application by the light source portion 10 by changing the setting of the light source driving portion 33.

The imager body 30 is provided with the control portion 34. The control portion 34 includes a CPU and is configured to control each component of the imager body 30. The control portion 34 is configured to control conditions for light application of the light source portion 10 set by the light source driving portion 33 and conditions for signal processing of the signal processing portion 31, for example.

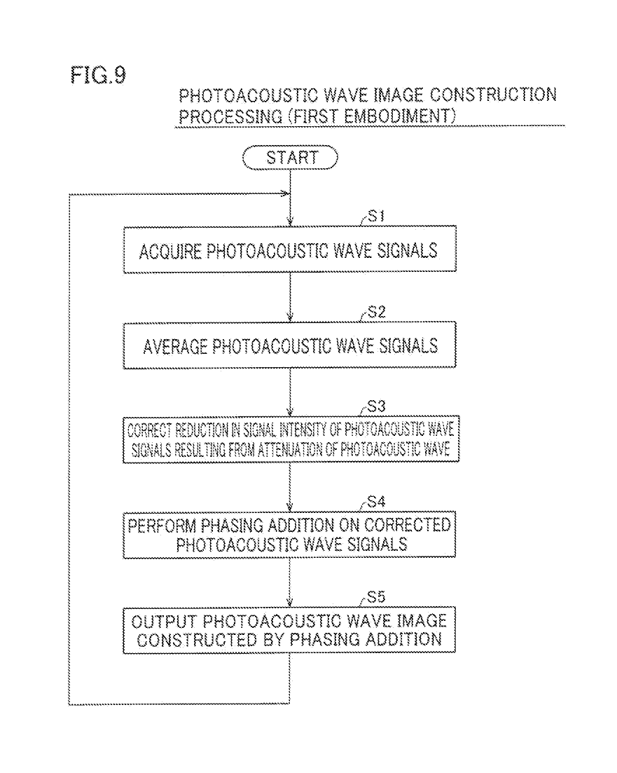

Photoacoustic wave image construction processing performed by the signal processing portion 31 of the imager body 30 is now described on the basis of a flowchart with reference to FIG. 9.

First, the photoacoustic wave signals are acquired at a step S1. Specifically, the photoacoustic wave signals are received by the receiving portion 41 (see FIG. 1) and are stored in the first memory 42 (see FIG. 1), whereby the photoacoustic wave signals L1 to LN (see FIG. 4) are acquired by the signal processing portion 31. At this time, the first memory 42 stores the photoacoustic wave signals L1 to LN as the N-M coordinate data before correction.

Then, the plurality (P sets) of photoacoustic wave signals are averaged at a step S2. Specifically, the averaging processing portion 43 averages the plurality (P sets) of pieces of N-M coordinate data corresponding to the plurality (P sets) of respective photoacoustic wave signals L1 to LN stored in the first memory 42.

Then, a reduction in the signal intensity of the photoacoustic wave signals resulting from attenuation of the photoacoustic wave AW is corrected at a step S3. Specifically, the correction processing portion 44 acquires the N-M coordinate data stored in the first memory 42 and makes a correction by multiplying the signal value (signal intensity) of each coordinate point in the acquired N-M coordinate data by the correction coefficient Z1. Thus, the N-M coordinate data in which a reduction in the signal intensity of the photoacoustic wave signals resulting from attenuation of the photoacoustic wave AW is corrected is obtained.

Then, phasing addition is performed on the corrected photoacoustic wave signals at a step S4. In other words, at the step S4, the phasing addition portion 46 performs phasing addition on the basis of the N-M coordinate data after correction obtained by the processing at the step S3. Consequently, the K-L coordinate data shown in FIG. 8 is generated, and the photoacoustic wave image based on the K-L coordinate data is constructed.

Then, the photoacoustic wave image constructed by phasing addition is output from the third memory 47 to the monitor 32 at a step S5. Consequently, the clear photoacoustic wave image obtained by the correction processing is displayed on the monitor 32. Then, the signal processing portion 31 returns to the step S1 and acquires subsequent photoacoustic wave signals.

According to the first embodiment, the following effects can be obtained.

According to the first embodiment, as hereinabove described, the photoacoustic imager 100 is provided with the signal processing portion 31 that corrects a reduction in the signal intensity of the photoacoustic wave signals (L1 to LN) resulting from attenuation of the photoacoustic wave AW and generates the photoacoustic wave image by performing phasing addition on the corrected photoacoustic wave signals. Thus, even if the photoacoustic wave AW generated in the specimen P attenuates before reaching the detection portion 20, a reduction in the signal intensity of the photoacoustic wave signals (L1 to LN) resulting from attenuation of the photoacoustic wave AW can be corrected. Consequently, phasing addition can be performed on the photoacoustic wave signals in which a reduction in the signal intensity is corrected, and hence the clear photoacoustic wave image can be obtained by phasing addition.

According to the first embodiment, as hereinabove described, the signal processing portion 31 is configured to correct a reduction in the signal intensity of the photoacoustic wave signals resulting from attenuation of the photoacoustic wave AW on the basis of both the detection time t required for the detection portion 20 to detect each of the photoacoustic wave signals and the signal frequency f of the photoacoustic wave signals. Thus, a reduction in the signal intensity of the photoacoustic wave signals resulting from attenuation of the photoacoustic wave AW can be reliably corrected on the basis of a reduction (the amount of reduction) in the signal intensity of the photoacoustic wave signals resulting from attenuation of the photoacoustic wave AW.

According to the first embodiment, as hereinabove described, the signal processing portion 31 is configured to correct a reduction in the signal intensity of the photoacoustic wave signals resulting from attenuation of the photoacoustic wave AW by increasing the signal intensity of the photoacoustic wave signals according to increases in the values of both the detection time t and the signal frequency f. Thus, the signal intensity of photoacoustic wave signals reduced by attenuation of the photoacoustic wave AW can be increased according to a reduction (the amount of reduction) in the signal intensity increased as the values of the detection time t and the signal frequency f are increased. Consequently, a reduction in the signal intensity of the photoacoustic wave signals resulting from attenuation of the photoacoustic wave AW can be more reliably corrected according to a reduction (the amount of reduction) in the signal intensity of the photoacoustic wave signals resulting from attenuation of the photoacoustic wave AW.

According to the first embodiment, as hereinabove described, the signal processing portion 31 is configured to increase the signal intensity of the photoacoustic wave signals according to increases in the values of the detection time t and the signal frequency f by multiplying the photoacoustic wave signals by the correction coefficient Z1 expressed by the aforementioned formula (1) where a unit of the detection time t is μs, a unit of the signal frequency f is MHz, and the constant k1 is at least 0.002 and not more than 0.009. Thus, the signal intensity of the photoacoustic wave signals can be increased according to both the detection time t and the signal frequency f by the aforementioned formula (1). Consequently, a reduction in the signal intensity of the photoacoustic wave signals resulting from attenuation of the photoacoustic wave AW can be still more reliably corrected according to a reduction (the amount of reduction) in the signal intensity of the photoacoustic wave signals resulting from attenuation of the photoacoustic wave AW. Furthermore, the constant k1 is at least 0.002 and not more than 0.009, whereby the correction coefficient Z1 can be properly acquired.

According to the first embodiment, as hereinabove described, the light source 11 of the light source portion 10 includes at least one of a light-emitting diode element, a semiconductor laser element, and an organic light-emitting diode element. Thus, advantageously, the power consumption of the light source 11 can be reduced while the light source portion 10 can be downsized, as compared with the case where a solid-state laser light source is employed. When the light-emitting diode element, the semiconductor laser element, or the organic light-emitting diode element is employed as the light source 11, an output of light applied from the light source 11 is reduced as compared with the case where the solid-state laser light source is employed, and hence the signal intensity of the photoacoustic wave signals detected by the detection portion 20 is further reduced. Therefore, when the light-emitting diode element, the semiconductor laser element, or the organic light-emitting diode element is employed as the light source 11, the aforementioned structure according to the first embodiment that can obtain the clear photoacoustic wave image by correcting a reduction in the signal intensity is particularly effective.

### Second Embodiment

A second embodiment is now described with reference to FIGS. 1 and 10 to 14. In this second embodiment, a reduction in the signal intensity of photoacoustic wave signals resulting from attenuation of light from a light source portion 10 is corrected in addition to the aforementioned structure according to the first embodiment. Portions of a photoacoustic imager 200 similar to those of the photoacoustic imager 100 according to the aforementioned first embodiment are denoted by the same reference numerals as those in the first embodiment, and redundant description is omitted.

The photoacoustic imager 200 according to the second embodiment of the present invention includes a light source portion 10, a detection portion 20, and a photoacoustic imager body (hereinafter referred to as the imager body) 130, as shown in FIG. 1. The imager body 130 is provided with a signal processing portion 131. The signal processing portion 131 is similar in structure to the signal processing portion 31 according to the aforementioned first embodiment except that the signal processing portion 131 is provided with a correction processing portion 144.

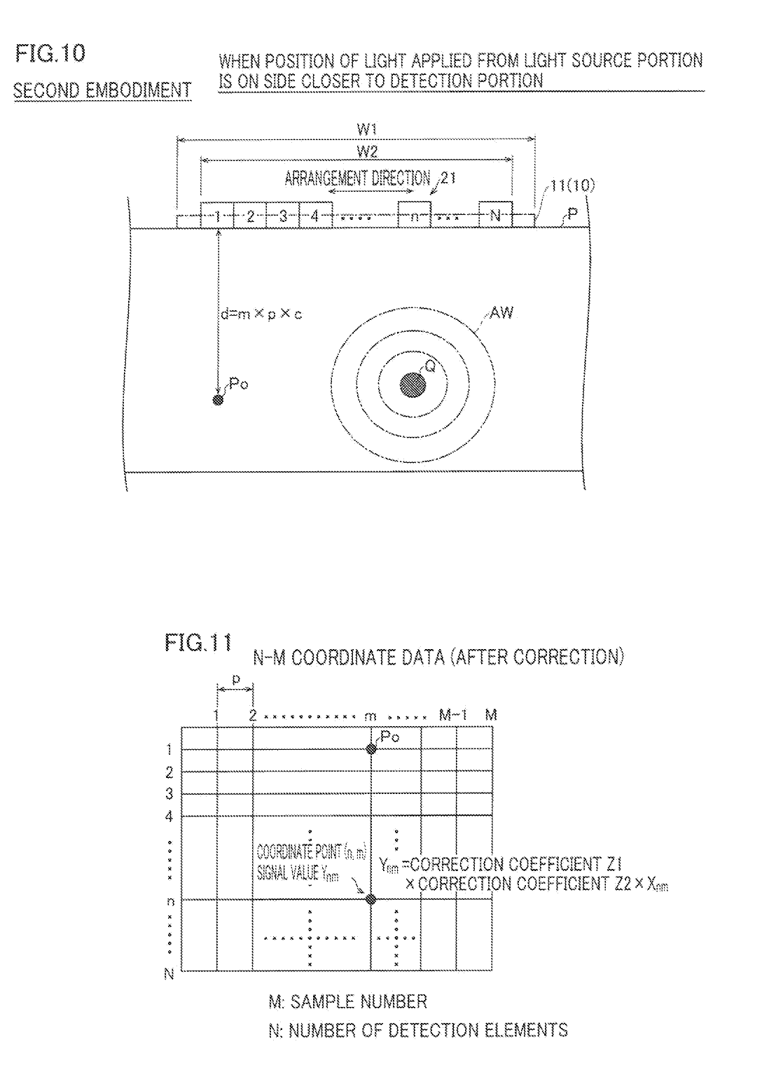

According to the second embodiment, the correction processing portion 144 is configured to correct a reduction in the signal intensity of photoacoustic wave signals resulting from attenuation of light from the light source portion 10 in addition to correcting a reduction in the signal intensity of photoacoustic wave signals resulting from attenuation of a photoacoustic wave AW. In other words, according to the second embodiment, the correction processing portion 144 performs correction processing in consideration of both attenuation of the photoacoustic wave AW generated in a specimen P (see FIG. 10) before reaching detection elements 21 of the detection portion 20 and attenuation of the light applied from the light source portion 10 that is generated before reaching a detection object Q (see FIG. 10) in the specimen P.

Specifically, the correction processing portion 144 is configured to correct a reduction in the signal intensity of the photoacoustic wave signals resulting from attenuation of the photoacoustic wave by the correction coefficient Z1 obtained by the formula (1), similarly to the aforementioned first embodiment. According to the second embodiment, the correction processing portion 144 is further configured to correct a reduction in the signal intensity of the photoacoustic wave signals resulting from attenuation of the light from the light source portion 10 on the basis of a distance d from the position of the light applied from the light source portion 10 to the specimen P to a prescribed position in the specimen P. According to the second embodiment, the distance d is obtained in correspondence to N-M coordinate data. For example, the distance d to the prescribed position Po in the specimen P shown in FIG. 10 is obtained as d=m×p×c by multiplying a detection timet=m×p at a coordinate point (1, m) in the N-M coordinate data by the velocity of sound c, as shown in FIG. 11. The distance d from the position of the light applied from the light source portion 10 to the prescribed position in the specimen P is obtained by being replaced with a distance from the detection elements 21 to the prescribed position in the specimen P. Also with respect to another coordinate point, the distance d can be obtained by the same calculation.

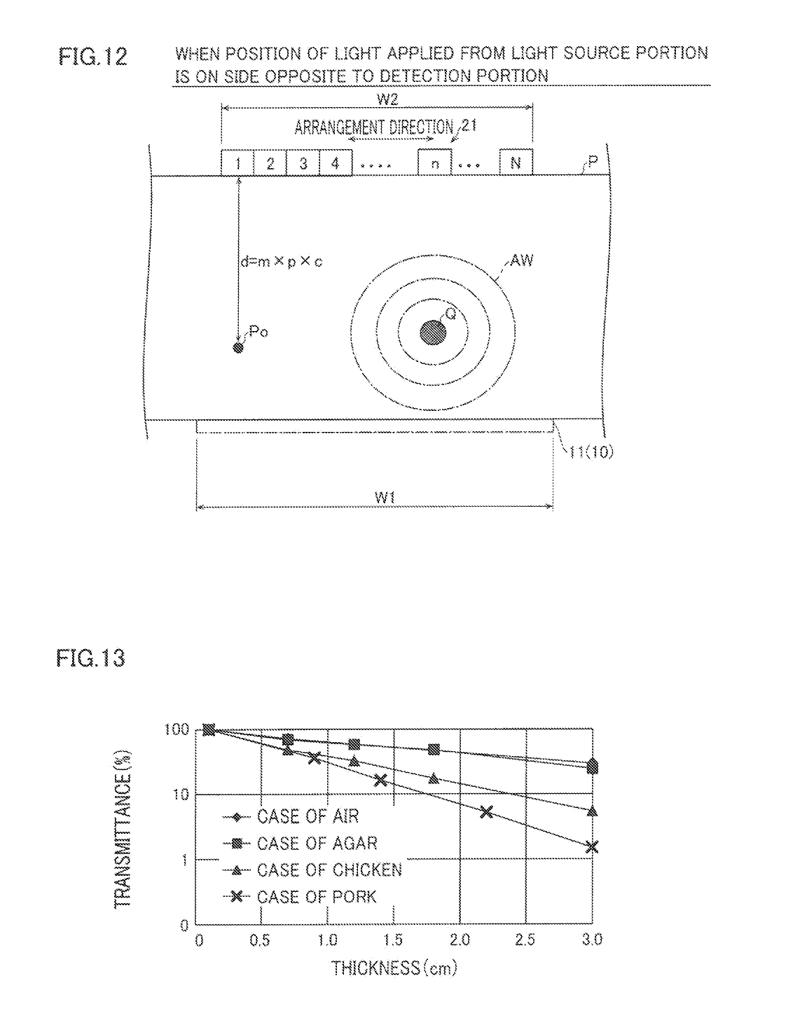

In the structure of obtaining the distance d in this manner, the width W1 of a light source 11 of the light source portion 10 in an arrangement direction in which a plurality of detection elements 21 are arranged is larger than the width W2 of all the plurality of detection elements 21 in the arrangement direction, as shown in FIGS. 10 and 12. Thus, the width W1 of the light source 11 is larger than the width W2 of the plurality of detection elements 21 in the arrangement direction, and hence the position of the light applied from the light source portion 10 can be reliably associated with the positions of the detection elements 21 even if the distance d from the position of the light applied from the light source portion 10 to the prescribed position in the specimen P is obtained by being replaced with the distance from the detection elements 21 to the prescribed position in the specimen P.

According to the second embodiment, the correction processing portion 144 is configured to correct a reduction in the signal intensity of the photoacoustic wave signals resulting from attenuation of the light from the light source portion 10 according to an increase in the distance d from the position of the light applied from the light source portion 10 to the prescribed position in the specimen P by multiplying the photoacoustic wave signals by a correction coefficient Z2 expressed by the following formula (2) where a constant related to the position of the light applied from the light source portion 10 is k2.

Z2=10^{k2×d} (2)

Specifically, the correction processing portion 144 is configured to correct a reduction in the signal intensity of the photoacoustic wave signals resulting from attenuation of the light from the light source portion 10 according to an increase in the distance d from the position of the light applied from the light source portion 10 to the prescribed position in the specimen P by multiplying a signal value (signal intensity) at each coordinate point in the N-M coordinate data stored in a first memory 42 by Z2, similarly to the case of the correction coefficient Z1 according to the aforementioned first embodiment. In other words, according to the second embodiment, the signal value (signal intensity) at each coordinate point in the N-M coordinate data stored in the first memory 42 is multiplied by both the correction coefficients Z1 and Z2. For example, a signal value Xₙₘ at a coordinate point (n, m) in the N-M coordinate data is multiplied by both the correction coefficients Z1 and Z2 at the coordinate point (n, m), whereby a signal value Yₙₘ (=Z1×Z2×Xₙₘ) after correction at the coordinate point (n, m) is obtained, as shown in FIG. 11. Similarly, the correction processing portion 144 acquires the N-M coordinate data after correction shown in FIG. 11 by multiplying a signal value at each of all coordinate points from a coordinate point (1, 1) to a coordinate point (N, M) in the N-M coordinate data by both the correction coefficients Z1 and Z2 at each of all the coordinate points. Then, the N-M coordinate data after correction is output from the correction processing portion 144 to a second memory 45. Thereafter, a phasing addition portion 46 performs phasing addition, and a photoacoustic wave image is constructed (generated), similarly to the aforementioned first embodiment.

As described above, the constant k2 is a constant related to the position of the light applied from the light source portion 10. More specifically, the constant k2 is a constant related to the distance d from the position of the light applied from the light source portion 10 to the specimen P to the prescribed position in the specimen P. In other words, the constant k2 is a constant for correcting attenuation of light (a reduction in light intensity) generated in the specimen P with respect to the distance d. The attenuation of light (the reduction in light intensity) generated in the specimen P with respect to the distance d is corrected, whereby a reduction in the signal intensity of the photoacoustic wave signals resulting from the attenuation of light can be corrected.

The constant k2 can be properly determined according to measurement conditions for the specimen P (a human body or another animal), a measurement site of the specimen P, or the like. In consideration of this point, the constant k2 is preferably at least 0.2 and not more than 0.8 when the position of the light applied from the light source portion 10 is on a side closer to the detection portion 20 (in other words, the light source portion 10 is arranged adjacent to the detection portion 20 so that the position of the light applied from the light source portion 10 is adjacent to the detection portion 20), as shown in FIG. 10, and a unit of the distanced (=m×p×c) is cm. When the constant k2 is a positive value, the correction coefficient Z2 is more than 1. In this case, a reduction in the signal intensity of the photoacoustic wave signals resulting from attenuation of the light from the light source portion 10 is corrected by increasing the signal intensity of the photoacoustic wave signals according to an increase in the distance d from the position of the light applied from the light source portion 10 to the prescribed position in the specimen P. In other words, in this case, a difference in relative signal intensity at each coordinate point in the N-M coordinate data caused by a reduction in the signal intensity of the photoacoustic wave signals resulting from attenuation of the light from the light source portion 10 is corrected to be reduced by increasing the signal intensity of the photoacoustic wave signals.

When the position of the light applied from the light source portion 10 is on a side opposite to the detection portion 20 (in other words, the light source portion 10 is arranged opposite to the detection portion 20 so that the position of the light applied from the light source portion 10 is opposite to the detection portion 20), as shown in FIG. 12, and a unit of the distance d is cm, the constant k2 is preferably at least −0.8 and not more than −0.2. Even when the position of the light applied from the light source portion 10 is on the side opposite to the detection portion 20, a distance from the position of virtually applied light to the prescribed position in the specimen P in the case where the position of the light applied from the light source portion 10 is on the side closer to the detection portion 20 is set to d (=m×p×c). When the constant k2 is a negative value, the correction coefficient Z2 is less than 1. In this case, a reduction in the signal intensity of the photoacoustic wave signals resulting from attenuation of the light from the light source portion 10 is corrected by reducing the signal intensity of the photoacoustic wave signals according to an increase in the distance d from the position of the virtually applied light to the prescribed position in the specimen P. In other words, a reduction in the signal intensity of the photoacoustic wave signals resulting from attenuation of the light from the light source portion 10 is corrected by reducing the signal intensity of the photoacoustic wave signals to reduce the amount of reduction in the signal intensity of the photoacoustic wave signals according to an increase in the distance from the position of the light actually applied from the light source portion 10. Thus, in this case, the difference in relative signal intensity at each coordinate point in the N-M coordinate data caused by a reduction in the signal intensity of the photoacoustic wave signals resulting from attenuation of the light from the light source portion 10 is corrected to be reduced by reducing the signal intensity of the photoacoustic wave signals.

Consequently, in the structure of obtaining the distance d by the same formula both when the position of the light applied from the light source portion 10 is on the side closer to the detection portion 20 and when the position of the light applied from the light source portion 10 is on the side opposite to the detection portion 20, the difference in relative signal intensity at each coordinate point in the N-M coordinate data can be reliably corrected to be reduced.

Results of an experiment conducted in order to determine the constant k2 are now described with reference to FIG. 13. FIG. 13 shows a semilogarithmic graph in which the horizontal axis shows a thickness (cm) and the vertical axis shows light transmittance (%) and is logarithmic. The experiment was conducted with respect to air (air space), agar, chicken, and pork. In the experiment, near infrared light (light with a center wavelength of 850 nm) was used. As shown in FIG. 13, the degree of a reduction in transmittance (attenuation of light) was smallest in the case of the air, and the degree of a reduction in transmittance (attenuation of light) was largest in the case of the pork. In the case of the pork, the thickness was 3 cm, and the transmittance was 1.5%. Therefore, the constant k2 is k2=−Log(1.5/100)/3=about 0.6 (cm⁻¹) in terms of attenuation of light per cm in the case of the pork. In the case of the air, the thickness was 3 cm, and the transmittance was 33%. Therefore, the constant k2 is k2=−Log(33/100)/3=about 0.2 (cm⁻¹) in terms of attenuation of light per cm in the case of the air. In view of attenuation of light in the specimen P such as the human body, the constant k2 is more preferably at least 0.2 and not more than 0.6 (when the position of the light applied from the light source portion 10 is on the side closer to the detection portion 20, as shown in FIG. 10) or at least −0.6 and not more than −0.2 (when the position of the light applied from the light source portion 10 is on the side opposite to the detection portion 20, as shown in FIG. 12).

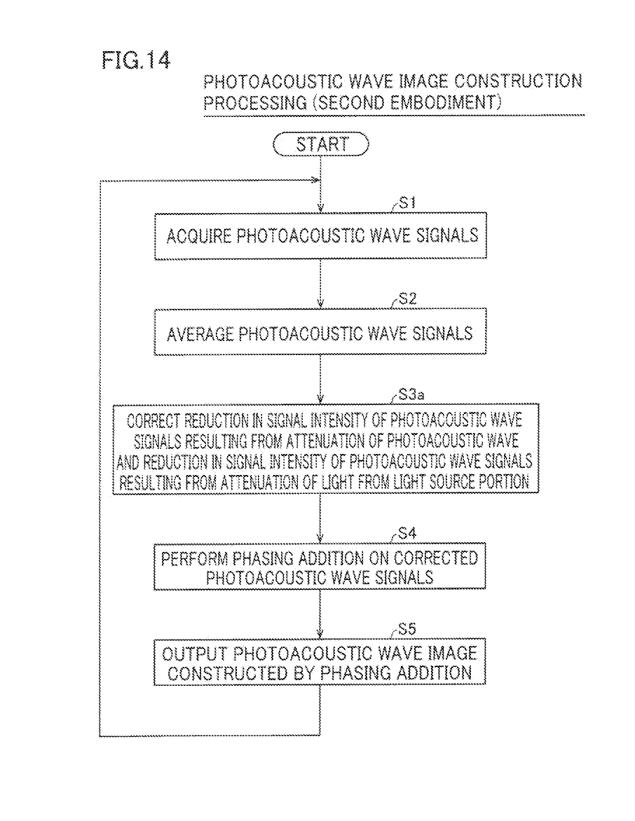

Photoacoustic wave image construction processing performed by the signal processing portion 131 of the imager body 130 according to the second embodiment is now described on the basis of a flowchart with reference to FIG. 14.

First, the photoacoustic wave signals are acquired at a step S1. Then, a plurality (P sets) of photoacoustic wave signals are averaged at a step S2. The processing at the steps S1 and S2 is similar to that according to the aforementioned first embodiment.

Then, a reduction in the signal intensity of the photoacoustic wave signals resulting from attenuation of the photoacoustic wave AW is corrected while a reduction in the signal intensity of the photoacoustic wave signals resulting from attenuation of the light from the light source portion 10 is corrected at a step S3a. Specifically, the correction processing portion 144 acquires the N-M coordinate data stored in the first memory 42 and makes a correction by multiplying the signal value (signal intensity) of each coordinate point in the acquired N-M coordinate data by both the correction coefficients Z1 and Z2. Thus, the N-M coordinate data in which both a reduction in the signal intensity of the photoacoustic wave signals resulting from attenuation of the photoacoustic wave AW and a reduction in the signal intensity of the photoacoustic wave signals resulting from attenuation of the light from the light source portion 10 are corrected is obtained.

Then, phasing addition is performed on the corrected photoacoustic wave signals at a step S4. Thereafter, processing at a step S5 is performed similarly to the aforementioned first embodiment. Consequently, according to the second embodiment, a clearer photoacoustic wave image is displayed on a monitor 32 through two types of correction processing. Then, the signal processing portion 131 returns to the step S1 and acquires subsequent photoacoustic wave signals.

The remaining structures of the photoacoustic imager 200 according to the second embodiment are similar to those of the photoacoustic imager 100 according to the aforementioned first embodiment.

According to the second embodiment, the following effects can be obtained.

According to the second embodiment, as hereinabove described, the signal processing portion 131 is configured to correct a reduction in the signal intensity of the photoacoustic wave signals resulting from attenuation of the light from the light source portion 10 according to an increase in the distance d from the position of the light applied from the light source portion 10 to the specimen P to the prescribed position (Po) in the specimen P in addition to correcting a reduction in the signal intensity of the photoacoustic wave signals resulting from attenuation of the photoacoustic wave AW. Thus, even if the light from the light source portion 10 attenuates before reaching the detection object Q in the specimen P, a reduction in the signal intensity of the photoacoustic wave signals resulting from attenuation of the light from the light source portion 10 can be corrected. Consequently, a reduction in the signal intensity of the photoacoustic wave signals resulting from attenuation of the light from the light source portion 10 can be corrected in addition to correcting a reduction in the signal intensity of the photoacoustic wave signals resulting from attenuation of the photoacoustic wave AW. Therefore, a reduction in the signal intensity of the photoacoustic wave signals can be more properly corrected. Thus, according to the second embodiment, the clearer photoacoustic wave image can be obtained by phasing addition.

According to the second embodiment, as hereinabove described, the signal processing portion 131 is configured to correct a reduction in the signal intensity of the photoacoustic wave signals resulting from attenuation of the light from the light source portion 10 according to an increase in the distance d from the position of the applied light to the prescribed position in the specimen P by multiplying the photoacoustic wave signals by the correction coefficient Z2 expressed by the aforementioned formula (2). Thus, a reduction in the signal intensity of the photoacoustic wave signals resulting from attenuation of the light from the light source portion 10 can be reliably corrected according to a reduction (the amount of reduction) in the signal intensity resulting from attenuation of the light from the light source portion 10 by the aforementioned formula (2).

According to the second embodiment, as hereinabove described, the constant k2 is set to at least 0.2 and not more than 0.8 when the position of the light applied from the light source portion 10 is on the side closer to the detection portion 20 and a unit of the distance d from the position of the applied light to the prescribed position in the specimen P is cm. Furthermore, the constant k2 is set to at least −0.8 and not more than −0.2 when the position of the light applied from the light source portion 10 is on the side opposite to the detection portion 20, the distance from the position of the light applied from the light source portion 10 to the prescribed position in the specimen P in the case where the position of the applied light is on the side closer to the detection portion 20 is set to d, and a unit of the distance d from the position of the applied light to the prescribed position in the specimen P is cm. Thus, the correction coefficient Z2 can be properly acquired according to the position of the light applied from the light source portion 10. Consequently, the signal intensity of the photoacoustic wave signals reduced by attenuation of the light from the light source portion 10 can be properly increased.

According to the second embodiment, as hereinabove described, the width W1 of the light source portion 10 in the arrangement direction in which the plurality of detection elements 21 are arranged is larger than the width W2 of all the plurality of detection elements 21 in the arrangement direction. Thus, the light from the light source portion 10 can be reliably applied to an entire region of the plurality of detection elements 21 in the arrangement direction. Consequently, insufficient generation of the photoacoustic wave AW from the detection object Q in a range detectable by the plurality of detection elements 21 caused by a small amount of applied light can be significantly reduced or prevented. Thus, the plurality of detection elements 21 can properly detect the detection object Q in the range detectable by the plurality of detection elements 21.

The remaining effects of the second embodiment are similar to those of the aforementioned first embodiment.

### Third Embodiment

A third embodiment is now described with reference to FIGS. 1, 7, and 15 to 17. In this third embodiment, a reduction in the signal intensity of photoacoustic wave signals resulting from the sensitivity of detection elements 21 is corrected in addition to the aforementioned structure according to the first embodiment. Portions of a photoacoustic imager 300 similar to those of the photoacoustic imager 100 according to the aforementioned first embodiment are denoted by the same reference numerals as those in the first embodiment, and redundant description is omitted.

The photoacoustic imager 300 according to the third embodiment of the present invention includes a light source portion 10, a detection portion 20, and a photoacoustic imager body (hereinafter referred to as the imager body) 230, as shown in FIG. 1. The imager body 230 is provided with a signal processing portion 231. The signal processing portion 231 is similar in structure to the signal processing portion 31 according to the aforementioned first embodiment except that the signal processing portion 231 is provided with a phasing addition portion 246.

As shown in FIG. 15, the detection elements 21 are different in sensitivity (detection sensitivity) from each other by directions from which a photoacoustic wave is incident (incident directions). For example, the sensitivity of the detection elements 21 each having a rectangular shape as shown in FIG. 15 is highest when the photoacoustic wave is incident from a direction vertical to detection surfaces of the detection elements 21. As an incidence angle θ that is an angle formed by the direction vertical to the detection surfaces and the incident direction of the photoacoustic wave increases, the sensitivity decreases. In FIG. 15, the magnitude of the sensitivity with respect to the incidence angle θ of a first detection element 21 is conceptually expressed by the lengths of arrows.

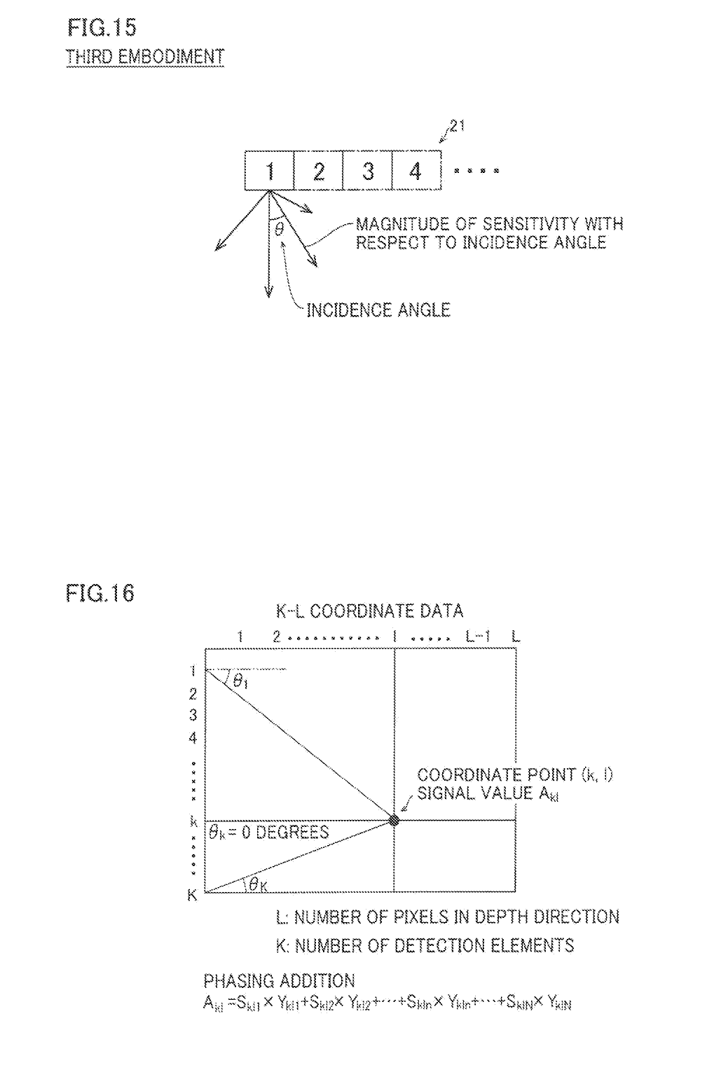

According to the third embodiment, the phasing addition portion 246 is configured to correct a reduction in the signal intensity of the photoacoustic wave signals resulting from the sensitivity of the detection elements 21 when acquiring a signal value (signal intensity) of each coordinate point in K-L coordinate data (see FIG. 16) on the basis of N-M coordinate data (see FIG. 7) after correction by phasing addition, as shown in FIG. 1.

Specifically, the phasing addition portion 246 is configured to acquire the incidence angle θ of each of the detection elements 21 with respect to a coordinate point at which a signal value is acquired when acquiring the signal value of each coordinate point in the K-L coordinate data by phasing addition. The phasing addition portion 246 is configured to acquire the sensitivity correction coefficient Sₖₗ of each of the detection elements 21 on the basis of the acquired incidence angle θ. The sensitivity correction coefficient Sₖₗ can be previously set, and the previously set value can be employed according to the incidence angle θ, for example. The magnitude of the sensitivity of each of the detection elements 21 with respect to the incidence angle θ also varies by the shape of each of the detection elements 21, and hence the sensitivity correction coefficient Sₖₗ is preferably to set in consideration of the shape of each of the detection elements 21. The phasing addition portion 246 is configured to multiply a signal value at a coordinate point corresponding to each of the detection elements 21 for phasing addition by the acquired sensitivity correction coefficient Sₖₗ of each of the detection elements 21. Thus, the phasing addition portion 246 is configured to correct a reduction in the signal intensity of the photoacoustic wave signals resulting from the sensitivity of the detection elements 21 when acquiring the signal value (signal intensity) of each coordinate point in the K-L coordinate data by phasing addition.

For example, the phasing addition portion 246 acquires the incidence angles θ₁ to θ_{K} of the respective detection elements 21 with respect to a coordinate point (k, l) when acquiring a signal value Aₖₗ at the coordinate point (k, l), as shown in FIG. 16. Then, the phasing addition portion 246 acquires correction coefficients Sₖₗ₁ to S_{klK} corresponding to the incidence angles θ₁ to θ_{K}, respectively, on the basis of the acquired incidence angles θ₁ to θ_{K}. Then, the phasing addition portion 246 acquires the signal value Aₖₗ (=Sₖₗ₁×Yₖₗ₁+Sₖₗ₂×Yₖₗ₂+ . . . +Sₖₗₙ×Yₖₗₙ+ . . . +S_{klN}×Y_{klN}) at the coordinate point (k, l) by multiplying signal values Yₖₗ₁ to Y_{klN} at the coordinate point corresponding to the respective detection elements 21 by the corresponding correction coefficients Sₖₗ₁ to S_{klK} and adding the products. In this manner, the phasing addition portion 246 corrects a reduction in the signal intensity of the photoacoustic wave signals resulting from the sensitivity of the detection elements 21 when acquiring the signal value at the coordinate point (k, l) by phasing addition. Similarly, the phasing addition portion 246 acquires signal values at all coordinate points from a coordinate point (1, 1) to a coordinate point (K, L) in the K-L coordinate data by phasing addition. Thus, the K-L coordinate data (see FIG. 16) in which a reduction in the signal intensity of the photoacoustic wave signals resulting from the sensitivity of the detection elements 21 is corrected is generated, and a photoacoustic wave image based on the K-L coordinate data is constructed. Thereafter, the photoacoustic wave image based on the K-L coordinate data is stored in a third memory 47, similarly to the aforementioned first embodiment.

In other words, according to the third embodiment, the phasing addition portion 246 corrects a reduction in the signal intensity of the photoacoustic wave signals resulting from the sensitivity of the detection elements 21 while a correction processing portion 44 corrects a reduction in the signal intensity of the photoacoustic wave signals resulting from attenuation of the photoacoustic wave by the correction coefficient Z1 obtained by the formula (1).

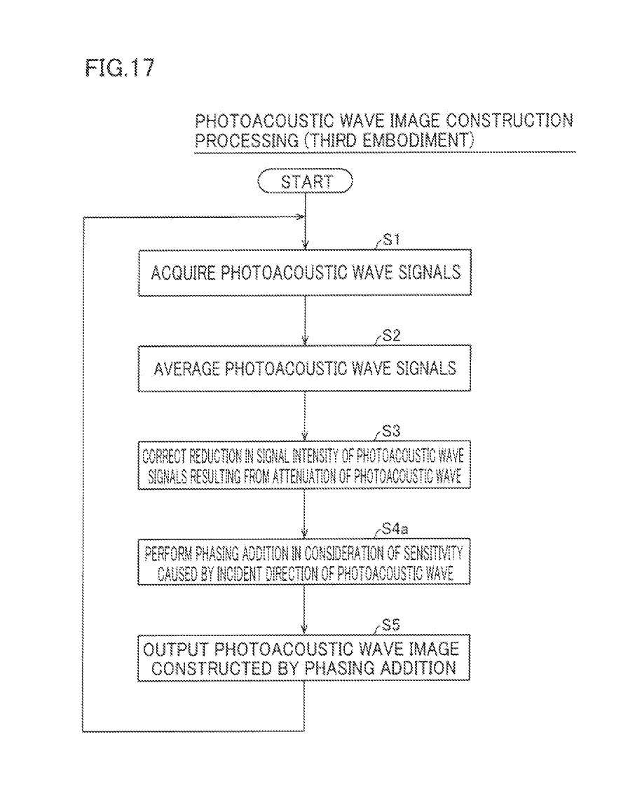

Photoacoustic wave image construction processing performed by the signal processing portion 231 of the imager body 230 according to the third embodiment is now described on the basis of a flowchart with reference to FIG. 17.

First, the photoacoustic wave signals are acquired at a step S1. Then, a plurality (P sets) of photoacoustic wave signals are averaged at a step S2. Then, the correction processing portion 44 corrects a reduction in the signal intensity of the photoacoustic wave signals resulting from attenuation of the photoacoustic wave at a step S3. The processing at the steps S1 to S3 is similar to that according to the aforementioned first embodiment.

Then, the phasing addition portion 246 performs phasing addition in consideration of the sensitivity caused by the incident direction with respect to the detection elements 21 at a step S4a. Specifically, the phasing addition portion 246 acquires the N-M coordinate data stored in a second memory 45 after correction by the correction processing portion 44 and makes a correction by multiplying the signal value at the coordinate point corresponding to each of the detection elements 21 by the sensitivity correction coefficient Sₖₗ of each of the detection elements 21 when acquiring the signal value (signal intensity) of each coordinate point in the K-L coordinate data on the basis of the acquired N-M coordinate data by phasing addition. Through the processing at the steps S3 and S4a, the K-L coordinate data in which both a reduction in the signal intensity of the photoacoustic wave signals resulting from attenuation of the photoacoustic wave and a reduction in the signal intensity of the photoacoustic wave signals resulting from the sensitivity of the detection elements 21 are corrected is obtained.

Thereafter, processing at a step S5 is performed similarly to the aforementioned first embodiment. Consequently, also according to the third embodiment, a clearer photoacoustic wave image is displayed on a monitor 32 through two types of correction processing. Then, the signal processing portion 231 returns to the step S1 and acquires subsequent photoacoustic wave signals.

The remaining structures of the photoacoustic imager 300 according to the third embodiment are similar to those of the photoacoustic imager 100 according to the aforementioned first embodiment.

According to the third embodiment, the following effects can be obtained.

According to the third embodiment, as hereinabove described, the signal processing portion 231 is configured to correct a reduction in the signal intensity of the photoacoustic wave signals resulting from the sensitivity of the detection elements 21 on the basis of the sensitivity caused by the incident direction of the photoacoustic wave with respect to the detection elements 21 in addition to correcting a reduction in the signal intensity of the photoacoustic wave signals resulting from attenuation of the photoacoustic wave. Thus, even if the signal intensity of the detected photoacoustic wave signals is reduced by a difference in the sensitivity of the detection elements 21 caused by the incident direction of the photoacoustic wave with respect to the detection elements 21, a reduction in the signal intensity of the photoacoustic wave signals resulting from the sensitivity of the detection elements 21 can be corrected. Consequently, a reduction in the signal intensity of the photoacoustic wave signals resulting from the sensitivity of the detection elements 21 can be corrected in addition to correcting a reduction in the signal intensity of the photoacoustic wave signals resulting from attenuation of the photoacoustic wave. Therefore, a reduction in the signal intensity of the photoacoustic wave signals can be more properly corrected. Consequently, also according to the third embodiment, the clearer photoacoustic wave image can be obtained by phasing addition.

The remaining effects of the third embodiment are similar to those of the aforementioned first embodiment.

### Fourth Embodiment

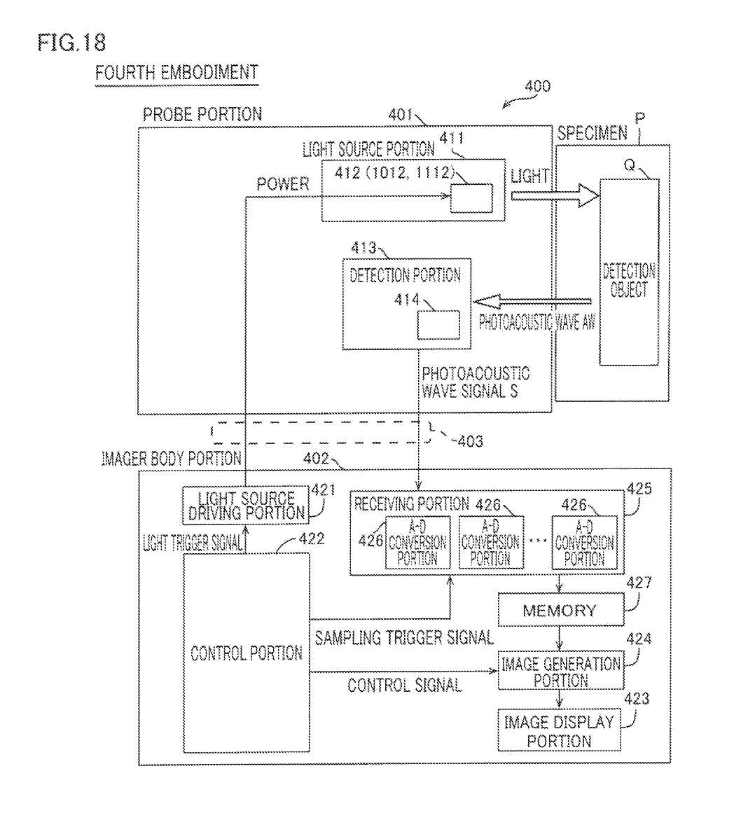

A fourth embodiment is now described with reference to FIGS. 18 to 25. In this fourth embodiment, a photoacoustic wave image is generated by a statistical method, unlike the aforementioned first to third embodiments in which the photoacoustic wave image is generated by phasing addition.

The overall structure of a photoacoustic imager 400 according to the fourth embodiment of the present invention is described with reference to FIGS. 18 to 23. According to the fourth embodiment, the photoacoustic imager 400 has a function of detecting a photoacoustic wave AW (photoacoustic wave signals S) from a detection object Q (such as blood) in a specimen P (such as a human body) and generating a photoacoustic wave image R by the statistical method. The statistical method is an example of the “prescribed signal processing” in the present invention.

The photoacoustic imager 400 according to the fourth embodiment of the present invention is provided with a probe portion 401 and an imager body portion 402, as shown in FIG. 18. The photoacoustic imager 400 is also provided with a cable 403 connecting the probe portion 401 and the imager body portion 402 to each other.

The probe portion 401 is so configured that the same is grasped by an operator and arranged on a surface of the specimen P (such as a surface of the human body). Furthermore, the probe portion 401 is configured to be capable of applying light to the specimen P, to detect the photoacoustic wave AW, described later, from the detection object Q in the specimen P, and to transmit the photoacoustic wave AW as the photoacoustic wave signals S to the imager body portion 402 through the cable 403.

The imager body portion 402 is configured to process and image the photoacoustic wave signals S detected by the probe portion 401 and to display the imaged photoacoustic wave signals S (the photoacoustic wave image R described later).

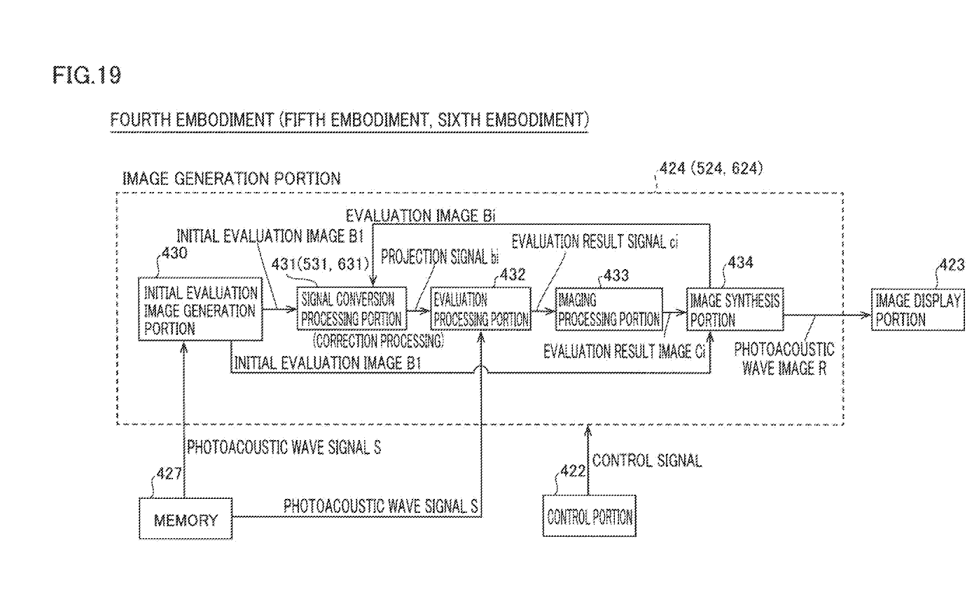

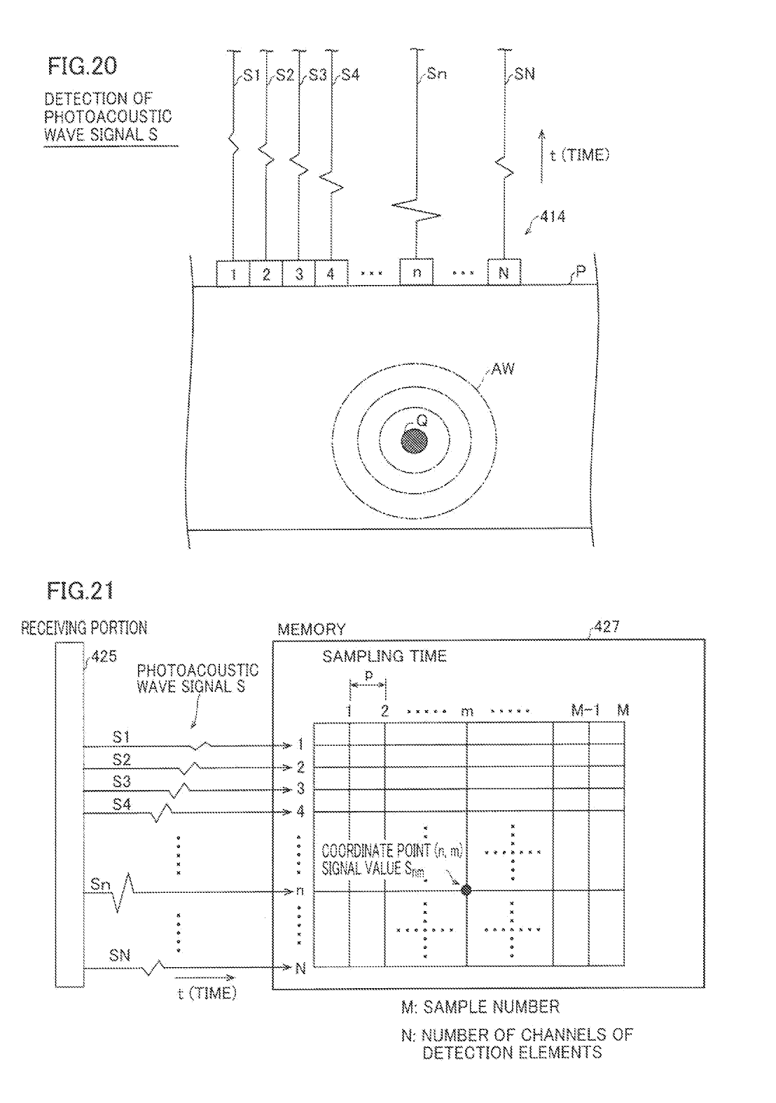

According to the fourth embodiment, the photoacoustic imager 400 is configured to generate the photoacoustic wave image R by processing employing the statistical method for making an approximation while repetitively performing signal conversion processing for generating an evaluation image Bi with which an evaluation is made by comparison with the photoacoustic wave signals S and converting the generated evaluation image Bi into projection signals bi to be compared with the photoacoustic wave signals S and processing for generating a new evaluation image Bi by performing imaging processing for imaging evaluation result signals ci based on results of comparison between the projection signals bi and the photoacoustic wave signals S, as shown in FIG. 19. Furthermore, the photoacoustic imager 400 is configured to perform correction processing for correcting the signal intensity of the projection signals bi of the evaluation image Bi to respond to a reduction in the signal intensity of the photoacoustic wave signals S resulting from attenuation of the photoacoustic wave AW during the signal conversion processing.

The structure of the photoacoustic imager 400 is now described in detail.

As shown in FIG. 18, the probe portion 401 is provided with a light source portion 411. According to the fourth embodiment, the light source portion 411 includes a plurality of semiconductor light-emitting elements 412 including at least ones of light-emitting diode elements, semiconductor laser elements, and organic light-emitting diode elements. The semiconductor light-emitting elements 412 are configured to be capable of emitting pulsed light having a wavelength (a wavelength of about 850 nm, for example) in an infrared region by being supplied with power from a light source driving portion 421 described later. The light source portion 411 is configured to apply the light emitted from the plurality of semiconductor light-emitting elements 412 to the specimen P.

The imager body portion 402 is provided with the light source driving portion 421. The light source driving portion 421 is configured to acquire power from an external power source (not shown). The light source driving portion 421 is further configured to supply power to the light source portion 411 on the basis of a light trigger signal received from a control portion 422 described later. The light trigger signal is configured as a signal whose frequency is 1 kHz, for example. Thus, the light source portion 411 is configured to apply pulsed light whose repetition frequency is 1 kHz to the specimen P.

The imager body portion 402 is also provided with the control portion 422 and an image display portion 423. The control portion 422 is configured to control operations of each portion of the photoacoustic imager 400. The image display portion 423 is configured to be capable of displaying the photoacoustic wave image R generated by an image generation portion 424 described later. The image generation portion 424 is an example of the “signal processing portion” in the present invention.

The probe portion 401 is also provided with a detection portion 413. As shown in FIG. 20, the detection portion 413 includes detection elements 414 (lead zirconate titanate (PZT), for example) of N channels (N detection elements). The detection elements 414 are arranged in an array in the vicinity of a tip end of an internal portion of an unshown housing of the probe portion 401. The number N of channels of the detection elements 414 can be 64, 128, 192, or 256, for example.

Detection of the photoacoustic wave signals S by the detection portion 413 and reception of the photoacoustic wave signals S by a receiving portion 425 are now described with reference to FIGS. 20 and 21.

According to the fourth embodiment, the detection portion 413 is configured to generate the photoacoustic wave signals S including RF (radio frequency) signals on the basis of the detected photoacoustic wave AW.

As shown in FIG. 20, the detection object Q (such as hemoglobin in the blood) in the specimen P absorbs the pulsed light applied from the probe portion 401 to the specimen P. The detection object Q generates the photoacoustic wave AW by expanding and contracting (returning to the original size from an expanding state) in response to the intensity of application (the quantity of absorption) of the pulsed light. The photoacoustic wave AW is generated from a wide range at a time by light application, but in FIG. 20, only one detection object Q is illustrated for ease of understanding.

According to the fourth embodiment, the detection portion 413 is configured to detect the photoacoustic wave AW generated by the absorption of the light applied from the light source portion 411 to the specimen P by the detection object Q in the specimen P and to acquire the photoacoustic wave signals S (RF signals).

Specifically, the detection elements 414 of N channels in the detection portion 413 are configured to vibrate and acquire the photoacoustic wave signals S when acquiring the photoacoustic wave AW. Therefore, the photoacoustic wave signals S contain information about the channels of the detection elements 414 and information about the signal intensity, a signal frequency f, and a detection time t. The information about the channels of the detection elements 414 corresponds to the positional information of the detection portion 413 in a width direction, and the detection time t corresponds to positional information in a depth direction of the specimen P.

The detection portion 413 (see FIG. 18) receives the photoacoustic wave AW generated from the detection object Q by the N detection elements 414 and detects the photoacoustic wave signals S. FIG. 20 shows the photoacoustic wave signals S detected by the detection elements 414 as photoacoustic wave signals S1 to SN. The photoacoustic wave signals S1 to SN detected by the detection elements 414 are output from the detection portion 413 to the imager body portion 402 and are received by the receiving portion 425 of the imager body portion 402.

The receiving portion 425 includes N A-D conversion portions 426 (see FIG. 18). The N respective A-D conversion portions 426 are configured to acquire the photoacoustic wave signals S1 to SN detected by the detection elements 414. An n^{th} (1≦n≦N) A-D conversion portion 426 acquires a photoacoustic wave signal Sn detected by an n^{th} detection element 414, for example.

The respective A-D conversion portions 426 are configured to convert the acquired photoacoustic wave signals L1 to LN from analog signals into digital signals with a prescribed sampling frequency and prescribed bit resolution. The respective A-D conversion portions 426 are configured to output the photoacoustic wave signals S1 to SN as digital signals to a memory 427.

The photoacoustic wave signals S1 to SN stored in the memory 427 are now described in more detail.

The memory 427 is configured to store the photoacoustic wave signals S1 to SN output from the respective A-D conversion portions 426, as shown in FIG. 21.

The photoacoustic wave signals S1 to SN include data obtained by configuring information about the width direction of the detection portion 413 and information about the depth direction from the surface of the specimen P in a matrix. Specifically, the photoacoustic wave signals S1 to SN are configured by a matrix of the number N of detection elements 414 and the sample number M. The sample number M is a sample number for a signal up to a depth desired to be imaged in each of the photoacoustic wave signals L1 to LN. When the depth desired to be imaged is 6 cm (0.06 m) from the surface of the specimen P, the velocity of sound in the human body is 1530 m/s, and the prescribed sampling frequency of the A-D conversion portions 426 is 20×10⁶ Hz, for example, the sample number M is M=(0.06/1530)×20×10⁶≈800. The sample number M indicates the number of pixels in the depth direction, and in the case of the aforementioned calculation example, for example, there are about 800 pixels in the depth direction.

Points of the M-coordinate of the photoacoustic wave signals S1 to SN are arranged at a time interval corresponding to a sampling time p. The sampling time p is a time corresponding to one cycle of the prescribed sampling frequency of the A-D conversion portions 426. When the prescribed sampling frequency of the A-D conversion portions 426 is 20×10⁶ Hz, for example, the sampling time p is 0.05 μs. In other words, the M-coordinate corresponds to the detection time t of each of the detected photoacoustic wave signals L1 to LN. When the M-coordinate is m (1≦m≦M), for example, the detection time t is obtained by multiplying m by p. In other words, t=m×p. Therefore, each of the photoacoustic wave signals S1 to SN can be said to be data having information about the detection time t. One set of photoacoustic wave signals S1 to SN is generated per pulsed light emission by the light source portion 411.

Generation of the photoacoustic wave image R by the processing employing the statistical method in the image generation portion 424 is now described with reference to FIGS. 19, 22, and 23.

According to the fourth embodiment, as the statistical method, a method for making an approximation while repetitively performing the signal conversion processing for generating the evaluation image Bi with which an evaluation is made by comparison with the photoacoustic wave signals S and converting the generated evaluation image Bi into the projection signals bi to be compared with the photoacoustic wave signals S and processing (image synthesis processing) for generating a new evaluation image Bi+1 by performing the imaging processing for imaging the evaluation result signals ci based on the results of comparison (evaluation processing) between the projection signals bi and the photoacoustic wave signals S is employed. Here, i represents the number of times approximation has been repeated, and the image generation portion 424 is configured to repeat approximation until i becomes a prescribed number I.

According to the fourth embodiment, as the processing employing the statistical method, the OS-EM (ordered-subsets expectation maximization) method is employed. In other words, the image generation portion 424 divides projection signals bi1 to biN and the photoacoustic wave signals S1 to SN into E subsets (groups) when comparing the projection signals bi with the photoacoustic wave signals S. When the detection portion 413 includes sixty-four (N=64) detection elements 414, for example, the image generation portion 424 divides the projection signals bi1 to biN and the photoacoustic wave signals S1 to SN into eight subsets (E=8) by including eight signals in each subset.

The image generation portion 424 performs the imaging processing, the signal conversion processing, the correction processing, the evaluation processing, and the image synthesis processing, all described later, on a first subset and thereafter performs all the above processing (performs processing, setting the above i as i+1) also on a second subset, for example. After performing all the above processing on all the E subsets and performing all the above processing on all the subsets, the image generation portion 424 performs all the above processing (performs processing, setting the above i as i+E) on the first subset again. Then, the image generation portion 424 repeats the above processing until i becomes the prescribed number I. Then, the image generation portion 424 generates an evaluation image BI as the photoacoustic wave image R.

The processing employing the statistical method is not limited to the OS-EM method, but the ML-EM (maximum likelihood-expectation maximization) method, the MAP-EM (maximum a posteriori-expectation maximization) method, the ART (algebraic reconstruction technique), the SIRT (simultaneous iterative reconstruction technique), the SART (statistical algebraic reconstruction technique), the IRT (iterative reconstruction technique), etc. can be employed. However, the above OS-EM method requires a shorter time to focus approximations than the ML-EM method etc., and hence the time required to generate the photoacoustic wave image R can be reduced. Furthermore, the time required to focus the approximations is short, and hence an increase in a processing load on the image generation portion 424 can be significantly reduced or prevented. In general, a load of the processing employing the statistical method is easily increased, and hence the OS-EM method is particularly preferably employed in view of this.

The structure of the image generation portion 424 is now described.

As shown in FIG. 19, the image generation portion 424 includes an initial evaluation image generation portion 430, a signal conversion processing portion 431, an evaluation processing portion 432, an imaging processing portion 433, and an image synthesis portion 434 and is configured as a functional block capable of performing the above processing employing the statistical method on the basis of a control signal from the control portion 422. In the processing employing the statistical method, a processing load on the image generation portion 424 is increased as compared with in processing employing an analytical method, and hence the image generation portion 424 preferably includes a GPU (graphics processing unit) capable of performing processing at a relatively high speed. In this case, the photoacoustic imager 400 can easily perform the processing employing the statistical method even when a processing load on the image generation portion 424 is relatively increased.

The imaging processing, the signal conversion processing, the correction processing, the evaluation processing, and the image synthesis processing in the photoacoustic imager 400 according to the fourth embodiment are now described with reference to FIGS. 19, 22, and 23.

(Imaging Processing and Generation Processing for Initial Evaluation Image B1)

According to the fourth embodiment, the initial evaluation image generation portion 430 is configured to generate an initial evaluation image B1 that is a first (i=1) evaluation image Bi by performing the processing employing the analytical method on the photoacoustic wave signals S1 to SN. According to the fourth embodiment, a phasing addition method is employed as the processing employing the analytical method. The processing employing the analytical method is not limited to the phasing addition method, but a CBP (circular backprojection) method, a two-dimensional Fourier transform method, and an HTA (Hough transform algorithm) method can be employed.

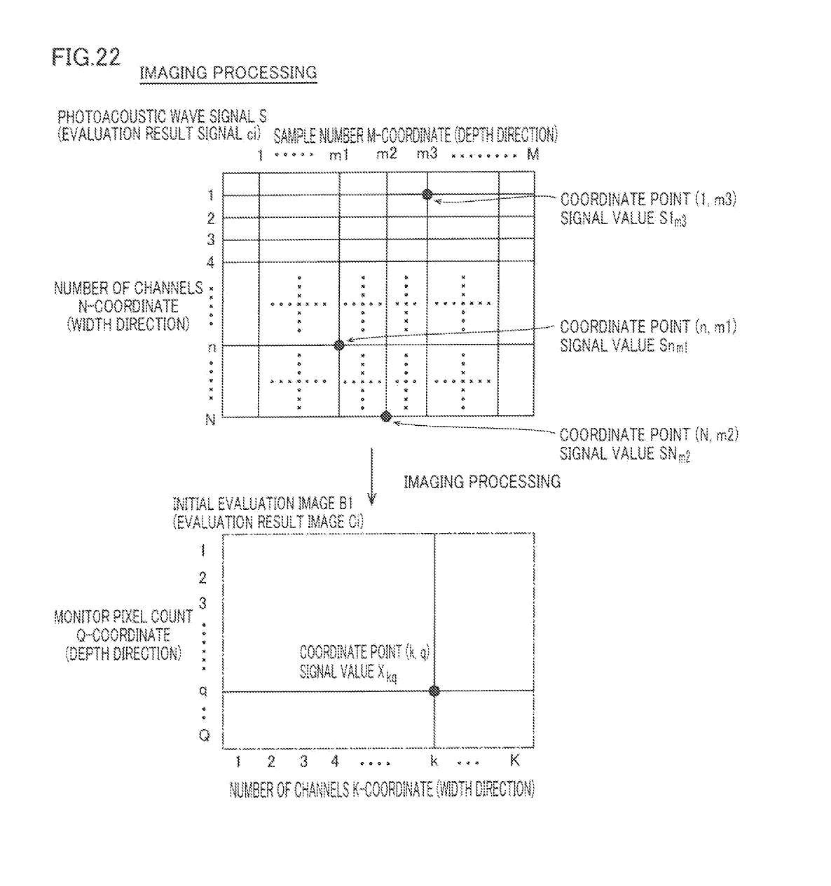

FIG. 22 shows the photoacoustic wave signals S configured as data containing information about coordinates of the number N of channels and the sample number M and the initial evaluation image B1 configured by information about the number K of channels and pixel signals of the monitor pixel count Q. The initial evaluation image generation portion 430 is further configured to perform imaging processing for converting the photoacoustic wave signals S into the initial evaluation image B1.

The initial evaluation image B1 includes data obtained by configuring information (K-coordinate) about the width direction of the detection portion 413 and information (Q-coordinate) about the depth direction from the surface of the specimen P in a matrix, similarly to the photoacoustic wave signals S1 to SN. The initial evaluation image B1 is set to the number K of channels and the monitor pixel count Q corresponding to the resolution of the image display portion 423. Specifically, the number K of channels of the initial evaluation image B1 is set to a number equal to, multiples of, or half the number N of channels of the detection elements 414 of the detection portion 413, and the monitor pixel count Q of the initial evaluation image B1 is set to a number equal to or half the sample number M.

The photoacoustic wave signals S1 to SN are backprojected into an image containing the information about the number K of channels and the pixel signals of the monitor pixel count Q while being filtered, whereby the initial evaluation image B1 is generated. As shown in FIG. 22, for example, an image is generated at a coordinate point (k, q) containing a signal value X_{kq} in the initial evaluation image B1 on the basis of signal values S1ₘ₃, . . . , Snₘ₁, . . . , and SNₘ₂ at N coordinate points (1, m3), . . . , (n, m1), . . . , and (N, m2), respectively, of the photoacoustic wave signals S.

(Signal Conversion Processing)

The signal conversion processing portion 431 is configured to acquire the evaluation image Bi from the initial evaluation image generation portion 430 or the image synthesis portion 434 described later, as shown in FIG. 19. The signal conversion processing portion 431 is configured to acquire the initial evaluation image B1 from the initial evaluation image generation portion 430 when acquiring the initial evaluation image B1 and to acquire the evaluation image Bi from the image synthesis portion 434 when acquiring the evaluation image Bi other than the initial evaluation image B1.

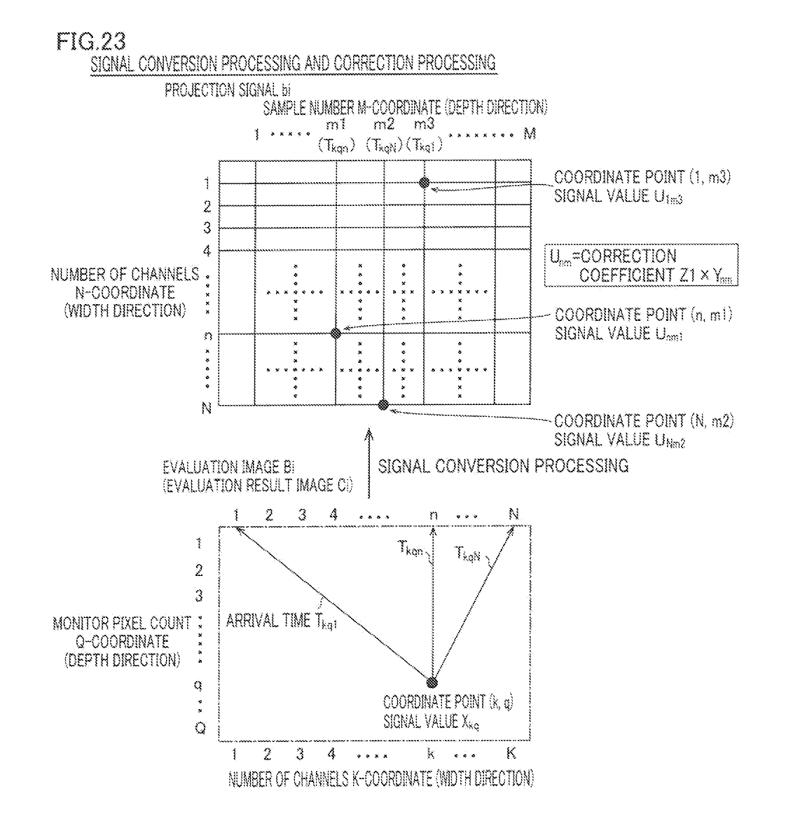

FIG. 23 shows the projection signals bi configured as data containing information about signals of the number N of channels and the sample number M and the evaluation image Bi (initial evaluation image B1) containing the information about the number K of channels and the pixel signals of the monitor pixel count Q. The signal conversion processing portion 431 performs signal conversion from the evaluation image Bi (initial evaluation image B1) into the projection signals bi.

The signal conversion processing portion 431 converts the signal intensity of each pixel of the evaluation image Bi to correspond to signals of the number N of channels and the sample number M. More specifically, assuming that the photoacoustic wave AW corresponding to the magnitude of the signal value X_{kq} is generated from a coordinate value (k, q), the projection signals bi are generated as signal values Y acquired by the detection portion 413. As shown in FIG. 23, for example, the signal conversion processing is performed on the signal value X_{kq} at the coordinate value (k, q) in the evaluation image Bi, whereby signal values are generated at N coordinate points (1, m3) to (N, m2) corresponding to the coordinate point (k, q). The signal conversion processing portion 431 performs the above signal conversion processing on all the pixels of the evaluation image Bi to generate the projection signals bi. In FIG. 23, only coordinate points (1, m3), (n, m1), and (N, m2) are illustrated for ease of understanding.

(Correction Processing)

According to the fourth embodiment, the signal conversion processing portion 431 of the image generation portion 424 is configured to correct the signal intensity of the projection signals bi of the evaluation image Bi to respond to a reduction in the signal intensity of the photoacoustic wave signals S resulting from attenuation of the photoacoustic wave AW by reducing the signal intensity of the projection signals bi according to increases in the values of the detection time t required for the detection portion 413 to detect each of the photoacoustic wave signals S and the signal frequency f of the photoacoustic wave signals S1 to SN during the above signal conversion processing, as shown in FIG. 23. Specifically, according to the fourth embodiment, the image generation portion 424 is configured to reduce the signal intensity of the projection signals bi according to increases in the values of the detection time t and the signal frequency f by multiplying the signal values Y of the projection signals bi1 to biN at each coordinate point by the correction coefficient Z1 expressed by the following formula (3), where the detection time is t (μs: microsecond), the signal frequency is f (MHz: megahertz), and a constant related to the detection time t and the signal frequency f is k1.

Z1=10^{-(k1×t×f)} (3)

The constant k1 is a constant corresponding to attenuation of the photoacoustic wave AW (a reduction in the signal intensity) generated in the specimen P in relation to the detection time t and the signal frequency f and can be properly determined according to measurement conditions for the specimen P (the human body or another animal), a measurement site of the specimen P, or the like. In consideration of this point, the constant k1 is preferably at least 0.002 and not more than 0.009.

When a living body (human body) soft tissue is measured, for example, the constant k1 is obtained as described below as an example. When the attenuation in the living body soft tissue is −0.6 dB/(cm×MHz) and a time required for sound (photoacoustic wave) to travel a distance of 1 cm in the living body soft tissue is 6.536 μs (=0.01 m/1530 m/s=1 cm/velocity of sound), the attenuation in the living body soft tissue can be expressed by 10^{-0.00459×t×f} (=10^{(((-0.6/20)/6.536)×t×f)}). The constant k1 is obtained as k1=((0.6/20)/6.536)=0.00459 (1/(μs×MHz)) in correspondence to the above formula. In other words, the constant k1 can be said to be a constant corresponding to attenuation of the photoacoustic wave AW (a reduction in the signal intensity) generated per the detection time t and the signal frequency f. The correction coefficient Z1 obtained by the aforementioned formula (3) can be said to be a correction coefficient for increasing the signal intensity by an amount corresponding to attenuation of the photoacoustic wave AW (a reduction in the signal intensity) generated in the specimen P. Therefore, the amount of reduction corresponding to attenuation of the photoacoustic wave AW (see FIG. 20) generated in the specimen P before reaching the detection elements 414 of the detection portion 413 can be reflected in the projection signals bi1 to biN by multiplying the signal values Y of the projection signal bi1 to biN at each coordinate point.

Specifically, the signal conversion processing portion 431 performs the signal conversion processing on the signal value X_{kq} of the evaluation image Bi at the coordinate point (k, q) to generate a signal value Yₙₘ at each of the N coordinate points (1, m3) to (N, m2) corresponding to the coordinate point (k, q), as shown in FIG. 23. Then, the signal conversion processing portion 431 generates the projection signals bi1 to biN including corrected signal values U₁₁ to U_{NM} by multiplying the signal values Y at each coordinate point by the correction coefficient Z1.

More specifically, the signal conversion processing portion 431 first calculates a distance from the coordinate point (k, q) to a detection element 414 of an n^{th} channel when correcting a signal value Yₙₘ₁ at a coordinate point (n, m1). Then, the signal conversion processing portion 431 calculates an arrival time T_{kqn} as a time required for the photoacoustic wave AW to reach the detection element 414 of the n^{th} channel from the coordinate point (k, q) by dividing the calculated distance by the velocity of sound. Then, the signal conversion processing portion 431 calculates arrival times T_{kq1} to T_{kqN} similarly to the arrival time T_{kqn}. Furthermore, the signal conversion processing portion 431 calculates the signal frequency f by analyzing the projection signals bi1 to biN by a Fourier transform method or the like, for example. The calculated arrival times T_{kq1} to T_{kqN} and signal frequency f are employed as the coefficient of the correction coefficient Z1.

(Evaluation Processing)

As shown in FIG. 19, the evaluation processing portion 432 is configured to evaluate the corrected projection signals bi (bi1 to biN) by comparing the corrected projection signals bi with the photoacoustic wave signals S (S1 to SN) and to generate the evaluation result signals ci. An evaluation method employed by the evaluation processing portion 432 is preferably a method (algorithm) according to an image desired by the operator (user). For example, one operator may accept an image including noise but desire an image in which an edge of the detection object Q is more clearly imaged whereas another operator may accept an image in which the edge of the detection object Q is slightly blurred but desire an image including minimized noise.

Therefore, the image generation portion 424 is configured to be capable of generating the photoacoustic wave image R approximated to the image desired by the operator by the statistical method on the basis of the evaluation result signals ci generated by the evaluation method according to the image desired by the operator. A method for calculating the evaluation result signals ci includes a calculation method employing differences between the projection signals bi and the photoacoustic wave signals S, a calculation method employing values obtained by dividing the projection signals bi by the photoacoustic wave signals S, etc.

The projection signals bi are corrected to respond to a reduction in the signal intensity of the photoacoustic wave signals S resulting from attenuation of the photoacoustic wave AW by the above correction processing, and hence an accurate evaluation result image Ci is acquired when the projection signals bi are compared with the photoacoustic wave signals S.

(Imaging Processing) (Generation Processing for Evaluation Image Bi)

The imaging processing portion 433 is configured to generate an evaluation result image Ci by imaging the evaluation result signals ci generated by the evaluation processing portion 432, as shown in FIG. 22. The imaging processing in the imaging processing portion 433 is performed by the analytical method, similarly to the initial evaluation image generation portion 430.

(Image Synthesis Processing)

The image synthesis portion 434 is configured to acquire the evaluation result image Ci generated by the imaging processing portion 433 and to generate the new evaluation image Bi+1 by synthesizing the evaluation result image Ci and the evaluation image Bi, as shown in FIG. 19. The image synthesis portion 434 is configured to acquire the initial evaluation image B1 from the initial evaluation image generation portion 430 and to generate an evaluation image B2 by synthesizing the evaluation result image Ci and the evaluation image B1 when the evaluation result image Ci generated by the imaging processing portion 433 is the first (in the case of an evaluation result image C1).

The image synthesis portion 434 is configured to output the evaluation image BI as the photoacoustic wave image R to the image display portion 423 when generating the evaluation image BI corresponding to the prescribed number I. The image generation portion 424 is configured to be capable of changing the prescribed number I according to the type of a statistical method or an image.

The image display portion 423 is configured to display the photoacoustic wave image R generated by the image generation portion 424.

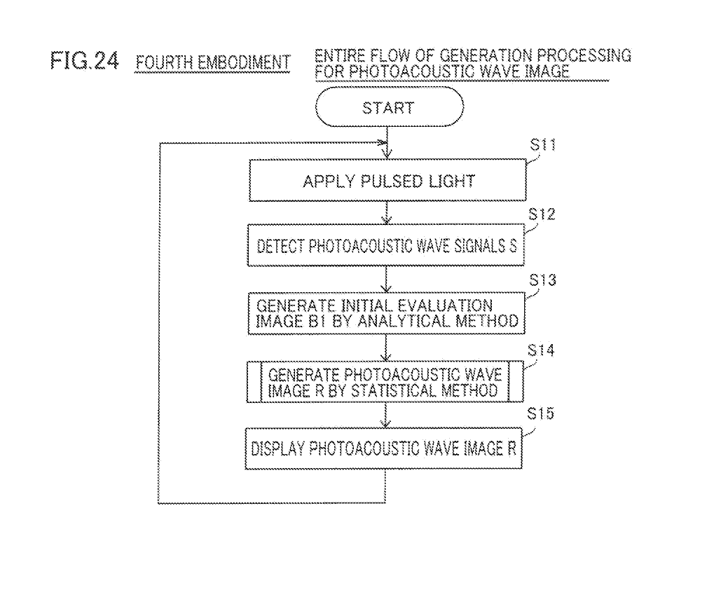

An entire flow of generation processing for the photoacoustic wave image R in the photoacoustic imager 400 according to the fourth embodiment is now described with reference to FIG. 24. Processing in the photoacoustic imager 400 is performed by the control portion 422 and the image generation portion 424.

First, the light source portion 411 applies pulsed light to the specimen P at a step S11. Then, the control portion 422 advances to a step S12.

At the step S12, the detection portion 413 detects the photoacoustic wave signals S (see FIG. 20). Then, the control portion 422 advances to a step S13.

At the step S13, the image generation portion 424 generates the initial evaluation image B1 by the analytical method (see FIG. 22). Then, the control portion 422 advances to a step S14.

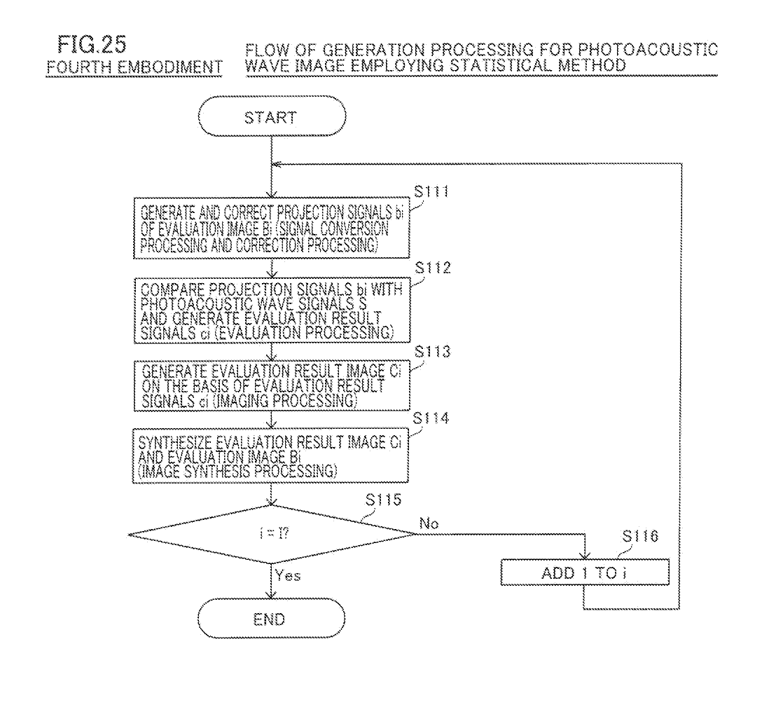

At the step S14, the image generation portion 424 generates the photoacoustic wave image R by the statistical method (see FIG. 25). Then, the control portion 422 advances to a step S15.

At the step S15, the image display portion 423 displays the photoacoustic wave image R. Then, the control portion 422 returns to the step S11.

A flow of generation processing for the photoacoustic wave image R employing the statistical method in the photoacoustic imager 400 according to the fourth embodiment is now described with reference to FIG. 25. Processing in the photoacoustic imager 400 is performed by the control portion 422 and the image generation portion 424. The generation processing for the photoacoustic wave image R employing the statistical method corresponds to the step S14 in the above entire flow (see FIG. 24) of the generation processing for the photoacoustic wave image R.

Steps S111 to S116 in FIG. 25 configure a loop in which an approximation is made while the signal conversion processing, the correction processing, the evaluation processing, the imaging processing, and the image synthesis processing are repetitively performed a prescribed number I of times.

First, the signal conversion processing portion 431 converts the evaluation image Bi into signals and generates the projection signals bi (see FIG. 23) at a step S111. The signal conversion processing portion 431 corrects the projection signals bi (see FIG. 23) when generating the projection signals bi. Then, the control portion 422 advances to a step S112.

At the step S112, the evaluation processing portion 432 evaluates the corrected projection signals bi relative to the photoacoustic wave signals S. The evaluation processing portion 432 also generates the evaluation result signals ci. Then, the control portion 422 advances to a step S113.

At the step S113, the imaging processing portion 433 images the evaluation result signals ci and generates the evaluation result image Ci (see FIG. 22). Then, the control portion 422 advances to a step S114.

At the step S114, the image synthesis portion 434 synthesizes the evaluation result image Ci and the evaluation image Bi. Then, the control portion 422 advances to a step S115.

At the step S115, it is determined whether or not i is equal in value to the prescribed number I. When i is equal in value to the prescribed number I, the generation processing for the photoacoustic wave image R employing the statistical method is terminated, and when i is not equal in value to (different from) the prescribed number I, the control portion 422 advances to a step S116.

At the step S116, 1 is added to i. Then, the control portion 422 returns to the step S111. More specifically, the steps S111 to S115 are repeated in a state where an image obtained by synthesis at the step S114 is set as the evaluation image Bi+1. Thus, the steps S111 to S115 are repeated until i becomes equal in value to the prescribed number I.

After the generation processing for the photoacoustic wave image R employing the statistical method is terminated, the image display portion 423 displays the photoacoustic wave image R, setting the evaluation image BI as the photoacoustic wave image R at the step S15 in the above entire flow (see FIG. 24) of the generation processing for the photoacoustic wave image R.

According to the fourth embodiment, the following effects can be obtained.

According to the fourth embodiment, as hereinabove described, the image generation portion 424 is configured to correct the signal intensity of the projection signals bi (signal values Y to signal values U) to respond to a reduction in the signal intensity of the photoacoustic wave signals S resulting from attenuation of the photoacoustic wave AW during the signal conversion processing. Thus, the signal intensity of the projection signals bi is corrected to respond to a reduction in the signal intensity of the photoacoustic wave signals S resulting from attenuation of the photoacoustic wave AW, and hence the accurate evaluation result image Ci can be acquired when the projection signals bi are compared with the photoacoustic wave signals S. Consequently, the clear photoacoustic wave image R can be generated. Furthermore, the photoacoustic wave image R is generated by the processing employing the statistical method, whereby resolution related to imaging is improved, and hence an increase in the number of detection elements 414 can be significantly reduced or prevented. In addition, the resolution is improved, and hence the clearer photoacoustic wave image R can be generated even when a wide angular detection range is detected, as compared with the case where the photoacoustic wave image R is generated by the processing employing the analytical method.

According to the fourth embodiment, as hereinabove described, the image generation portion 424 is configured to correct the signal intensity of the projection signals bi (the signal values Y to the signal values U) to respond to a reduction in the signal intensity of the photoacoustic wave signals S resulting from attenuation of the photoacoustic wave AW by reducing the signal intensity of the projection signals (the signal values Y to the signal values U) according to increases in the values of the detection time t required for the detection portion 413 to detect each of the photoacoustic wave signals S and the signal frequency f of the photoacoustic wave signals S during the signal conversion processing. The signal intensity of the photoacoustic wave signals S resulting from attenuation of the photoacoustic wave AW is reduced as the detection time t and the signal frequency f are increased. Therefore, according to the fourth embodiment, the signal intensity of the projection signals bi can be properly corrected to respond to a reduction in the signal intensity of the photoacoustic wave signals S resulting from attenuation of the photoacoustic wave AW according to a reduction (the amount of reduction) in the signal intensity of the photoacoustic wave signals S resulting from attenuation of the photoacoustic wave AW.

According to the fourth embodiment, as hereinabove described, the image generation portion 424 is configured to reduce the signal intensity of the projection signals bi from the signal values Y to the signal values U according to increases in the values of the detection time t and the signal frequency f by multiplying the signal values Y of the projection signals bi by the correction coefficient Z1 expressed by the aforementioned formula (3) where the detection time is t, the signal frequency is f, a constant related to the detection time and the signal frequency is k1, a unit of the detection time t is μs, a unit of the signal frequency f is MHz, and the constant k1 is at least 0.002 and not more than 0.009. Thus, the signal intensity of the projection signals bi can be easily corrected by multiplying the signal values Y by the correction coefficient Z1 expressed by the aforementioned formula (3) during the signal conversion processing. Furthermore, the constant k1 is at least 0.002 and not more than 0.009, whereby the correction coefficient Z1 can be properly acquired.

According to the fourth embodiment, as hereinabove described, the image generation portion 424 is configured to generate the initial evaluation image B1 that is the first evaluation image Bi by performing the processing employing the analytical method on the photoacoustic wave signals S. Thus, the processing employing the statistical method can be started from a state where the initial evaluation image B1 is further approximated to the photoacoustic wave image R, unlike the case where the initial evaluation image B1 is set to a prescribed image not based on the photoacoustic wave signals S. Consequently, the time required for the processing employing the statistical method can be reduced, and hence the photoacoustic wave image R can be generated in less time.

According to the fourth embodiment, as hereinabove described, the light source portion 411 includes the semiconductor light-emitting elements 412. When the semiconductor light-emitting elements 412 are employed as light sources, an output of light applied from the light source portion 411 is reduced as compared with the case where solid-state laser light sources are employed, and hence the signal intensity of the photoacoustic wave signals S detected by the detection portion 413 is relatively reduced. When the semiconductor light-emitting elements 412 are employed as light sources, therefore, the structure of the photoacoustic imager 400 according to the fourth embodiment in which the clear photoacoustic wave image R can be generated by the processing employing the statistical method (the signal/noise ratio can be improved) is particularly effective.

When semiconductor laser elements are employed as the semiconductor light-emitting elements 412, the semiconductor laser elements can apply relatively-high-directivity laser light to the specimen P as compared with light-emitting diode elements, and hence most of light from the semiconductor laser elements can be reliably applied to the specimen P.

When organic light-emitting diode elements are employed as the semiconductor light-emitting elements 412, the organic light-emitting diode elements are easily thinned, and hence the light source portion 411 can be easily downsized.

According to the fourth embodiment, as hereinabove described, the detection portion 413 is configured to generate the photoacoustic wave signals S including the RF signals on the basis of the detected photoacoustic wave AW, and the image generation portion 424 is configured to generate the photoacoustic wave image R by the processing employing the statistical method based on the photoacoustic wave signals S including the RF signals. Generally, fine information (such as information indicating the phases of the signals) contained in the RF signals may be lost when the RF signals are demodulated (detected). According to the fourth embodiment, on the other hand, the photoacoustic wave image R is generated by the processing employing the statistical method based on the photoacoustic wave signals S including the RF signals, and hence the photoacoustic wave image R can be generated without losing the fine information contained in the RF signals, and the clearer photoacoustic wave image R can be generated.

### Fifth Embodiment

The structure of a photoacoustic imager 500 according to a fifth embodiment is now described with reference to FIGS. 19 and 26 to 29. In the fifth embodiment, projection signals are corrected to respond to a reduction in the signal intensity of photoacoustic wave signals resulting from attenuation of light from a light source portion in addition to the aforementioned structure according to the fourth embodiment. Portions of the photoacoustic imager 500 similar to those of the photoacoustic imager 400 according to the aforementioned fourth embodiment are denoted by the same reference numerals as those in the fourth embodiment, and redundant description is omitted.

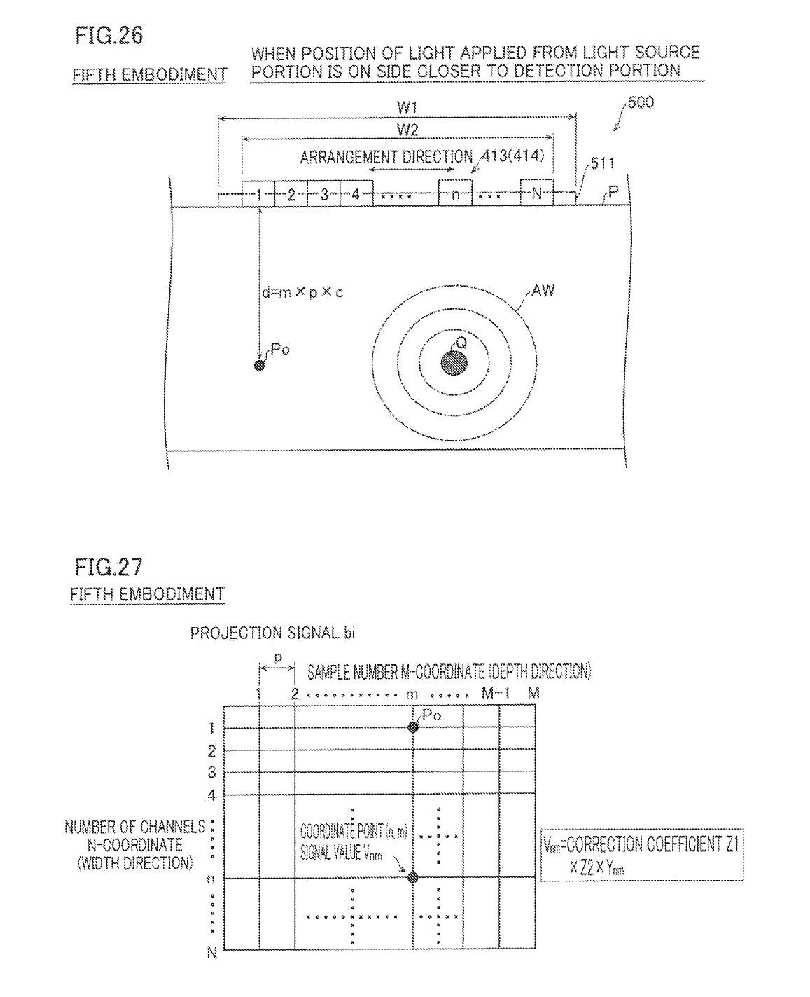

The photoacoustic imager 500 according to the fifth embodiment of the present invention includes a light source portion 511 and a detection portion 413, as shown in FIG. 26. As shown in FIG. 19, the photoacoustic imager 500 is provided with an image generation portion 524. The image generation portion 524 is provided with a signal conversion processing portion 531. The image generation portion 524 is an example of the “signal processing portion” in the present invention.

According to the fifth embodiment, the image generation portion 524 is configured to correct the signal intensity of projection signals bi to respond to a reduction in the signal intensity of photoacoustic wave signals S resulting from attenuation of light from the light source portion 511 by correcting the signal intensity of the projection signals bi according to a distance d from the position of the light applied from the light source portion 511 to a specimen P to a prescribed position in the specimen P in addition to correcting the signal intensity of the projection signals bi to respond to a reduction in the signal intensity of the photoacoustic wave signals S resulting from attenuation of a photoacoustic wave AW. More specifically, according to the fifth embodiment, the signal conversion processing portion 531 performs correction processing in consideration of both attenuation of the photoacoustic wave AW generated in the specimen P (see FIG. 26) before reaching detection elements 414 of the detection portion 413 and attenuation of the light applied from the light source portion 511 that is generated before reaching a detection object Q (see FIG. 26) in the specimen P.

Specifically, the signal conversion processing portion 531 is configured to correct the signal intensity of the projection signals bi by the correction coefficient Z1 obtained by the aforementioned formula (3) to respond to a reduction in the signal intensity of the photoacoustic wave signals S resulting from attenuation of the photoacoustic wave AW, similarly to the aforementioned fourth embodiment. According to the fifth embodiment, the signal conversion processing portion 531 is further configured to correct the signal intensity of the projection signals bi to respond to a reduction in the signal intensity of the photoacoustic wave signals S resulting from attenuation of the light from the light source portion 511 on the basis of the distance d from the position of the light applied from the light source portion 511 to the specimen P to the prescribed position in the specimen P.

Specifically, the signal conversion processing portion 531 is configured to correct the signal intensity of the projection signals bi to respond to a reduction in the signal intensity of the photoacoustic wave signals S resulting from attenuation of the light from the light source portion 511 according to an increase in the distance d from the position of the light applied from the light source portion 511 to the prescribed position in the specimen P by multiplying a signal value Y at each coordinate point in projection signals Bi1 to BiN stored in a memory 427 by a correction coefficient Z2 expressed by the following formula (4) where a constant related to the position of the light applied from the light source portion 511 is k2, similarly to the case of the correction coefficient Z1 according to the aforementioned fourth embodiment. In other words, according to the fifth embodiment, the signal value Y at each coordinate point of the projection signals Bi1 to BiN is multiplied by both the correction coefficients Z1 and Z2 during signal conversion processing.

Z2=10^{-(k2×d)} (4)

The distance d is obtained in correspondence to the projection signals Bi1 to BiN (the arrangement positions of the detection elements 414). For example, the distance d to the prescribed position Po in the specimen P shown in FIG. 26 is obtained as d=m×p×c by multiplying a detection time t=m×p at a coordinate point (1, m) of each of the projection signals bi by the velocity of sound c, as shown in FIG. 27. Also with respect to another coordinate point, the distance d can be obtained by the same calculation.

The constant k2 is a constant related to the distance d from the position of the light applied from the light source portion 511 to the specimen P to the prescribed position in the specimen P. More specifically, the constant k2 is a constant corresponding to light attenuation (a reduction in light intensity) generated in the specimen P with respect to the distance d.

The constant k2 can be properly determined according to measurement conditions for the specimen P (a human body or another animal), a measurement site of the specimen P, or the like. For example, the constant k2 is preferably at least 0.2 and not more than 0.8 when the position of the light applied from the light source portion 511 is on a side closer to the detection portion 413 (in other words, the light source portion 511 is arranged adjacent to the detection portion 413 so that the position of the light applied from the light source portion 511 is adjacent to the detection portion 413), as shown in FIG. 26, and a unit of the distanced (=m×p×c) is cm.

As shown in FIG. 27, a signal value Yₙₘ at a coordinate point (n, m) of the projection signals bi1 to biN is multiplied by both the correction coefficients Z1 and Z2 at the coordinate point (n, m), whereby a signal value Vₙₘ (=Z1×Z2×Yₙₘ) after correction at the coordinate point (n, m) is obtained. Similarly, the signal values Y at all coordinate points from a coordinate point (1, 1) to a coordinate point (N, M) of the projection signals bi1 to biN are multiplied by both the correction coefficients Z1 and Z2 at all the coordinate points. The image generation portion 524 generates a photoacoustic wave image R by performing processing employing a statistical method with the projection signals bi1 to biN after correction.

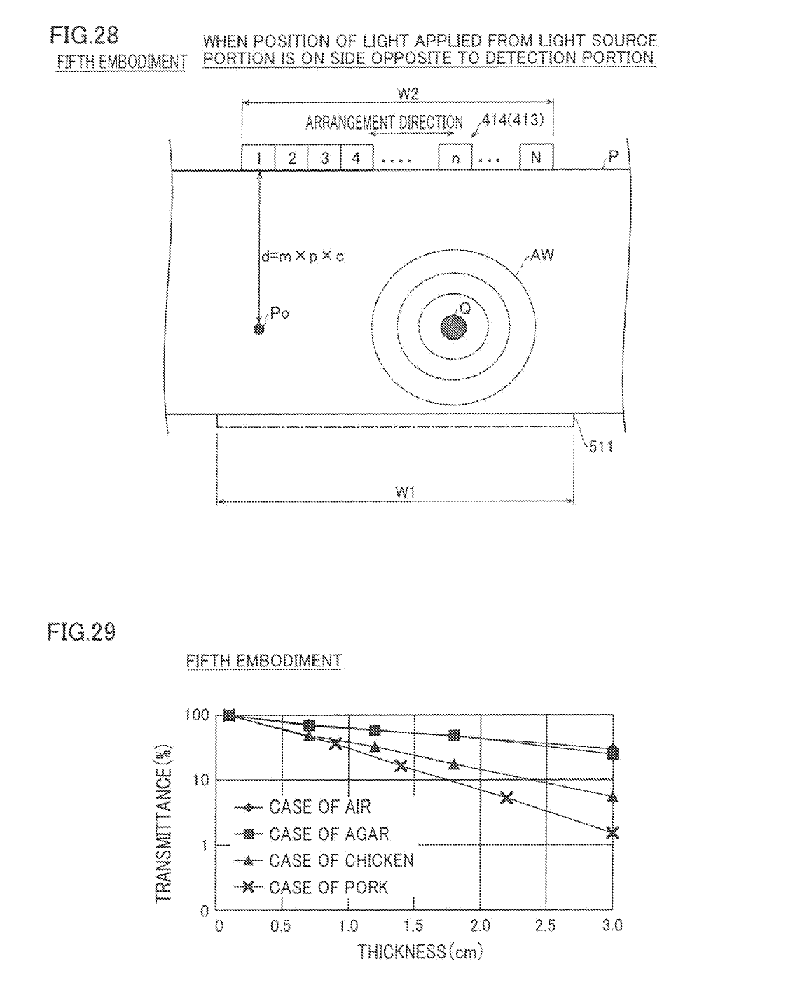

When the position of the light applied from the light source portion 511 is on a side opposite to the detection portion 413 (in other words, the light source portion 511 is arranged opposite to the detection portion 413 so that the position of the light applied from the light source portion 511 is opposite to the detection portion 413), as shown in FIG. 28, and a unit of the distance d is cm, the constant k2 is preferably at least −0.8 and not more than −0.2.

Even when the position of the light applied from the light source portion 511 is on the side opposite to the detection portion 413, a distance from the position of virtually applied light to the prescribed position in the specimen P in the case where the position of the light applied from the light source portion 511 is on the side closer to the detection portion 413 is set to d (=m×p×c). Thus, both when the position of the light applied from the light source portion 511 is on the side closer to the detection portion 413 and when the position of the light applied from the light source portion 511 is on the side opposite to the detection portion 413, the same formula can be employed.

In the structure of obtaining the distance d in this manner, the width W1 of the light source portion 511 in an arrangement direction in which a plurality of detection elements 414 are arranged is larger than the width W2 of all the plurality of detection elements 414 in the arrangement direction, as shown in FIGS. 26 and 28. When the width W1 is smaller than the width W2, for example, a distance from the light source portion 511 to the position Po may be larger than the distance d. According to the fifth embodiment, as described above, the width W1 of the light source portion 511 is larger than the width W2 of the plurality of detection elements 414 in the arrangement direction, and hence the position of the light applied from the light source portion 511 can be reliably associated with the positions of the detection elements 414 even if the distance d from the position of the light applied from the light source portion 511 to the prescribed position in the specimen P is regarded as the distance from the detection elements 414 to the prescribed position in the specimen P.

Results of an experiment conducted in order to determine the constant k2 are now described with reference to FIG. 29. FIG. 29 shows a semilogarithmic graph in which the horizontal axis shows a thickness (cm) and the vertical axis shows light transmittance (%) and is logarithmic. The experiment was conducted with respect to air (air space), agar, chicken, and pork. In the experiment, near infrared light (light with a center wavelength of 850 nm) was used.

The Results of the experiment show that the degree of a reduction in transmittance (attenuation of light) was smallest in the case of the air and the degree of a reduction in transmittance (attenuation of light) was largest in the case of the pork. In the case of the pork, the thickness was 3 cm, and the transmittance was 1.5%. Thus, the constant k2 is k2=−Log(1.5/100)/3=about 0.6 (cm⁻¹) in terms of attenuation of light per cm in the case of the pork. In the case of the air, the thickness was 3 cm, and the transmittance was 33%. Thus, the constant k2 is k2=−Log(33/100)/3=about 0.2 (cm⁻¹) in terms of attenuation of light per cm in the case of the air.

In view of attenuation of light in the specimen P such as the human body, therefore, the constant k2 is more preferably at least 0.2 and not more than 0.6 (when the position of the light applied from the light source portion 511 is on the side closer to the detection portion 413, as shown in FIG. 26) or at least −0.6 and not more than −0.2 (when the position of the light applied from the light source portion 511 is on the side opposite to the detection portion 413, as shown in FIG. 28).

The remaining structures of the photoacoustic imager 500 according to the fifth embodiment are similar to those of the photoacoustic imager 400 according to the aforementioned fourth embodiment.

According to the fifth embodiment, the following effects can be obtained.

According to the fifth embodiment, as hereinabove described, the image generation portion 524 is configured to correct the signal intensity of the projection signals bi to respond to a reduction in the signal intensity of the photoacoustic wave signals S resulting from attenuation of the light from the light source portion 511 by correcting the signal intensity of the projection signals bi (the signal values Y to signal values V) according to the distance d from the position of the light applied from the light source portion 511 to the specimen P to the prescribed position in the specimen P in addition to correcting the signal intensity of the projection signals bi to respond to a reduction in the signal intensity of the photoacoustic wave signals S resulting from attenuation of the photoacoustic wave AW. Thus, even if the light from the light source portion 511 attenuates before reaching the detection object Q in the specimen P, the signal intensity of the projection signals bi can be corrected to respond to a reduction in the signal intensity of the photoacoustic wave signals S resulting from attenuation of the light from the light source portion 511. Consequently, more accurate comparison results (evaluation result image Ci) can be acquired when the projection signals bi are compared with the photoacoustic wave signals S, and hence a clear photoacoustic wave image R can be more reliably generated.

According to the fifth embodiment, as hereinabove described, the image generation portion 524 is configured to correct the signal intensity of the projection signals bi according to the distance from the position of the applied light to the prescribed position in the specimen P by multiplying the projection signals bi by the correction coefficient Z2 expressed by the aforementioned formula (4) where the constant related to the position of the applied light is k2 and the distance from the position of the applied light to the prescribed position in the specimen P is d. Thus, the signal intensity of the projection signals bi can be easily corrected according to a reduction (the amount of reduction) in the signal intensity resulting from attenuation of the light from the light source portion 511 by the aforementioned formula (4).

According to the fifth embodiment, as hereinabove described, the constant k2 is set to at least 0.2 and not more than 0.8 when the position of the light applied from the light source portion 511 is on the side closer to the detection portion 413 and a unit of the distance d from the position of the applied light to the prescribed position in the specimen P is cm. Furthermore, the constant k2 is set to at least −0.8 and not more than −0.2 when the position of the light applied from the light source portion 511 is on the side opposite to the detection portion 413, the distance from the position of the light applied from the light source portion 511 to the prescribed position in the specimen P in the case where the position of the applied light is on the side closer to the detection portion 413 is set to d, and a unit of the distance d from the position of the applied light to the prescribed position in the specimen P is cm. Thus, the correction coefficient Z2 can be properly acquired according to the position of the light applied from the light source portion 511. Consequently, the signal intensity of the projection signals bi can be more properly corrected to respond to a reduction in the signal intensity of the photoacoustic wave signals S resulting from attenuation of the light from the light source portion 511.

According to the fifth embodiment, as hereinabove described, the plurality of detection elements 414 are arranged in the detection portion 413 to receive the photoacoustic wave AW and detect the photoacoustic wave signals S caused by the photoacoustic wave, and the width W1 of the light source portion 511 in the arrangement direction in which the plurality of detection elements 414 are arranged is larger than the width W2 of the plurality of detection elements 414 in the arrangement direction. Thus, the light from the light source portion 511 can be reliably applied to an entire region of the plurality of detection elements 414 in the arrangement direction. Consequently, insufficient generation of the photoacoustic wave AW from the detection object Q in a range detectable by the plurality of detection elements 414 caused by a small amount of applied light in the range detectable by the plurality of detection elements 414 can be significantly reduced or prevented.

The remaining effects of the photoacoustic imager 500 according to the fifth embodiment are similar to those of the photoacoustic imager 400 according to the fourth embodiment.

### Sixth Embodiment

The structure of a photoacoustic imager 600 according to a sixth embodiment is now described with reference to FIGS. 19, 30, and 31. In the sixth embodiment, a reduction in the signal intensity of photoacoustic wave signals resulting from the sensitivity of detection elements is corrected in addition to the aforementioned structure according to the fourth embodiment. Portions of the photoacoustic imager 600 similar to those of the photoacoustic imager 400 according to the aforementioned fourth embodiment are denoted by the same reference numerals as those in the fourth embodiment, and redundant description is omitted.

The photoacoustic imager 600 according to the sixth embodiment of the present invention includes an image generation portion 624, as shown in FIG. 19. The image generation portion 624 includes a signal conversion processing portion 631. The image generation portion 624 is an example of the “signal processing portion” in the present invention.

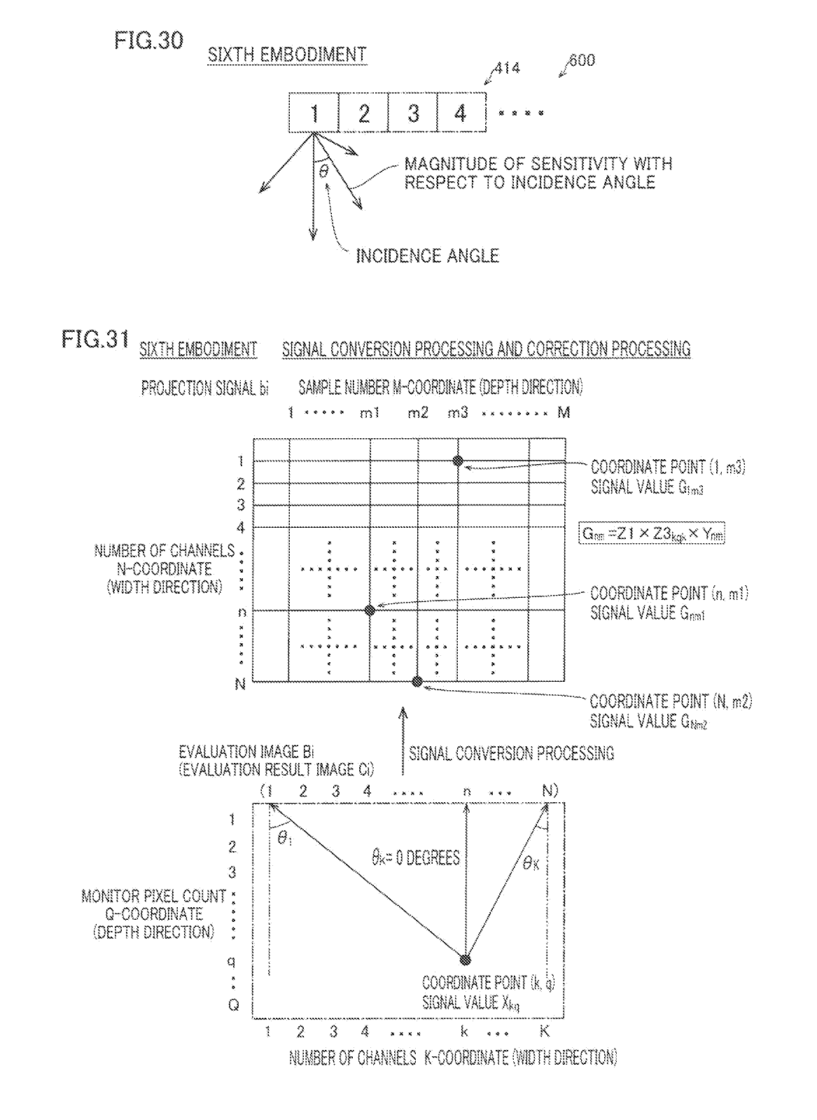

As shown in FIG. 30, detection elements 414 are different in sensitivity (detection sensitivity) from each other by directions from which a photoacoustic wave AW is incident (incident directions). For example, the sensitivity of the detection elements 414 each having a rectangular shape as shown in FIG. 30 is highest when the photoacoustic wave AW is incident from a direction vertical to detection surfaces of the detection elements 414. As an incidence angle θ that is an angle formed by the direction vertical to the detection surfaces and the incident direction of the photoacoustic wave increases, the sensitivity decreases. In FIG. 30, the magnitude of the sensitivity with respect to the incidence angle θ of a first detection element 414 is conceptually expressed by the lengths of arrows.

According to the sixth embodiment, the signal conversion processing portion 631 of the image generation portion 624 is configured to correct the signal intensity of projection signals bi to respond to a reduction in the signal intensity of photoacoustic wave signals S resulting from the sensitivity of the detection elements 414 on the basis of the sensitivity caused by the incident direction (incidence angle θ) of the photoacoustic wave AW with respect to the detection elements 414 in addition to correcting the signal intensity of the projection signals bi to respond to a reduction in the signal intensity of the photoacoustic wave signals S resulting from attenuation of the photoacoustic wave AW, as shown in FIG. 31.

Specifically, the signal conversion processing portion 631 is configured to acquire the incidence angle θ of each of the detection elements 414 with respect to a coordinate point at which a signal value is acquired when converting an evaluation image Bi into signals. The signal conversion processing portion 631 is further configured to acquire the sensitivity correction coefficient Z3_{kq} of each of the detection elements 414 on the basis of the acquired incidence angle θ. The sensitivity correction coefficient Z3_{kq} can be previously set, and the previously set value can be employed according to the incidence angle θ, for example. The magnitude of the sensitivity of each of the detection elements 414 with respect to the incidence angle θ also varies by the shape of each of the detection elements 414, and hence the sensitivity correction coefficient Z3_{kq} is preferably to set in consideration of the shape of each of the detection elements 414.

The signal conversion processing portion 631 is configured to multiply the signal values Y of the projection signals bi by the acquired sensitivity correction coefficient Z3_{kg} of each of the detection elements 414. Thus, the signal conversion processing portion 631 is configured to correct the signal intensity of the projection signals bi to respond to a reduction in the signal intensity of the photoacoustic wave signals S resulting from the sensitivity of the detection elements 414.

For example, the signal conversion processing portion 631 acquires the incidence angles θ₁ to θ_{K} of the respective detection elements 414 with respect to a coordinate point (k, q) when acquiring a signal value X_{kq} at the coordinate point (k, q), as shown in FIG. 31. Then, the signal conversion processing portion 631 acquires sensitivity correction coefficients Z3_{kq1} to Z3_{kqK} corresponding to the incidence angles θ₁ to θ_{K}, respectively, on the basis of the acquired incidence angles θ₁ to θ_{K}. Then, the signal conversion processing portion 631 acquires the signal value Gₙₘ (=Z1×Z3_{kqk}×Yₙₘ) of the projection signals bi at a coordinate point (n, m) by multiplying signal values Y₁₁ to Y_{NM} at the coordinate point corresponding to the respective detection elements 414 by the corresponding sensitivity correction coefficients Z3_{kq1} to Z3_{kqK}. In this manner, the signal conversion processing portion 631 corrects the signal intensity of the projection signals bi. Then, the image generation portion 624 generates a photoacoustic wave image R by performing processing employing a statistical method with the projection signals bi after correction.

The remaining structures of the photoacoustic imager 600 according to the sixth embodiment are similar to those of the photoacoustic imager 400 according to the aforementioned fourth embodiment.

According to the sixth embodiment, the following effects can be obtained.

According to the sixth embodiment, as hereinabove described, the image generation portion 624 is configured to correct the signal intensity of the projection signals bi (the signal values Y to signal values G) to respond to a reduction in the signal intensity of the photoacoustic wave signals S resulting from the sensitivity of the detection elements 414 on the basis of the sensitivity caused by the incident direction of the photoacoustic wave AW with respect to the detection elements 414 in addition to correcting the signal intensity of the projection signals bi to respond to a reduction in the signal intensity of the photoacoustic wave signals S resulting from attenuation of the photoacoustic wave AW. Thus, even if the signal intensity of the detected photoacoustic wave signals S is reduced by a difference in the sensitivity of the detection elements 414 caused by the incident direction of the photoacoustic wave AW with respect to the detection elements 414, the signal intensity of the projection signals bi can be corrected to respond to a reduction in the signal intensity of the photoacoustic wave signals S resulting from the sensitivity of the detection elements 414.

The remaining effects of the photoacoustic imager 600 according to the sixth embodiment are similar to those of the photoacoustic imager 400 according to the fourth embodiment.

### Seventh Embodiment

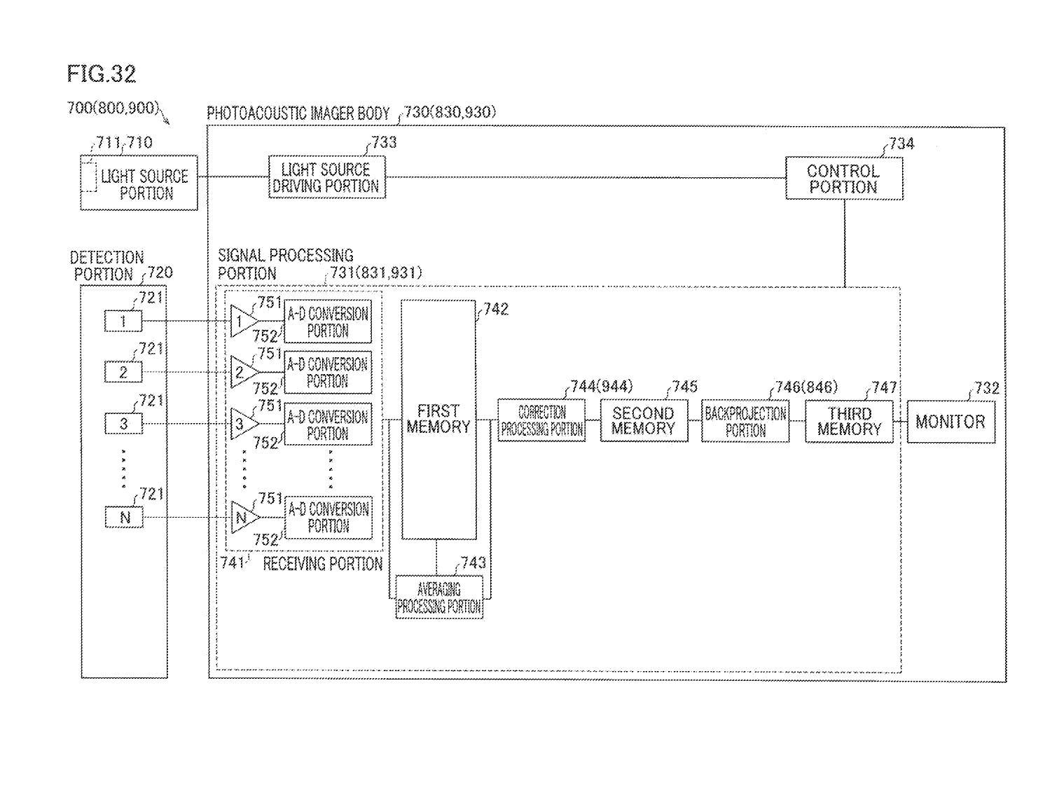

A seventh embodiment is now described with reference to FIGS. 32 to 39. In this seventh embodiment, a photoacoustic wave image is generated by a backprojection method, unlike to the aforementioned first to third embodiments in which the photoacoustic wave image is generated by phasing addition and the aforementioned fourth to sixth embodiments in which the photoacoustic wave image is generated by the statistical method. The backprojection method is an example of the “prescribed signal processing” in the present invention.

The structure of a photoacoustic imager 700 according to the seventh embodiment of the present invention is now described with reference to FIGS. 32 to 38.

The photoacoustic imager 700 according to the seventh embodiment of the present invention includes a light source portion 710, a detection portion 720, and a photoacoustic imager body (hereinafter referred to as the imager body) 730, as shown in FIG. 32. The light source portion 710 and the detection portion 720 are provided outside the imager body 730 and are connected to the imager body 730 by unshown wires. The photoacoustic imager 700 is configured to be capable of performing signal transmission such as output of a control signal from the imager body 730 to the light source portion 710 and output of photoacoustic wave signals detected by the detection portion 720 from the detection portion 720 to the imager body 730 through these wires.

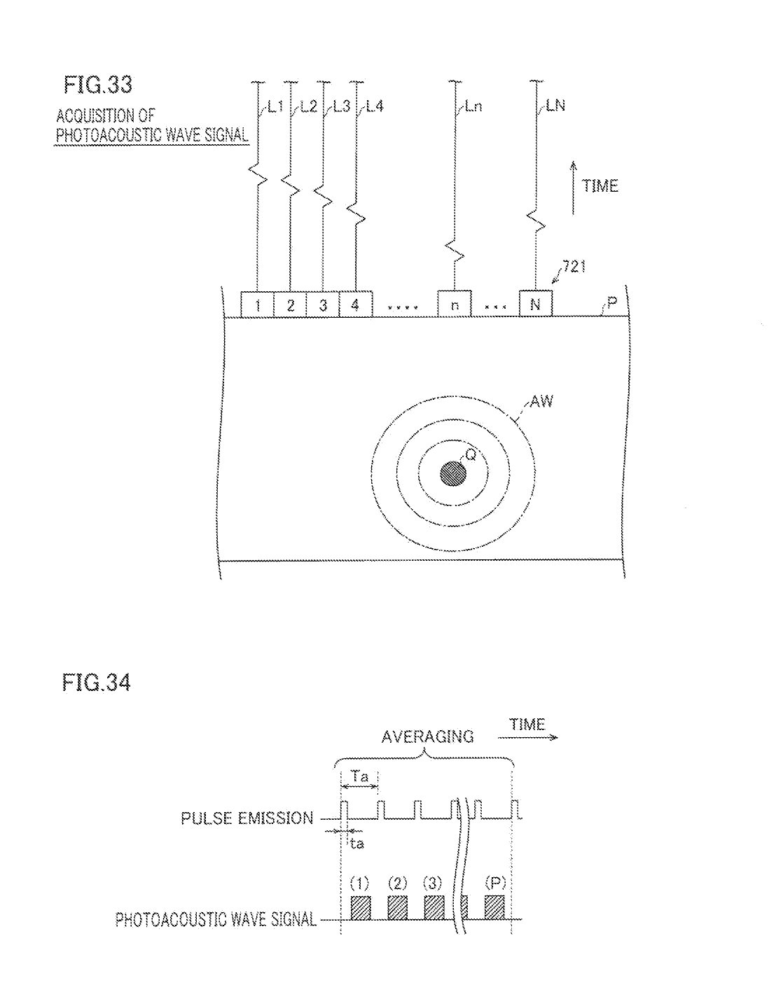

As shown in FIG. 32, the light source portion 710 is a light source unit configured to apply light to a specimen P (see FIG. 33). During measurement of a photoacoustic wave AW (see FIG. 33), the light source portion 710 is brought into contact with a surface of the specimen P.

The light source portion 710 includes a light source 711 and is configured to apply light for measurement from the light source 711 to the specimen P. The light source 711 of the light source portion 710 is configured to repetitively emit pulsed light with a pulse width to (see FIG. 34) in a light-emission cycle Ta (see FIG. 34) on the basis of a control signal from a light source driving portion 733, described later, of the imager body 730. Photoacoustic wave signals in a prescribed period after emission of pulsed light and before subsequent emission of pulsed light are repetitively acquired by the imager body 730.

The light source 711 is configured to generate light (light with a center wavelength at about 700 nm to about 1000 nm, for example) with a measurement wavelength of an infrared region suitable for measuring the specimen P (see FIG. 33) such as a human body. As the light source 711, a semiconductor light-emitting element such as a light-emitting diode element, a semiconductor laser element, or an organic light-emitting diode element can be employed, for example. In this case, the light source portion 710 can be downsized, and hence the photoacoustic wave AW can be measured while the light source portion 710 provided with the light source 711 is brought into direct contact with the specimen P. The measurement wavelength of the light source 711 may be properly determined according to a detection object Q desired to be detected.

As shown in FIG. 32, the detection portion 720 is a probe configured to receive the photoacoustic wave AW (see FIG. 33). The detection portion 720 can be configured to transmit and receive an ultrasonic wave in addition to receiving the photoacoustic wave AW. During measurement of the photoacoustic wave AW, the detection portion 720 is brought into contact with the surface of the specimen P.

The detection portion 720 includes a plurality of detection elements 721. The plurality of detection elements 721 include piezoelectric elements and are arranged in an array in the vicinity of a tip end of an internal portion of an unshown housing. According to the seventh embodiment, N (also referred to as N channels) detection elements 721 are provided. The number N of detection elements 721 can be 64, 128, 192, or 256, for example.

The detection portion 720 is configured to receive the photoacoustic wave AW and detect photoacoustic wave signals by vibration of the detection elements 721 resulting from the photoacoustic wave AW generated from the detection object Q (see FIG. 33) in the specimen P (see FIG. 33) that absorbs light applied from the light source portion 710. The detection portion 720 is further configured to output the detected photoacoustic wave signals to the imager body 730.

According to the seventh embodiment, the imager body 730 is provided with a signal processing portion 731. The signal processing portion 731 is configured to correct the photoacoustic wave signals output from the detection portion 720 and to generate a photoacoustic wave image based on the photoacoustic wave signals by backprojection. Specifically, the signal processing portion 731 is configured to correct a reduction in the signal intensity of the photoacoustic wave signals resulting from attenuation of the photoacoustic wave AW and to generate the photoacoustic wave image by the backprojection method on the basis of the corrected photoacoustic wave signals.

Schematically, the signal processing portion 731 is configured to perform signal processing involved in acquisition of the photoacoustic wave signals, correction of the acquired photoacoustic wave signals, backprojection of the corrected photoacoustic wave signals, and generation of the photoacoustic wave image based on the backprojected photoacoustic wave signals. The structure of the signal processing portion 731 is now described in detail.

As shown in FIG. 32, the signal processing portion 731 includes a receiving portion 741, a first memory 742, an averaging processing portion 743, a correction processing portion 744, a second memory 745, a backprojection portion 746, and a third memory 747. The function of the signal processing portion 731 can be attained by a combination of hardware such as a dedicated circuit, a general-purpose CPU, an FPGA (field programmable gate array), a non-volatile memory, and a volatile memory and software such as various programs, for example.

The receiving portion 741 is provided with a plurality of (N) amplification portions 751 and a plurality of (N) analog-digital conversion portions (hereinafter referred to as the A-D conversion portions) 752 corresponding to the plurality of (N) detection elements 721 of the detection portion 720.

Detection of the photoacoustic wave signals by the detection portion 720 through reception of the photoacoustic wave signals by the receiving portion 741 is now described with reference to FIG. 33. When the light source portion 710 (see FIG. 32) applies pulsed light to the specimen P, the photoacoustic wave AW is generated from the detection object Q in the specimen P, as shown in FIG. 33. At this time, the photoacoustic wave AW is generated from a wide range at a time by light application. In FIG. 33, only one detection object Q is illustrated for ease of understanding.

Then, the detection portion 720 (see FIG. 32) receives the photoacoustic wave AW generated from the detection object Q and detects the photoacoustic wave signals by the N respective detection elements 721. In FIG. 33, the photoacoustic wave signals detected by the detection elements 721 are shown as photoacoustic wave signals L1 to LN. The photoacoustic wave signals L1 to LN detected by the detection elements 721 are output from the detection portion 720 to the imager body 730 and are received by the receiving portion 741 of the imager body 730. The photoacoustic wave signals are hereinafter referred to as the photoacoustic wave signals L1 to LN properly.

The receiving portion 741 is configured to receive a photoacoustic wave signal Ln (L1 to LN) detected by an n^{th} (1≦n≦N) detection element 721 with an n^{th} amplification portion 751 and a corresponding n^{th} A-D conversion portion 752.

The respective amplification portions 751 are configured to amplify (about 300 times to about 30000 times, for example) the received photoacoustic wave signals L1 to LN and to output the same to the A-D conversion portions 752.

The respective A-D conversion portions 752 are configured to convert the photoacoustic wave signals L1 to LN amplified by the amplification portions 751 from analog signals into digital signals with a prescribed sampling frequency and prescribed bit resolution. The A-D conversion portions 752 are configured to output the photoacoustic wave signals L1 to LN as digital signals to the first memory 742.

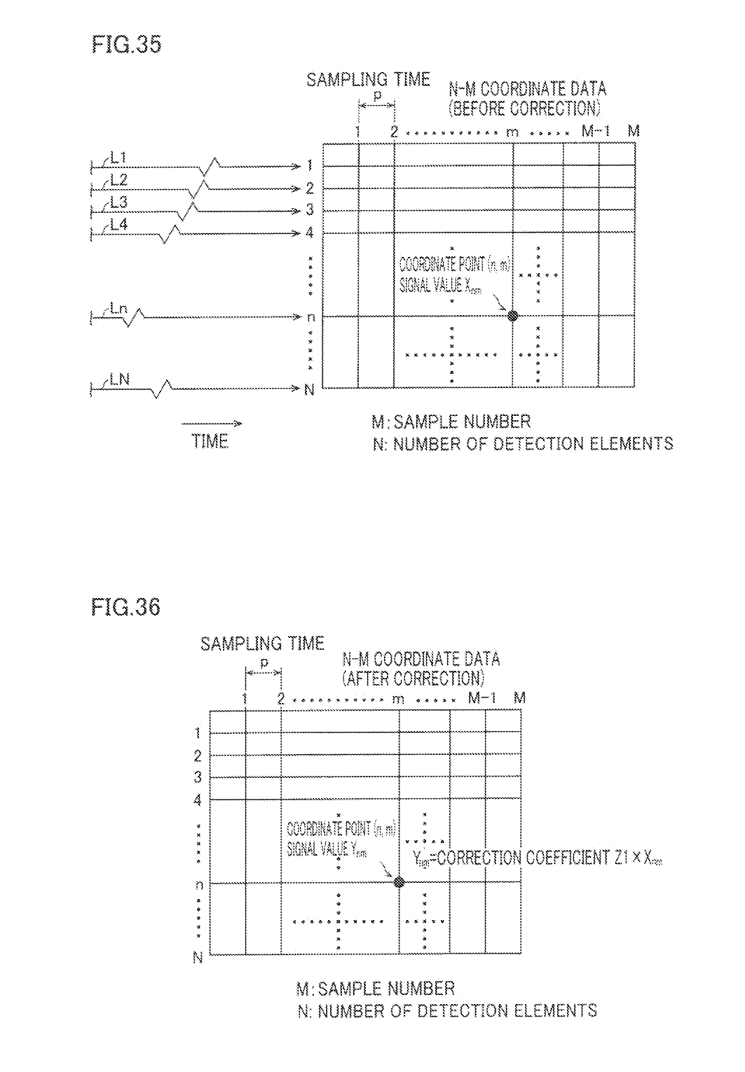

The first memory 742 is configured to store the photoacoustic wave signals L1 to LN output from the respective A-D conversion portions 752. As shown in FIG. 35, the first memory 742 stores the photoacoustic wave signals L1 to LN as N-M coordinate data.

The N-M coordinate data is data obtained by configuring information about the width direction of the detection portion 720 and information about a depth direction from the surface of the specimen P in a matrix. Specifically, the N-M coordinate data is configured by a matrix of the number N of detection elements 721 (detection element number N) and the sample number M. The sample number M is a sample number for a signal up to a depth desired to be imaged in each of the photoacoustic wave signals L1 to LN. When a depth desired to be imaged is 6 cm (0.06 m) from the surface of the specimen P, the velocity of sound in the human body is 1530 m/s, and the prescribed sampling frequency of the A-D conversion portions 752 is 20×10⁶ Hz, for example, the sample number M is obtained by M=(0.06/1530)×20×10⁶=about 800. The sample number M indicates the number of pixels in the depth direction, and in the case of the aforementioned calculation example, for example, there are about 800 pixels in the depth direction.

In the N-M coordinate data, each point of an M-coordinate is arranged at a time interval corresponding to a sampling time p. The sampling time p is a time corresponding to one cycle of the prescribed sampling frequency of the A-D conversion portions 752. When the prescribed sampling frequency of the A-D conversion portions 752 is 20×10⁶ Hz, for example, the sampling time p is 0.05 μs. In other words, in the N-M coordinate data, the M-coordinate corresponds to a detection time t of each of the detected photoacoustic wave signals L1 to LN. When the M-coordinate is m (1≦m≦M), for example, the detection time t is obtained by the following formula: t=m×p. Therefore, this N-M coordinate data can be said to be data having information about the detection time t of each of the photoacoustic wave signals L1 to LN detected by the respective detection elements 721. Specifically, a coordinate point (n, m) in the N-M coordinate data has information about a signal value Xₙₘ in the detection time t (=m×p) of the photoacoustic wave signal Ln. One piece of N-M coordinate data is obtained per pulsed light emission by the light source 711 of the light source portion 710. The pulsed light emission is performed every light-emission cycle Ta, and the photoacoustic wave signals L1 to LN based on each pulsed light are stored in the first memory 742.

The averaging processing portion 743 (see FIG. 32) is configured to average a plurality of (P) pieces of N-M coordinate data corresponding to a plurality of (P sets of) respective photoacoustic wave signals L1 to LN received on the basis of a plurality of (P) pulsed light emissions, as shown in FIG. 34. Thus, the photoacoustic wave image (image data) can be generated in a state where the S/N ratio (signal/noise ratio) of the photoacoustic wave signals L1 to LN is improved by averaging, and hence the photoacoustic wave image that accurately reflects a state inside the specimen P can be generated. The averaging processing portion 743 is configured to store the averaged N-M coordinate data in the first memory 742. The first memory 742 is configured to be capable of outputting the stored N-M coordinate data to the correction processing portion 744.

According to the seventh embodiment, the correction processing portion 744 is configured to correct a reduction in the signal intensity of the photoacoustic wave signals L1 to LN resulting from attenuation of the photoacoustic wave AW on the basis of the detection time t and a signal frequency f. The detection time t is a time from a time point when the light source portion 710 applies pulsed light to a time point when the detection portion 720 detects each of the photoacoustic wave signals L1 to LN. The starting point of the detection time t may not be strictly the time point when the light source portion 710 applies pulsed light. For example, the starting point of the detection time t may be a time point when sampling of the photoacoustic wave signals L1 to LN is started after the time point when the light source portion 710 applies pulsed light, as shown in FIG. 34. According to the seventh embodiment, as the detection time t, a value obtained by multiplying the M-coordinate m of the N-M coordinate data by the sampling time p is employed, as described above. The signal frequency f is the signal frequency of the photoacoustic wave signals L1 to LN. According to the seventh embodiment, as the signal frequency f, the signal frequency at a prescribed coordinate point in the N-M coordinate data is employed. This signal frequency f can be obtained by analyzing the photoacoustic wave signals L1 to LN by a Fourier transform method or the like, for example.

According to the seventh embodiment, the correction processing portion 744 is configured to increase the signal intensity of the photoacoustic wave signals according to increases in the values of the detection time t and the signal frequency f by multiplying the photoacoustic wave signals L1 to LN by a correction coefficient Z1 expressed by the following formula (5) where a constant related to the velocity of sound is h and a constant related to the detection time t (μs: microsecond) and the signal frequency f (MHz: megahertz) is k1.

Z1=h×t×10^{k1×t×f} (5)

The constant k1 is a constant for correcting attenuation of the photoacoustic wave AW (a reduction in the signal intensity) generated in the specimen P in relation to the detection time t and the signal frequency f and can be properly determined according to measurement conditions for the specimen P (the human body or another animal), a measurement site of the specimen P, or the like. In consideration of this point, the constant k1 is preferably at least 0.002 and not more than 0.009.

When a living body (human body) soft tissue is measured, for example, the constant k1 is obtained as described below as an example. When the attenuation in the living body soft tissue is −0.6 dB/(cm×MHz) and a time required for sound (photoacoustic wave AW) to travel a distance of 1 cm in the living body soft tissue is 6.536 μs (=0.01 m/1530 m/s=1 cm/velocity of sound), the attenuation in the living body soft tissue can be expressed by 10^{-0.00459×t×f} (=10^{(((-0.6/20)/6.536)×t×f)}). The (=10 The constant k1 is obtained as k1=((0.6/20)/6.536)=0.00459 ((μs×MHz)⁻¹) in correspondence to the above formula. In other words, the constant k1 can be said to be a constant for correcting attenuation of the photoacoustic wave AW (a reduction in the signal intensity) generated per the detection time t and the signal frequency f. The correction coefficient Z1 obtained by the aforementioned formula (5) can be said to be a correction coefficient for increasing the signal intensity by an amount corresponding to attenuation of the photoacoustic wave AW (a reduction in the signal intensity) generated in the specimen P. Therefore, even if the photoacoustic wave AW (see FIG. 33) generated in the specimen P (see FIG. 33) attenuates before reaching the detection elements 721 of the detection portion 720, a reduction in the signal intensity of the photoacoustic wave signals L1 to LN resulting from the attenuation of the photoacoustic wave AW can be corrected by multiplying the photoacoustic wave signals by the correction coefficient Z1.

The constant h is a value determined from the velocity of sound in the specimen P and can be properly determined according to measurement conditions for the specimen P (the human body or another animal), a measurement site of the specimen P, or the like. In consideration of this point, the constant h is preferably at least 0.1 and not more than 0.2. When the living body (human body) soft tissue is measured, for example, a unit of the velocity of sound (1530 m/s) in the living body soft tissue is converted, whereby h=about 0.15 (cm/μs) can be employed as the constant h.

In the correction coefficient Z1, the term of (h×t) is obtained by multiplying the constant h (cm/μs) related to the velocity of sound by the detection time t (μs) thereby indicating a distance (cm) in the depth direction in the specimen P with respect to the detection elements 721. The term of (h×t) is provided, whereby signal processing employing the backprojection method described later can be properly performed.

The correction processing portion 744 is configured to acquire the N-M coordinate data stored in the first memory 742 and to multiply a signal value (signal intensity) at each coordinate point in the acquired N-M coordinate data by the correction coefficient Z1 as specific correction processing with respect to attenuation of the photoacoustic wave AW of the photoacoustic wave signals L1 to LN. Thus, the correction processing portion 744 is configured to increase the signal intensity of the photoacoustic wave signals L1 to LN according to increases in the values of the detection time t and the signal frequency f. For example, a signal value Yₙₘ (=Z1×Xₙₘ) after correction at the coordinate point (n, m) is obtained by multiplying a signal value Xₙₘ at the coordinate point (n, m) in the N-M coordinate data by the correction coefficient Z1 at the coordinate point (n, m), as shown in FIGS. 35 and 36. Similarly, the correction processing portion 744 acquires the N-M coordinate data after correction shown in FIG. 36 by multiplying a signal value at each of all coordinate points from a coordinate point (1, 1) to a coordinate point (N, M) in the N-M coordinate data by the correction coefficient Z1 at each of all the coordinate points. As shown in FIG. 32, the correction processing portion 744 is configured to output the acquired N-M coordinate data after correction to the second memory 745.

The photoacoustic wave signals L1 to LN corrected by the correction processing portion 744 may be either RF (radio frequency) signals (high-frequency signals) or RF signals obtained by demodulating (detecting) the original RF signals. In other words, the correction processing performed by the correction processing portion 744 may be performed on either the RF signals or the demodulated (detected) RF signals. When the correction processing is performed on the demodulated RF signals, a demodulation (detection) processing portion is provided in a stage preceding the correction processing portion 744 so that the correction processing can be performed on the demodulated RF signals.

The second memory 745 is configured to store the N-M coordinate data (see FIG. 36) after correction output from the correction processing portion 744. The second memory 745 is configured to be capable of outputting the stored N-M coordinate data to the backprojection portion 746.

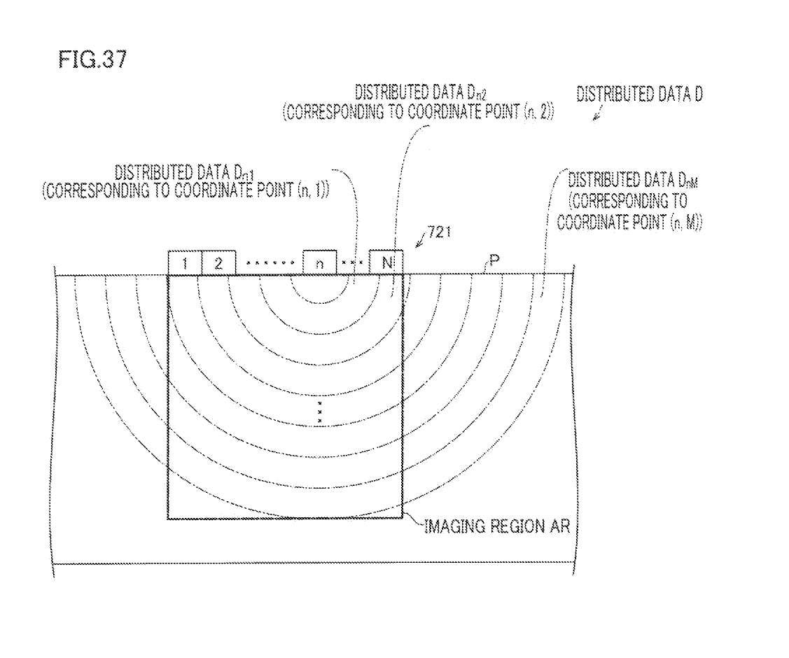

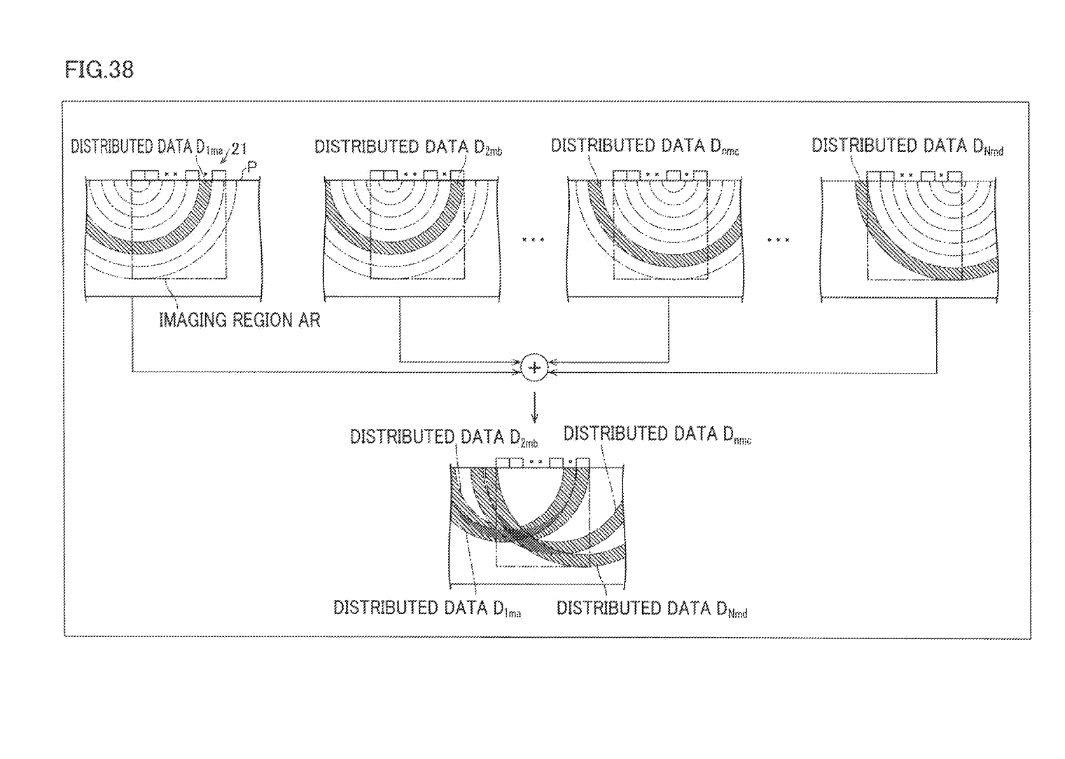

The backprojection portion 746 is configured to perform backprojection on the basis of the N-M coordinate data after correction. Backprojection performed by the backprojection portion 746 is now described with reference to FIGS. 37 and 38.

As shown in FIG. 37, the backprojection portion 746 is configured to determine the distribution of signal values in an imaging region AR corresponding to the inside of the specimen P by performing backprojection on the basis of the N-M coordinate data (see FIG. 36) after correction. Schematically, the backprojection portion 746 virtually sets a plurality of pieces of distributed data D that are semi-annular about the detection elements 721 and determines the distribution of the signal values in the imaging region AR based on overlaps in the set distributed data D. Virtual setting of the plurality of pieces of distributed data D that are semi-annular about the detection elements 721 by the backprojection portion 746 is now described.

In the backprojection method, the signal intensity of the photoacoustic wave signals in the detection time t is expressed by integrated values of sound fields at a distance (c×t) from the detection elements 721, setting the velocity of sound to c. More specifically, in the backprojection method, the signal intensity of the photoacoustic wave signals in the detection time t is expressed by integrated values of sound fields on semi-circles of a radius r=(c×t) with respect to the detection elements 721. According to the seventh embodiment, the backprojection portion 746 treats the sound fields on the semi-circles as the distributed data D having semi-annular (belt-like) regions.

As shown in FIG. 37, first, the backprojection portion 746 virtually sets the plurality of pieces of distributed data D having the semi-annular regions about the detection elements 721. The plurality of pieces of distributed data D are virtually set about each of the detection elements 721. FIG. 37 shows the plurality of (M) pieces of distributed data Dₙ₁ to D_{nM} of an n^{th} detection element 721.

The plurality of pieces of distributed data D each have a signal value (signal intensity) corresponding to the coordinate point in the N-M coordinate data. Specifically, the plurality of pieces of distributed data D each have a signal value obtained by dividing a signal value Yₙₘ at the corresponding coordinate point by the area of the distributed data D. In other words, in each of the semi-annular (belt-like) regions of the plurality of pieces of distributed data D, the signal value Yₙₘ at the corresponding coordinate point can be said to be evenly (uniformly) distributed. The distributed data D can be configured by a plurality of unit pixels, for example. In this case, a value obtained by dividing the signal value Yₙₘ by the number of unit pixels of the distributed data D is assigned to each unit pixel, whereby the signal value Yₙₘ at the corresponding coordinate point can be evenly (uniformly) distributed in each of the semi-annular (belt-like) regions of the plurality of pieces of distributed data D.

The distributed data D is described in detail with reference to FIG. 37. For example, first distributed data Dₙ₁ of the n^{th} detection element 721 has a signal value obtained by dividing a signal value Yₙ₁ at a coordinate point (n, 1) in the N-M coordinate data by the area of the distributed data Dₙ₁. In other words, in a semi-annular region of the distributed data Dₙ₁, the signal value Yₙ₁ at the coordinate point (n, 1) is evenly (uniformly) distributed. Similarly, second distributed data Dₙ₂ to M^{th} distributed data D_{nM} of the n^{th} detection element 721 have signal values obtained by dividing signal values Yₙ₂ to Y_{nM} at coordinate points (n, 2) to (n, M) in the N-M coordinate data by the areas of the distributed data Dₙ₂ to the distributed data D_{nM}, respectively.

The first distributed data Dₙ₁ of the n^{th} detection element 721 is virtually arranged in the specimen P at a position spaced a distance corresponding to a detection time 1×p in the depth direction in the specimen P from the n^{th} detection element 721. The second distributed data Dₙ₂ is virtually arranged in the specimen P at a position spaced a distance corresponding to a detection time 2×p in the depth direction in the specimen P from the n^{th} detection element 721. In other words, the distributed data Dₙ₁ to the distributed data D_{nM} of the n^{th} detection element 721 are arranged at equal intervals of a distance (=p×c) corresponding to the sampling time p in the depth direction in the specimen P from the n^{th} detection element 721.

The backprojection portion 746 is configured to virtually set the plurality of pieces of semi-annular distributed data D of each of first to N^{th} detection elements 721, similarly to the case of the n^{th} detection element 721.

At this time, the area of the distributed data D increases as the distance in the depth direction increases. Consequently, when the signal value Yₙₘ at the corresponding coordinate point is divided by the area of the distributed data D, therefore, a signal value after division significantly reduces as the distance in the depth direction increases. According to the seventh embodiment, the term of (h×t) expressing the distance in the depth direction in the specimen P is provided in the correction coefficient Z1 obtained by the aforementioned formula (5), and a correction is previously made to increase the signal value at each coordinate point in the N-M coordinate data according to an increase in the distance in the depth direction. Consequently, the signal value after division can be prevented from significantly reducing as the distance in the depth direction increases. Consequently, the signal processing employing the backprojection method can be properly performed.

According to the seventh embodiment, the correction processing portion 744 is configured to set a value obtained by multiplying the constant h (cm/μs) by the detection time t (μs) to a prescribed value when the value obtained by multiplying the constant h by the detection time t is smaller than the prescribed value in the term of (h×t) (in other words, the distance in the depth direction is less than a prescribed distance (cm)). When the light source portion 710 is arranged adjacent to the detection portion 720, light from the light source portion 710 hardly reaches a region nearly immediately below the detection elements 721 of the detection portion 720. Consequently, the photoacoustic wave signals having relatively small signal intensity are conceivably easily obtained from a position in which the distance in the depth direction is less than the prescribed distance. In consideration of this point, the prescribed value can be set to at least 0.5 and not more than 1.5 (the prescribed distance can be set to at least 0.5 cm and not more than 1.5 cm). According to the seventh embodiment, as described above, the value obtained by multiplying the constant h by the detection time t is set to the prescribed value when the distance in the depth direction is less than the prescribed distance (smaller than the prescribed value). Thus, the signal value can be multiplied by the correction coefficient Z1 larger than usual (a value of h×t). Consequently, the correction coefficient Z1 can be properly acquired in consideration of the case where the distance in the depth direction is less than the prescribed distance that the light from the light source portion 710 hardly travels.

Determination of the distribution of the signal values in the imaging region AR based on the overlaps in the distributed data D set by the backprojection portion 746 is now described with reference to FIG. 38.

As shown in FIG. 38, the backprojection portion 746 determines the distribution of the signal values in the imaging region AR by determining a signal value in each section of the imaging region AR on the basis of the overlaps in the set distributed data D. The determination is now described on the basis of a specific example with reference to FIG. 38.

FIG. 38 distributed data D₁ₘₐ (data corresponding to a signal value at a coordinate point (1, ma)) of a first detection element 721, distributed data D_{2mb} (data corresponding to a signal value at a coordinate point (2, mb)) of a second detection element 721, distributed data D_{nmc} (data corresponding to a signal value at a coordinate point (n, mc)) of an n^{th} detection element 721, and distributed data D_{Nmd} (data corresponding to a signal value at a coordinate point (N, md)) of an N^{th} detection element 721. The coordinate points ma to md of the M-coordinate may be the same as each other or different from each other. As shown in FIG. 38, in portions (regions) of the distributed data D₁ₘₐ, the distributed data D_{2mb}, the distributed data D_{nmc}, and the distributed data D_{Nmd} that overlap each other, the signal values of the distributed data D₁ₘₐ, the distributed data D_{2mb}, the distributed data D_{nmc}, and the distributed data D_{Nmd} that overlap each other are added, whereby the signal values of the portions in the imaging region AR are determined. In portions that do not overlap each other, each of the signal values of the portions in the imaging region AR is determined by the value of the distributed data D₁ₘₐ, the distributed data D_{2mb}, the distributed data D_{nmc}, or the distributed data D_{Nmd}. In FIG. 38, portions of a larger number of pieces of the distributed data D that overlap each other (in other words, portions in which the signal values are larger) are shown in darker color. The above processing is performed on the basis of the overlaps in the distributed data D of all the detection elements 721, whereby the distribution of the signal values in the imaging region AR is determined. Thus, distribution data (signal distribution data) of the signal values in the imaging region AR is generated by the backprojection portion 746. The photoacoustic wave image is constructed (generated) on the basis of the generated signal distribution data. In other words, the constructed photoacoustic wave image is an image obtained by backprojecting the signal values corrected by the correction processing portion 744. As shown in FIG. 32, the backprojection portion 746 is configured to output the photoacoustic wave image (image data) based on the signal distribution data to the third memory 747.

The third memory 747 is configured to store the photoacoustic wave image (image data) output from the backprojection portion 746. The third memory 747 is further configured to be capable of outputting the stored photoacoustic wave image to a monitor 732. Consequently, the monitor 732 displays a clear photoacoustic wave image generated by the backprojection method on the basis of the photoacoustic wave signals in which a reduction in the signal intensity is corrected. An image processing portion that performs image processing such as gradation adjustment can be further provided between the third memory 747 and the monitor 732.

The imager body 730 is provided with the monitor 732 including a common liquid crystal monitor. The monitor 732 is configured to be capable of displaying the photoacoustic wave image, various operation screens, etc.

The imager body 730 is further provided with the light source driving portion 733. The light source driving portion 733 is configured to control the light source 711 of the light source portion 710 provided outside the imager body 730 to emit pulsed light. Specifically, the light source driving portion 733 is configured to control the light source 711 of the light source portion 710 to repetitively emit the pulsed light with the pulse width to in the light-emission cycle Ta. The light source driving portion 733 is further configured to be capable of adjusting the pulse width ta, the light-emission cycle Ta, and a current value for driving the light source 711 on the basis of control signals from a control portion 734 of the imager body 730. In other words, the photoacoustic imager 700 is configured to be capable of changing conditions for light application by the light source portion 710 by changing the setting of the light source driving portion 733.

The imager body 730 is provided with the control portion 734. The control portion 734 includes a CPU and is configured to control each component of the imager body 730. The control portion 734 is configured to control conditions for light application of the light source portion 710 set by the light source driving portion 733 and conditions for signal processing of the signal processing portion 731, for example.

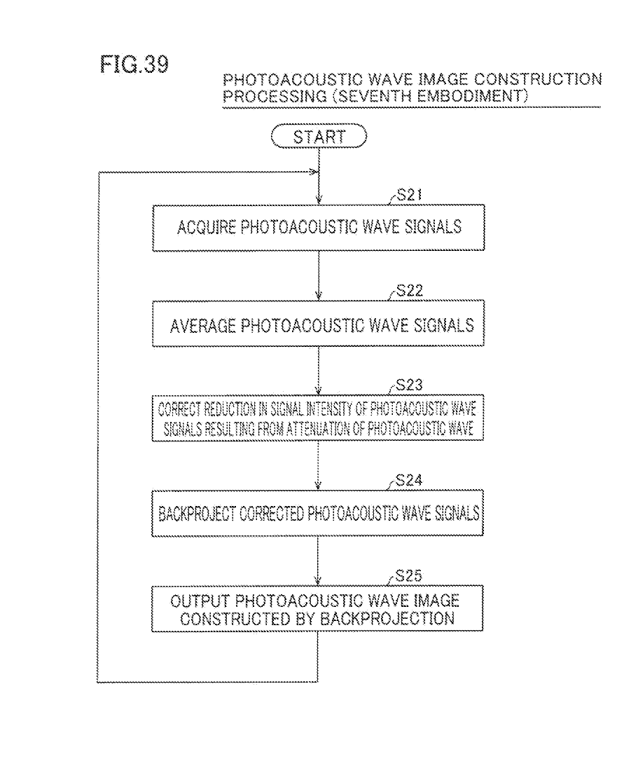

Photoacoustic wave image construction processing performed by the signal processing portion 731 of the imager body 730 is now described on the basis of a flowchart with reference to FIG. 39.

First, the photoacoustic wave signals are acquired at a step S21. Specifically, the photoacoustic wave signals are received by the receiving portion 741 (see FIG. 32) and are stored in the first memory 742 (see FIG. 32), whereby the photoacoustic wave signals L1 to LN (see FIG. 35) are acquired by the signal processing portion 731. At this time, the first memory 742 stores the photoacoustic wave signals L1 to LN as the N-M coordinate data before correction (see FIG. 35).

Then, the plurality (P sets) of photoacoustic wave signals are averaged at a step S22. Specifically, the averaging processing portion 743 averages the plurality (P sets) of pieces of N-M coordinate data corresponding to the plurality (P sets) of respective photoacoustic wave signals L1 to LN stored in the first memory 742.

Then, a reduction in the signal intensity of the photoacoustic wave signals resulting from attenuation of the photoacoustic wave AW is corrected at a step S23. Specifically, the correction processing portion 744 acquires the N-M coordinate data stored in the first memory 742 and makes a correction by multiplying the signal value (signal intensity) Xₙₘ of each coordinate point in the acquired N-M coordinate data by the correction coefficient Z1. Thus, the N-M coordinate data (see FIG. 36) in which a reduction in the signal intensity of the photoacoustic wave signals resulting from attenuation of the photoacoustic wave AW is corrected is obtained.

Then, the corrected photoacoustic wave signals are backprojected at a step S24. In other words, at the step S24, the backprojection portion 746 performs backprojection on the basis of the N-M coordinate data after correction obtained by the processing at the step S23. Consequently, the signal distribution data in the imaging region AR is generated on the basis of the overlaps of the distributed data D of the detection elements 721, as shown in FIG. 38, and the photoacoustic wave image based on the signal distribution data is constructed.

Then, the photoacoustic wave image constructed by backprojection is output from the third memory 747 to the monitor 732 at a step S25. Consequently, the clear photoacoustic wave image obtained by the correction processing is displayed on the monitor 732. Then, the signal processing portion 731 returns to the step S21 and acquires subsequent photoacoustic wave signals.

According to the seventh embodiment, the following effects can be obtained.

According to the seventh embodiment, as hereinabove described, the photoacoustic imager 700 is provided with the signal processing portion 731 that corrects a reduction in the signal intensity of the photoacoustic wave signals resulting from attenuation of the photoacoustic wave AW and generates the photoacoustic wave image by the backprojection method on the basis of the corrected the photoacoustic wave signals. Thus, even if the photoacoustic wave AW generated in the specimen attenuates before reaching the detection portion 720, a reduction in the signal intensity of the photoacoustic wave signals resulting from attenuation of the photoacoustic wave AW can be corrected. Consequently, the signal processing employing the backprojection method can be performed on the photoacoustic wave signals in which a reduction in the signal intensity is corrected, and hence the clear photoacoustic wave image can be obtained by the backprojection method.

According to the seventh embodiment, as hereinabove described, the signal processing portion 731 is configured to correct a reduction in the signal intensity of the photoacoustic wave signals resulting from attenuation of the photoacoustic wave AW on the basis of both the detection time t required for the detection portion 720 to detect each of the photoacoustic wave signals and the signal frequency f of the photoacoustic wave signals. Thus, a reduction in the signal intensity of the photoacoustic wave signals can be reliably corrected on the basis of a reduction (the amount of reduction) in the signal intensity of the photoacoustic wave signals resulting from attenuation of the photoacoustic wave AW.

According to the seventh embodiment, as hereinabove described, the signal processing portion 731 is configured to correct a reduction in the signal intensity of the photoacoustic wave signals resulting from attenuation of the photoacoustic wave AW by increasing the signal intensity of the photoacoustic wave signals according to increases in the values of the detection time t and the signal frequency f. Thus, the signal intensity of photoacoustic wave signals reduced by attenuation of the photoacoustic wave AW can be increased according to a reduction (the amount of reduction) in the signal intensity increased as the values of the detection time t and the signal frequency f are increased. Consequently, a reduction in the signal intensity of the photoacoustic wave signals can be more reliably corrected according to a reduction (the amount of reduction) in the signal intensity of the photoacoustic wave signals resulting from attenuation of the photoacoustic wave AW.

According to the seventh embodiment, as hereinabove described, the signal processing portion 731 is configured to increase the signal intensity of the photoacoustic wave signals according to increases in the values of the detection time t and the signal frequency f by multiplying the photoacoustic wave signals by the correction coefficient Z1 expressed by the aforementioned formula (5) where a unit of the detection time t is μs, a unit of the signal frequency f is MHz, and the constant k1 is at least 0.002 and not more than 0.009. Thus, the signal intensity of the photoacoustic wave signals can be increased according to both the detection time t and the signal frequency f by the aforementioned formula (5). Consequently, a reduction in the signal intensity of the photoacoustic wave signals can be still more reliably corrected according to a reduction (the amount of reduction) in the signal intensity of the photoacoustic wave signals resulting from attenuation of the photoacoustic wave AW. Furthermore, the constant k1 is at least 0.002 and not more than 0.009, whereby the correction coefficient Z1 can be properly acquired. In addition, the term of (h×t) is provided in the aforementioned formula (5), whereby signal processing can be properly performed according to the characteristics of the backprojection method.

According to the seventh embodiment, as hereinabove described, the constant h is set to at least 0.1 and not more than 0.2 when a unit of the constant h is cm/μs and a unit of the detection time t is μs. When the value obtained by multiplying the constant h by the detection time t is smaller than the prescribed value, the value obtained by multiplying the constant h by the detection time t is set to the prescribed value. Thus, the value of the constant h is properly set, and hence the correction coefficient Z1 can be more properly acquired.

According to the seventh embodiment, as hereinabove described, the prescribed value is at least 0.5 and not more than 1.5. Thus, the value of the constant h is more properly set, and hence the correction coefficient Z1 can be still more properly acquired.

According to the seventh embodiment, as hereinabove described, the light source 711 of the light source portion 710 includes at least one of a light-emitting diode element, a semiconductor laser element, and an organic light-emitting diode element. Thus, advantageously, the power consumption of the light source 711 can be reduced while the light source portion 710 can be downsized, as compared with the case where a solid-state laser light source is employed. When the light-emitting diode element, the semiconductor laser element, or the organic light-emitting diode element is employed as the light source 711, an output of light applied from the light source 711 is reduced as compared with the case where the solid-state laser light source is employed. Thus, the signal intensity of the photoacoustic wave signals detected by the detection portion 720 is further reduced. Therefore, when the light-emitting diode element, the semiconductor laser element, or the organic light-emitting diode element is employed as the light source 711, the present invention that can obtain the clear photoacoustic wave image by correcting a reduction in the signal intensity is particularly effective.

### Eighth Embodiment

An eighth embodiment is now described with reference to FIGS. 32, 33, 36, 37, and 40 to 42. In this eighth embodiment, a photoacoustic wave image is generated by a backprojection method in consideration of sensitivity caused by the incident direction of a photoacoustic wave AW with respect to detection elements 721 in addition to the aforementioned structure according to the seventh embodiment. Portions of a photoacoustic imager 800 similar to those of the photoacoustic imager 700 according to the aforementioned seventh embodiment are denoted by the same reference numerals as those in the seventh embodiment, and redundant description is omitted.

The photoacoustic imager 800 according to the eighth embodiment of the present invention includes a light source portion 710, a detection portion 720, and a photoacoustic imager body (hereinafter referred to as the imager body) 830, as shown in FIG. 32. The imager body 830 is provided with a signal processing portion 831. The signal processing portion 831 is similar in structure to the signal processing portion 731 according to the aforementioned seventh embodiment except that the signal processing portion 831 is provided with a backprojection portion 846.

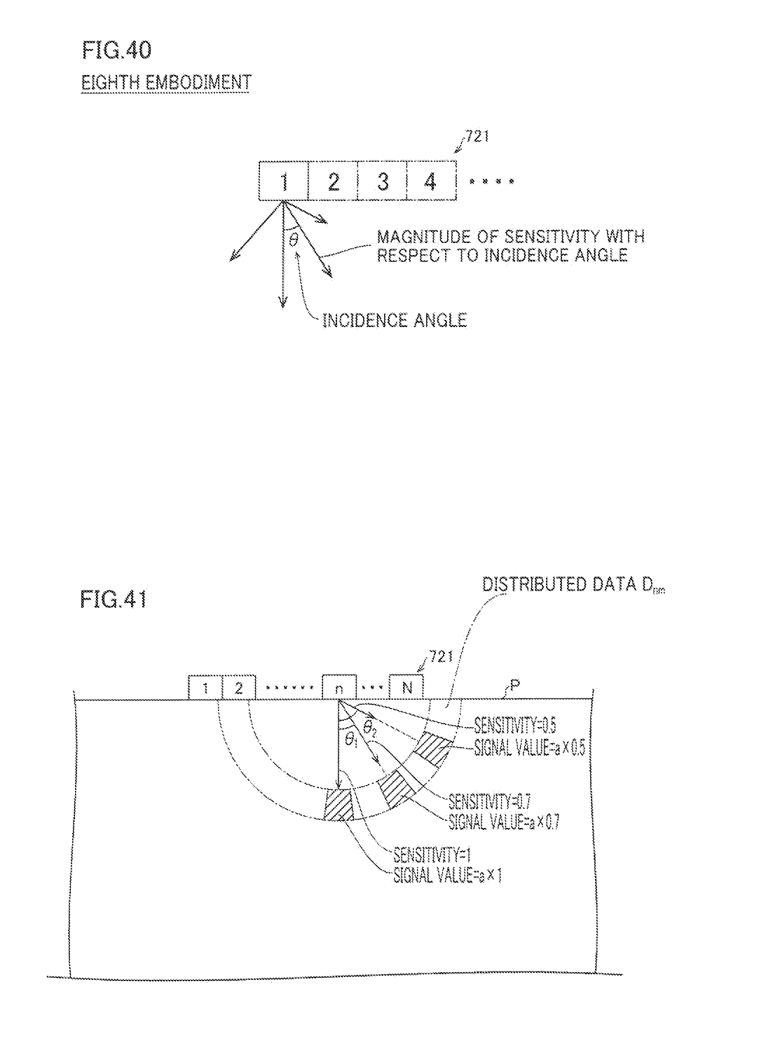

As shown in FIG. 40, the detection elements 721 are different in sensitivity (detection sensitivity) from each other by directions from which the photoacoustic wave AW (see FIG. 33) is incident (incident directions). For example, the sensitivity of the detection elements 721 each having a rectangular shape as shown in FIG. 40 is highest when the photoacoustic wave AW is incident from a direction vertical to detection surfaces of the detection elements 721. As an incidence angle θ that is an angle formed by the direction vertical to the detection surfaces and the incident direction of the photoacoustic wave AW increases, the sensitivity decreases. In FIG. 40, the magnitude of the sensitivity with respect to the incidence angle θ of a first detection element 721 is conceptually expressed by the lengths of arrows.

According to the eighth embodiment, the backprojection portion 846 is configured to generate signal distribution data in an imaging region AR (see FIG. 37) in consideration of the sensitivity caused by the incident direction of the photoacoustic wave AW with respect to the detection elements 721 when performing backprojection on the basis of N-M coordinate data after correction (see FIG. 36), as shown in FIG. 32.

Specifically, the backprojection portion 846 is configured to first set the signal values of a plurality of pieces of distributed data D that are semi-annular about the detection elements 721 in consideration of the sensitivity caused by the incident direction of the photoacoustic wave AW with respect to the detection elements 721 when virtually setting the plurality of pieces of distributed data D, as shown in FIG. 41. For example, it is assumed that in distributed data Dₙₘ of an n^{th} detection element 721, a signal value (a signal value obtained by dividing a signal value Yₙₘ at a corresponding coordinate point by the area of the distributed data D) is a when the signal value Yₙₘ corresponding to the coordinate point in the N-M coordinate data is evenly distributed, the sensitivity of the detection element 721 at the incidence angle θ=0 is 1, the sensitivity at the incidence angle θ=θ₁ (0<θ₁) is 0.7, and the sensitivity at the incidence angle θ=θ₂ (θ₁<θ₂) is 0.5, as shown in FIG. 41. In this case, in a section of a semi-annular region of the distributed data Dₙₘ, corresponding to the incident direction at the incidence angle θ=0, a signal value is set to a×1, as shown in FIG. 41. Similarly, in a section corresponding to the incident direction at the incidence angle θ=θ₁, a signal value is set to a×0.7, and in a section corresponding to the incident direction at the incidence angle θ=θ₂, a signal value is set to a×0.5. In this manner, the backprojection portion 846 sets signal values in sections of the plurality of pieces of distributed data D corresponding to the incident direction at the incidence angle θ in consideration of the sensitivity caused by the incident direction of the photoacoustic wave AW with respect to the detection elements 721.

According to the eighth embodiment, the backprojection portion 846 is configured to determine the distribution of signal values in the imaging region AR on the basis of overlaps in the distributed data D set in consideration of the sensitivity caused by the incident direction of the photoacoustic wave AW with respect to the detection elements 721. A method for generating the signal distribution data by determining this distribution of the signal values is similar to that according the aforementioned seventh embodiment. Thereafter, the photoacoustic wave image based on the signal distribution data is stored in a third memory 747, similarly to the aforementioned seventh embodiment.

In other words, according to the eighth embodiment, a correction processing portion 744 corrects a reduction in the signal intensity of photoacoustic wave signals resulting from attenuation of the photoacoustic wave AW by the correction coefficient Z1 obtained by the formula (5), and the backprojection portion 846 generates the signal distribution data in the imaging region AR in consideration of the sensitivity caused by the incident direction of the photoacoustic wave AW with respect to the detection elements 721 and constructs (generates) the photoacoustic wave image on the basis of the signal distribution data.

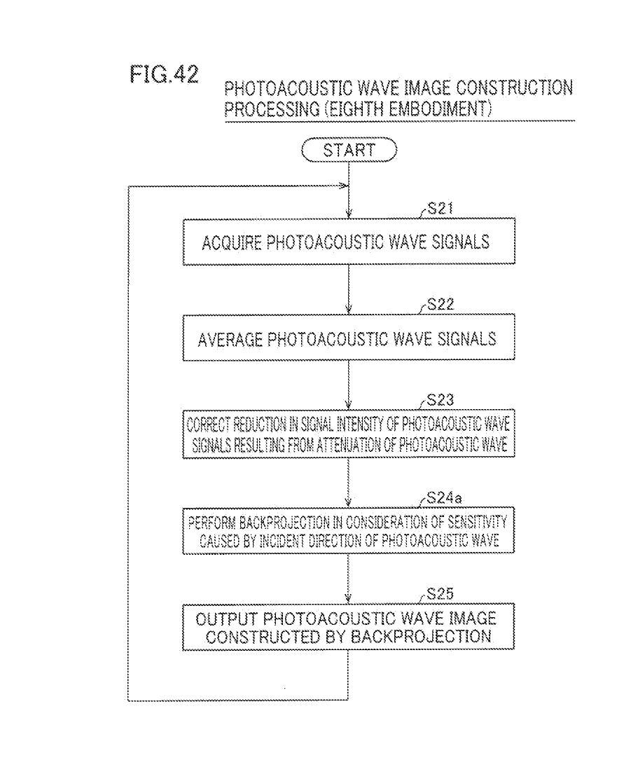

Photoacoustic wave image construction processing performed by the signal processing portion 831 of the imager body 830 according to the eighth embodiment is now described on the basis of a flowchart with reference to FIG. 42.

First, the photoacoustic wave signals are acquired at a step S21, and then a plurality (P sets) of photoacoustic wave signals are averaged at a step S22. Then, the correction processing portion 744 corrects a reduction in the signal intensity of the photoacoustic wave signals resulting from attenuation of the photoacoustic wave AW at a step S23. The processing at the steps S21 to S23 is similar to that according to the aforementioned seventh embodiment.

Then, the backprojection portion 846 performs backprojection in consideration of the sensitivity caused by the incident direction with respect to the detection elements 721 at a step S24a. Specifically, the backprojection portion 846 acquires the N-M coordinate data after correction by the correction processing portion 744, stored in a second memory 745, virtually sets the distributed data D based on the acquired N-M coordinate data, and generates the signal distribution data in the imaging region AR based on the overlaps in the set distributed data D. When virtually setting the distributed data D based on the acquired N-M coordinate data, the backprojection portion 846 virtually sets the distributed data D in consideration of the sensitivity caused by the incident direction with respect to the detection elements 721. By the processing at the steps S23 and S24a, a reduction in the signal intensity of the photoacoustic wave signals resulting from attenuation of the photoacoustic wave AW is corrected, and the signal distribution data in the imaging region AR is obtained in consideration of the sensitivity caused by the incident direction with respect to the detection elements 721. At the step S24a, the photoacoustic wave image based on the signal distribution data is constructed.

Thereafter, processing at a step S25 is performed similarly to the aforementioned seventh embodiment. Consequently, also according to the eighth embodiment, a clear photoacoustic wave image is displayed on a monitor 732. Then, the signal processing portion 831 returns to the step S21 and acquires subsequent photoacoustic wave signals.

The remaining structures of the photoacoustic imager 800 according to the eighth embodiment are similar to those of the photoacoustic imager 700 according to the aforementioned seventh embodiment.

According to the eighth embodiment, the following effects can be obtained.

According to the eighth embodiment, as hereinabove described, the signal processing portion 831 is configured to generate the photoacoustic wave image by the backprojection method in consideration of the sensitivity caused by the incident direction of the photoacoustic wave AW with respect to the detection elements 721 in addition to correcting a reduction in the signal intensity of the photoacoustic wave signals resulting from attenuation of the photoacoustic wave AW. Thus, a difference in the sensitivity of the detection elements 72 caused by the incident direction of the photoacoustic wave AW can be considered when the photoacoustic wave image is generated by the backprojection method, and hence the photoacoustic wave image closer to an actual condition in a specimen P (see FIG. 33) can be obtained. Consequently, the photoacoustic wave image closer to the actual condition in the specimen P can be obtained by considering the sensitivity caused by the incident direction of the photoacoustic wave AW with respect to the detection elements 721 while the sharpness of the photoacoustic wave image is improved by correcting a reduction in the signal intensity of the photoacoustic wave signals resulting from attenuation of the photoacoustic wave AW. Therefore, according to the eighth embodiment, the clear photoacoustic wave image closer to the actual condition in the specimen P can be obtained by the backprojection method.

The remaining effects of the photoacoustic imager 800 according to the eighth embodiment are similar to those of the photoacoustic imager 700 according to the aforementioned seventh embodiment.

### Ninth Embodiment

A ninth embodiment is now described with reference to FIGS. 32 and 43 to 47. In this ninth embodiment, a reduction in the signal intensity of photoacoustic wave signals resulting from attenuation of light from a light source portion 710 is corrected in addition to the aforementioned structure according to the seventh embodiment. Portions of a photoacoustic imager 900 similar to those of the photoacoustic imager 700 according to the aforementioned seventh embodiment are denoted by the same reference numerals as those in the seventh embodiment, and redundant description is omitted.

The photoacoustic imager 900 according to the ninth embodiment of the present invention includes the light source portion 710, a detection portion 720, and a photoacoustic imager body (hereinafter referred to as the imager body) 930, as shown in FIG. 32. The imager body 930 is provided with a signal processing portion 931. The signal processing portion 931 is similar in structure to the signal processing portion 731 according to the aforementioned seventh embodiment except that the signal processing portion 931 is provided with a correction processing portion 944.

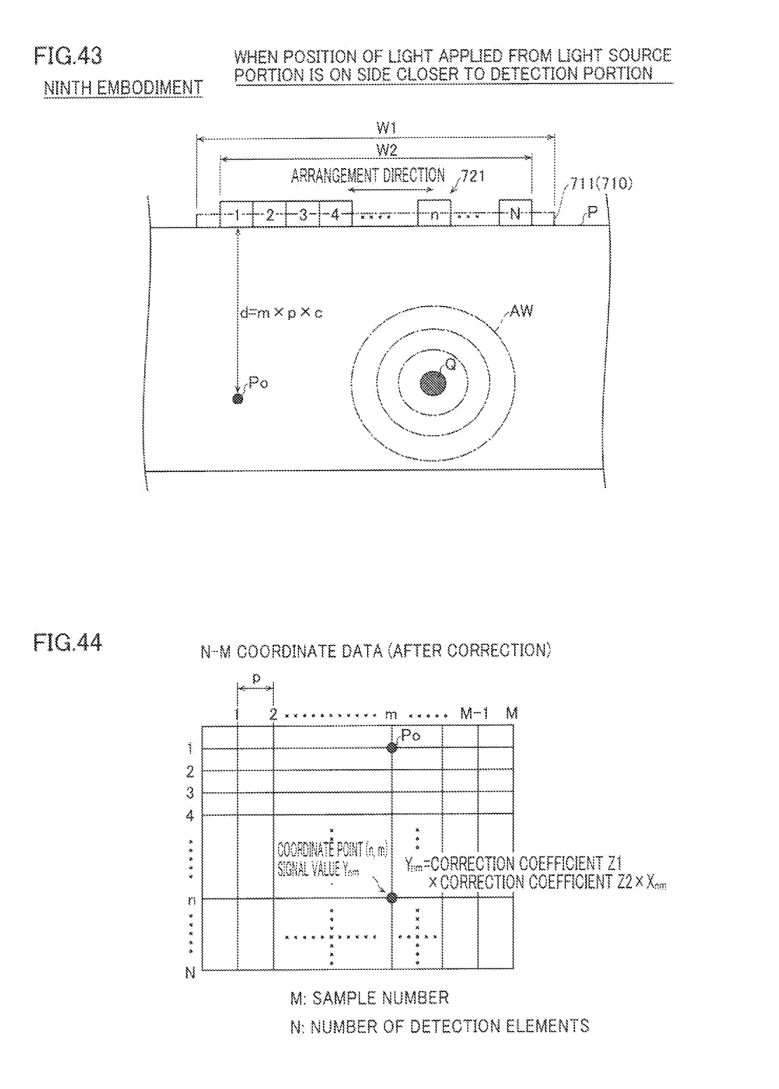

According to the ninth embodiment, the correction processing portion 944 is configured to correct a reduction in the signal intensity of the photoacoustic wave signals resulting from attenuation of the light from the light source portion 710 in addition to correcting a reduction in the signal intensity of the photoacoustic wave signals resulting from attenuation of a photoacoustic wave AW. In other words, according to the ninth embodiment, the correction processing portion 944 performs correction processing in consideration of both attenuation of the photoacoustic wave AW generated in a specimen P (see FIG. 43) before reaching detection elements 721 of the detection portion 720 and attenuation of the light applied from the light source portion 710 that is generated before reaching a detection object Q (see FIG. 43) in the specimen P.

Specifically, the correction processing portion 944 is configured to correct a reduction in the signal intensity of the photoacoustic wave signals resulting from attenuation of the photoacoustic wave AW by the correction coefficient Z1 obtained by the formula (5), similarly to the aforementioned seventh embodiment. According to the ninth embodiment, the correction processing portion 944 is further configured to correct a reduction in the photoacoustic wave signals resulting from attenuation of the light from the light source portion 710 on the basis of a distance d from the position of the light applied from the light source portion 710 to the specimen P to a prescribed position in the specimen P. According to the ninth embodiment, the distance d is obtained in correspondence to N-M coordinate data. For example, the distance d to the prescribed position Po in the specimen P shown in FIG. 43 is obtained as d=m×p×c by multiplying a detection time t=m×p at a coordinate point (1, m) in the N-M coordinate data by the velocity of sound c, as shown in FIG. 44. In other words, the distance d from the position of the light applied from the light source portion 710 to the prescribed position in the specimen P is obtained by being replaced with a distance from the detection elements 721 to the prescribed position in the specimen P. Also with respect to another coordinate point, the distance d can be obtained by the same calculation.

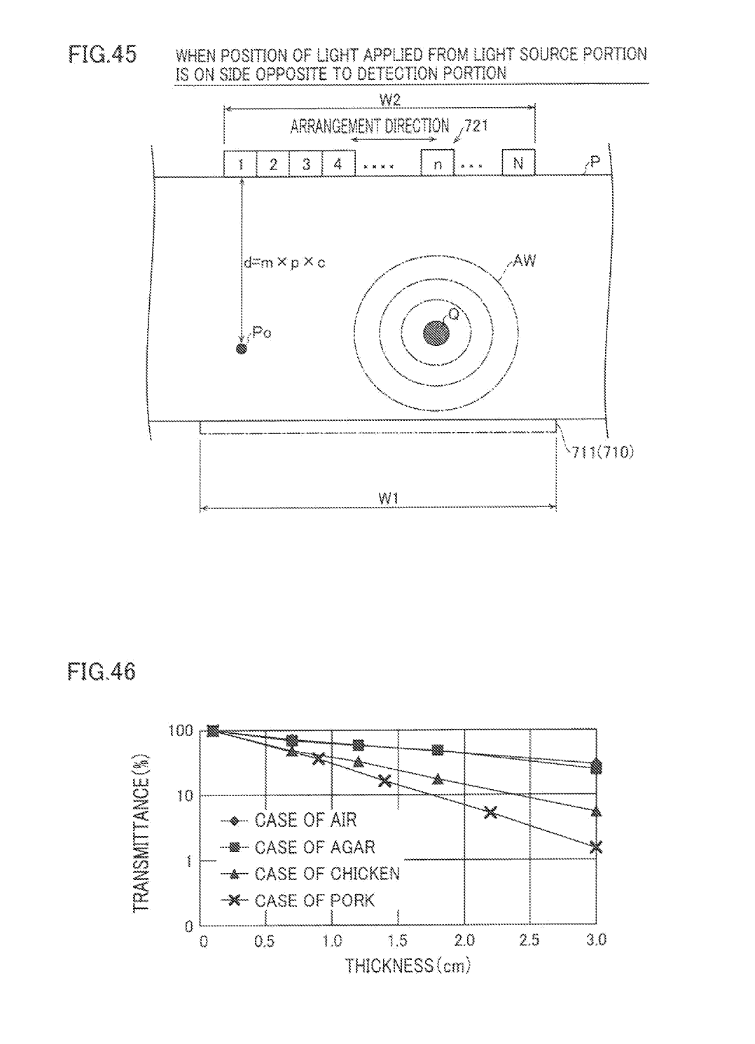

In the structure of obtaining the distance d in this manner, the width W1 of a light source 711 of the light source portion 710 in an arrangement direction in which a plurality of detection elements 721 are arranged is larger than the width W2 of all the plurality of detection elements 721 in the arrangement direction, as shown in FIGS. 43 and 45. Thus, the width W1 of the light source 711 is larger than the width W2 of the plurality of detection elements 721 in the arrangement direction, and hence the position of the light applied from the light source portion 710 can be reliably associated with the positions of the detection elements 721 even if the distance d from the position of the light applied from the light source portion 710 to the prescribed position in the specimen P is obtained by being replaced with the distance from the detection elements 721 to the prescribed position in the specimen P.

According to the ninth embodiment, the correction processing portion 944 is configured to correct a reduction in the signal intensity of the photoacoustic wave signals resulting from attenuation of the light from the light source portion 710 according to an increase in the distance d from the position of the light applied from the light source portion 710 to the prescribed position in the specimen P by multiplying the photoacoustic wave signals by a correction coefficient Z2 expressed by the following formula (6) where a constant related to the position of the light applied from the light source portion 710 is k2.

Z2=10^{k2×d} (6)

Specifically, the correction processing portion 944 is configured to correct a reduction in the signal intensity of the photoacoustic wave signals resulting from attenuation of the light from the light source portion 710 according to an increase in the distance d from the position of the light applied from the light source portion 710 to the prescribed position in the specimen P by multiplying a signal value (signal intensity) at each coordinate point in the N-M coordinate data stored in a first memory 742 by Z2, similarly to the case of the correction coefficient Z1 according to the aforementioned seventh embodiment. In other words, according to the ninth embodiment, the signal value (signal intensity) at each coordinate point in the N-M coordinate data stored in the first memory 742 is multiplied by both the correction coefficients Z1 and Z2. For example, a signal value Xₙₘ at a coordinate point (n, m) in the N-M coordinate data is multiplied by both the correction coefficients Z1 and Z2 at the coordinate point (n, m), whereby a signal value Yₙₘ (=Z1×Z2×Xₙₘ) after correction at the coordinate point (n, m) is obtained, as shown in FIG. 44. Similarly, the correction processing portion 944 acquires the N-M coordinate data after correction shown in FIG. 44 by multiplying a signal value at each of all coordinate points from a coordinate point (1, 1) to a coordinate point (N, M) in the N-M coordinate data by both the correction coefficients Z1 and Z2 at each of all the coordinate points. Then, the N-M coordinate data after correction is output from the correction processing portion 944 to a second memory 745. Thereafter, a backprojection portion 746 performs backprojection, and a photoacoustic wave image is constructed (generated), similarly to the aforementioned seventh embodiment.

As described above, the constant k2 is a constant related to the position of the light applied from the light source portion 710. More specifically, the constant k2 is a constant related to the distance d from the position of the light applied from the light source portion 710 to the specimen P to the prescribed position in the specimen P. In other words, the constant k2 is a constant for correcting attenuation of light (a reduction in light intensity) generated in the specimen P with respect to the distance d. The attenuation of light (the reduction in light intensity) generated in the specimen P with respect to the distance d is corrected, whereby a reduction in the signal intensity of the photoacoustic wave signals resulting from the attenuation of light can be corrected.

The constant k2 can be properly determined according to measurement conditions for the specimen P (a human body or another animal), a measurement site of the specimen P, or the like. In consideration of this point, the constant k2 is preferably at least 0.2 and not more than 0.8 when the position of the light applied from the light source portion 710 is on a side closer to the detection portion 720 (in other words, the light source portion 710 is arranged adjacent to the detection portion 720 so that the position of the light applied from the light source portion 710 is adjacent to the detection portion 720), as shown in FIG. 43, and a unit of the distanced (=m×p×c) is cm. When the constant k2 is a positive value, the correction coefficient Z2 is more than 1. In this case, a reduction in the signal intensity of the photoacoustic wave signals resulting from attenuation of the light from the light source portion 710 is corrected by increasing the signal intensity of the photoacoustic wave signals according to an increase in the distance d from the position of the light applied from the light source portion 710 to the prescribed position in the specimen P. In other words, in this case, a difference in relative signal intensity at each coordinate point in the N-M coordinate data caused by a reduction in the signal intensity of the photoacoustic wave signals resulting from attenuation of the light from the light source portion 710 is corrected to be reduced by increasing the signal intensity of the photoacoustic wave signals.

When the position of the light applied from the light source portion 710 is on a side opposite to the detection portion 720 (in other words, the light source portion 710 is arranged opposite to the detection portion 720 so that the position of the light applied from the light source portion 710 is opposite to the detection portion 720), as shown in FIG. 45, and a unit of the distance d is cm, the constant k2 is preferably at least −0.8 and not more than −0.2. Even when the position of the light applied from the light source portion 710 is on the side opposite to the detection portion 720, a distance from the position of virtually applied light to the prescribed position in the specimen P in the case where the position of the light applied from the light source portion 710 is on the side closer to the detection portion 720 is set to d (=m×p×c). When the constant k2 is a negative value, the correction coefficient Z2 is less than 1. In this case, a reduction in the signal intensity of the photoacoustic wave signals resulting from attenuation of the light from the light source portion 710 is corrected by reducing the signal intensity of the photoacoustic wave signals according to an increase in the distance d from the position of the virtually applied light to the prescribed position in the specimen P. In other words, a reduction in the signal intensity of the photoacoustic wave signals resulting from attenuation of the light from the light source portion 710 is corrected by reducing the signal intensity of the photoacoustic wave signals to reduce the amount of reduction in the signal intensity of the photoacoustic wave signals according to an increase in the distance from the position of the light actually applied from the light source portion 710. Thus, in this case, the difference in relative signal intensity at each coordinate point in the N-M coordinate data caused by a reduction in the signal intensity of the photoacoustic wave signals resulting from attenuation of the light from the light source portion 710 is corrected to be reduced by reducing the signal intensity of the photoacoustic wave signals.

Consequently, in the structure of obtaining the distance d by the same formula both when the position of the light applied from the light source portion 710 is on the side closer to the detection portion 720 and when the position of the light applied from the light source portion 710 is on the side opposite to the detection portion 720, the difference in relative signal intensity at each coordinate point in the N-M coordinate data can be reliably corrected to be reduced.

Results of an experiment conducted in order to determine the constant k2 are now described with reference to FIG. 46. FIG. 46 shows a semilogarithmic graph in which the horizontal axis shows a thickness (cm) and the vertical axis shows light transmittance (%) and is logarithmic. The experiment was conducted with respect to air (air space), agar, chicken, and pork. In the experiment, near infrared light (light with a center wavelength of 850 nm) was used. As shown in FIG. 46, the degree of a reduction in transmittance (attenuation of light) was smallest in the case of the air, and the degree of a reduction in transmittance (attenuation of light) was largest in the case of the pork. In the case of the pork, the thickness was 3 cm, and the transmittance was 1.5%. Therefore, the constant k2 is k2=−Log(1.5/100)/3=about 0.6 (cm⁻¹) in terms of attenuation of light per cm in the case of the pork. In the case of the air, the thickness was 3 cm, and the transmittance was 33%. Therefore, the constant k2 is k2=−Log(33/100)/3=about 0.2 (cm⁻¹) in terms of attenuation of light per cm in the case of the air. In view of attenuation of light in the specimen P such as the human body, the constant k2 is more preferably at least 0.2 and not more than 0.6 (when the position of the light applied from the light source portion 710 is on the side closer to the detection portion 720, as shown in FIG. 43) or at least −0.6 and not more than −0.2 (when the position of the light applied from the light source portion 710 is on the side opposite to the detection portion 720, as shown in FIG. 45).

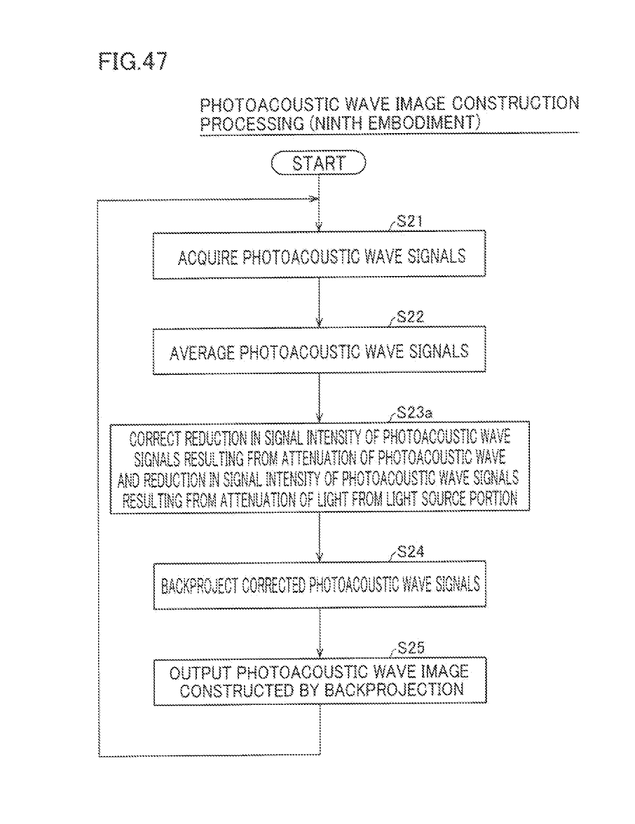

Photoacoustic wave image construction processing performed by the signal processing portion 931 of the imager body 930 according to the ninth embodiment is now described on the basis of a flowchart with reference to FIG. 47.

First, the photoacoustic wave signals are acquired at a step S21, and then a plurality (P sets) of photoacoustic wave signals are averaged at a step S22. The processing at the steps S21 and S22 is similar to that according to the aforementioned seventh embodiment.

Then, a reduction in the signal intensity of the photoacoustic wave signals resulting from attenuation of the photoacoustic wave AW is corrected while a reduction in the signal intensity of the photoacoustic wave signals resulting from attenuation of the light from the light source portion 710 is corrected at a step S23a. Specifically, the correction processing portion 944 acquires the N-M coordinate data stored in the first memory 742 and makes a correction by multiplying the signal value (signal intensity) of each coordinate point in the acquired N-M coordinate data by both the correction coefficients Z1 and Z2. Thus, the N-M coordinate data in which both a reduction in the signal intensity of the photoacoustic wave signals resulting from attenuation of the photoacoustic wave AW and a reduction in the signal intensity of the photoacoustic wave signals resulting from attenuation of the light from the light source portion 710 are corrected is obtained.

Then, the photoacoustic wave signals to which the two types of corrections have been made are backprojected at a step S24. Thereafter, processing at a step S25 is performed similarly to the aforementioned seventh embodiment. Consequently, also according to the ninth embodiment, a clear photoacoustic wave image is displayed on a monitor 732. Then, the signal processing portion 931 returns to the step S21 and acquires subsequent photoacoustic wave signals.

The remaining structures of the photoacoustic imager 900 according to the ninth embodiment are similar to those of the photoacoustic imager 700 according to the aforementioned seventh embodiment.

According to the ninth embodiment, the following effects can be obtained.

According to the ninth embodiment, as hereinabove described, the signal processing portion 931 is configured to correct a reduction in the signal intensity of the photoacoustic wave signals resulting from attenuation of the light from the light source portion 710 according to an increase in the distance d from the position of the light applied from the light source portion 710 to the specimen P to the prescribed position (Po) in the specimen P in addition to correcting a reduction in the signal intensity of the photoacoustic wave signals resulting from attenuation of the photoacoustic wave AW. Thus, even if the light from the light source portion 710 attenuates before reaching the detection object Q in the specimen P, a reduction in the signal intensity of the photoacoustic wave signals resulting from attenuation of the light from the light source portion 710 can be corrected. Consequently, a reduction in the signal intensity of the photoacoustic wave signals resulting from attenuation of the light from the light source portion 710 can be corrected in addition to correcting a reduction in the signal intensity of the photoacoustic wave signals resulting from attenuation of the photoacoustic wave AW. Therefore, a reduction in the signal intensity of the photoacoustic wave signals can be more properly corrected. Thus, according to the ninth embodiment, a clearer photoacoustic wave image can be obtained by backprojection.

According to the ninth embodiment, as hereinabove described, the signal processing portion 931 is configured to correct a reduction in the signal intensity of the photoacoustic wave signals resulting from attenuation of the light from the light source portion 710 according to an increase in the distance d from the position of the applied light to the prescribed position in the specimen P by multiplying the photoacoustic wave signals by the correction coefficient Z2 expressed by the aforementioned formula (6). Thus, a reduction in the signal intensity of the photoacoustic wave signals resulting from attenuation of the light from the light source portion 710 can be reliably corrected according to a reduction (the amount of reduction) in the signal intensity resulting from attenuation of the light from the light source portion 710 by the aforementioned formula (6).

According to the ninth embodiment, as hereinabove described, the constant k2 is set to at least 0.2 and not more than 0.8 when the position of the light applied from the light source portion 710 is on the side closer to the detection portion 720 and a unit of the distance d from the position of the applied light to the prescribed position in the specimen P is cm. Furthermore, the constant k2 is set to at least −0.8 and not more than −0.2 when the position of the light applied from the light source portion 710 is on the side opposite to the detection portion 720, the distance from the position of the light applied from the light source portion 710 to the prescribed position in the specimen P in the case where the position of the applied light is on the side closer to the detection portion 720 is set to d, and a unit of the distance d from the position of the applied light to the prescribed position in the specimen P is cm. Thus, the correction coefficient Z2 can be properly acquired according to the position of the light applied from the light source portion 710. Consequently, the signal intensity of the photoacoustic wave signals reduced by attenuation of the light from the light source portion 710 can be properly increased.

According to the ninth embodiment, as hereinabove described, the width W1 of the light source portion 710 in the arrangement direction in which the plurality of detection elements 721 are arranged is larger than the width W2 of the plurality of detection elements 721 in the arrangement direction. Thus, the light from the light source portion 710 can be reliably applied to an entire region of the plurality of detection elements 721 in the arrangement direction. Consequently, insufficient generation of the photoacoustic wave AW from the detection object Q in a range detectable by the plurality of detection elements 721 caused by a small amount of applied light in the range detectable by the plurality of detection elements 721 can be significantly reduced or prevented. Thus, the plurality of detection elements 721 can properly detect the detection object Q in the range detectable by the plurality of detection elements 721.

The remaining effects of the photoacoustic imager 900 according to the ninth embodiment are similar to those of the photoacoustic imager 700 according to the aforementioned seventh embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the control portion is provided separately from the signal processing portion in each of the aforementioned first to ninth embodiments, the present invention is not restricted to this. According to the present invention, the control portion may alternatively perform a portion of the function of the signal processing portion.

While two of a reduction in the signal intensity of the photoacoustic wave signals resulting from attenuation of the photoacoustic wave AW and a reduction in the signal intensity of the photoacoustic wave signals resulting from attenuation of the light from the light source portion are corrected in the aforementioned second embodiment, and two of a reduction in the signal intensity of the photoacoustic wave signals resulting from attenuation of the photoacoustic wave and a reduction in the signal intensity of the photoacoustic wave signals resulting from the sensitivity of the detection elements are corrected in the aforementioned third embodiment, the present invention is not restricted to this. According to the present invention, three of a reduction in the signal intensity of the photoacoustic wave signals resulting from attenuation of the photoacoustic wave, a reduction in the signal intensity of the photoacoustic wave signals resulting from attenuation of the light from the light source portion, and a reduction in the signal intensity of the photoacoustic wave signals resulting from the sensitivity of the detection elements may alternatively be corrected. Thus, a clearer image can be obtained by phasing addition.

While a reduction in the signal intensity of the photoacoustic wave signals resulting from attenuation of the photoacoustic wave is corrected on the basis of both the detection time and the signal frequency in each of the aforementioned first to third and seventh to ninth embodiments, the present invention is not restricted to this. According to the present invention, a reduction in the signal intensity of the photoacoustic wave signals resulting from attenuation of the photoacoustic wave may alternatively be corrected on the basis of at least one of the detection time and the signal frequency.

While the plurality of (N) amplification portions and the plurality of (N) A-D conversion portions are provided in the receiving portion in correspondence to the plurality of (N) detection elements of the detection portion in each of the aforementioned first to third and seventh to ninth embodiments, the present invention is not restricted to this. According to the present invention, the amplification portions and the A-D conversion portions fewer in number than the plurality of detection elements of the detection portion may alternatively be provided in the receiving portion. In this case, the N photoacoustic wave signals detected by the plurality of detection elements of the detection portion may be received in plural batches. Thus, the structure of the receiving portion can be simplified, and hence the structure of the photoacoustic imager can be simplified.

While one light source is provided in the light source portion in each of the aforementioned first to third and seventh to ninth embodiments, the present invention is not restricted to this. According to the present invention, a plurality of light sources may alternatively be provided in the light source portion, and the plurality of light sources may alternatively be capable of emitting light with wavelengths different from each other. In this case, photoacoustic wave signals caused by the light with the wavelengths or a synthetic photoacoustic wave signal obtained by synthesizing the photoacoustic wave signals caused by the light with the wavelengths may be corrected, and a photoacoustic wave image may be generated by phasing addition or the backprojection method. Thus, also in the structure of obtaining a plurality of photoacoustic wave signals by the light with the wavelengths, as compared with the case where the photoacoustic wave image is obtained on the basis of the photoacoustic wave signals caused by the light with a single wavelength, a photoacoustic wave image containing more diverse information about the inside of a specimen can be obtained while the photoacoustic wave image is made clear by phasing addition or the backprojection method.

While the correction coefficient Z1 expressed by the formula (1) is employed for correction in the aforementioned first embodiment, and the correction coefficient Z1 expressed by the formula (1) and the correction coefficient Z2 expressed by the formula (2) are employed for correction in the aforementioned second embodiment, the present invention is not restricted to this. According to the present invention, the formulae for the correction coefficients Z1 and Z2 may alternatively be simplified. In the case of the aforementioned first embodiment, for example, the correction coefficient Z1 may be simplified to Z1=2.3×(1+(k1×t×f)). In the case of the aforementioned second embodiment, the correction coefficient Z1×Z2 may be simplified to Z1×Z2=2.3×(1+(k1×t×f)+(k2×d)). Thus, the formulae for the correction coefficients are simplified, and hence the time for the correction processing can be reduced.

While the projection signals are corrected on the basis of both the detection time and the signal frequency to respond to a reduction in the signal intensity of the photoacoustic wave signals resulting from attenuation of the photoacoustic wave in each of the aforementioned fourth to sixth embodiments, the present invention is not restricted to this. According to the present invention, the projection signals may alternatively be corrected on the basis of at least one of the detection time and the signal frequency to respond to a reduction in the signal intensity of the photoacoustic wave signals resulting from attenuation of the photoacoustic wave.

While the initial evaluation image that is the first evaluation image is generated by performing the processing employing the analytical method on the photoacoustic wave signals in each of the aforementioned fourth to sixth embodiments, the present invention is not restricted to this. According to the present invention, the initial evaluation image that is the first evaluation image may alternatively be generated by other than performing the processing employing the analytical method on the photoacoustic wave signals. For example, the initial evaluation image may be generated without performing the processing employing the analytical method such that all the signal values have the same prescribed value (zero, for example).

While the example of making a correction to respond to a reduction in the signal intensity of the photoacoustic wave signals resulting from attenuation of the light from the light source portion (fifth embodiment) and the example of making a correction to respond to a reduction in the signal intensity of the photoacoustic wave signals resulting from the sensitivity of the detection elements (sixth embodiment) are shown separately in the aforementioned fifth and sixth embodiments, the present invention is not restricted to this. According to the present invention, in combination of the fifth embodiment and the sixth embodiment, three of a reduction in the signal intensity of the photoacoustic wave signals resulting from attenuation of the photoacoustic wave, a reduction in the signal intensity of the photoacoustic wave signals resulting from attenuation of the light from the light source portion, and a reduction in the signal intensity of the photoacoustic wave signals resulting from the sensitivity of the detection elements may alternatively be corrected simultaneously.

While the plurality of (N) A-D conversion portions are provided in the receiving portion in correspondence to the plurality of (N) detection elements of the detection portion in each of the aforementioned fourth to sixth embodiments, the present invention is not restricted to this. According to the present invention, the A-D conversion portions fewer in number than the plurality of detection elements of the detection portion may alternatively be provided in the receiving portion.

While the correction coefficient Z1 expressed by the formula (3) is employed for correction in the aforementioned fourth embodiment, and the correction coefficient Z1 expressed by the formula (3) and the correction coefficient Z2 expressed by the formula (4) are employed for correction in the aforementioned fifth embodiment, the present invention is not restricted to this. According to the present invention, the formulae for the correction coefficients Z1 and Z2 may alternatively be simplified. In the case of the aforementioned fourth embodiment, for example, the correction coefficient Z1 may be simplified to Z1=2.3×(1−(k1×t×f)). In the case of the aforementioned fifth embodiment, the correction coefficient Z1×Z2 may be simplified to Z1×Z2=2.3×(1−(k1×t×f)−(k2×d)). Thus, the formulae for the correction coefficients are simplified, and hence the time for the correction processing can be reduced.

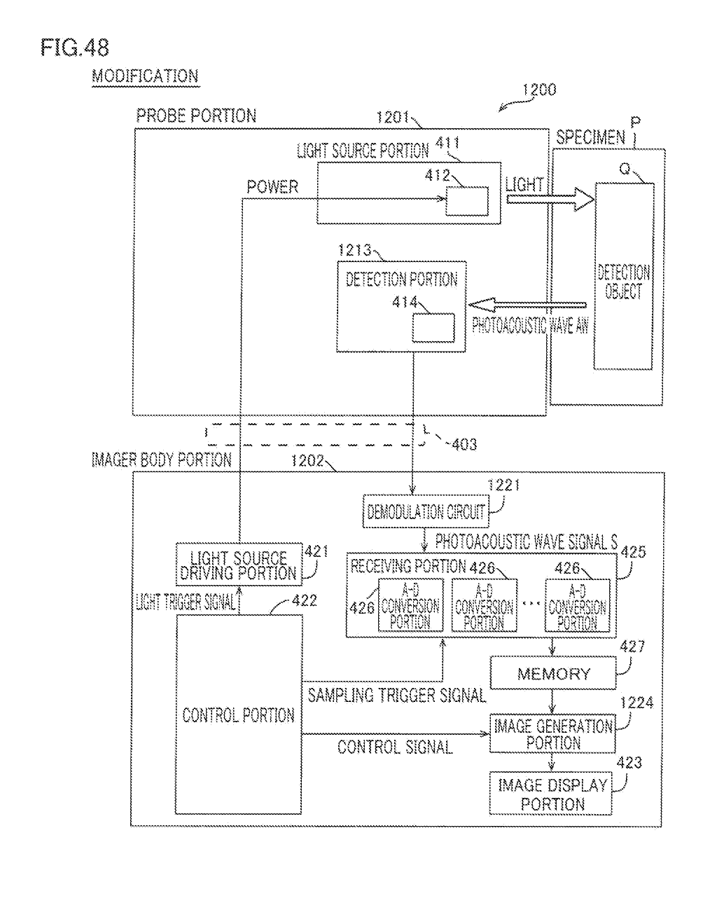

While the detection portion generates the photoacoustic wave signals including the RF signals in each of the aforementioned fourth to sixth embodiments, the present invention is not restricted to this. According to the present invention, the detection portion may alternatively be configured to generate RF signals, and the photoacoustic imager may alternatively be configured to generate photoacoustic wave signals including demodulation (detection) signals obtained by demodulating (detecting) the RF signals. As in a modification shown in FIG. 48, for example, a detection portion 1213 may generate RF signals, and a demodulation (detection) circuit 1221 may demodulate (detect) the RF signals to generate photoacoustic wave signals S including demodulation (detection) signals.

A photoacoustic imager 1200 according to the modification includes a probe portion 1201 and an imager body portion 1202, and the probe portion 1201 includes the detection portion 1213. The imager body portion 1202 includes the demodulation circuit 1221 and an image generation portion 1224. The demodulation circuit 1221 is configured to demodulate signals including the RF signals acquired from the detection portion 1213. For example, the demodulation circuit 1221 generates the demodulation signals that are signals of envelope components (excluding modulation components or the like) in the waveform of the RF signals. The demodulation circuit 1221 is further configured to transmit the photoacoustic wave signals S including the demodulation signals to a receiving portion 425. The image generation portion 1224 is configured to generate a photoacoustic wave image R by processing employing a statistical method based on the photoacoustic wave signals S including the demodulation signals. Thus, the data capacity of the demodulation signals is smaller than that of the RF signals, and hence due to a reduction in data capacity, the capacity of a memory (such as a memory 427) included in the photoacoustic imager 1200 can be reduced.

While a reduction in the signal intensity of the photoacoustic wave signals resulting from attenuation of the photoacoustic wave AW is corrected and backprojection is performed in consideration of the sensitivity caused by the incident direction of the photoacoustic wave AW with respect to the detection elements 721 in the aforementioned eighth embodiment, and two of a reduction in the signal intensity of the photoacoustic wave signals resulting from attenuation of the photoacoustic wave AW and a reduction in the signal intensity of the photoacoustic wave signals resulting from attenuation of the light from the light source portion 710 are corrected and backprojection is performed in the aforementioned ninth embodiment, the present invention is not restricted to this. According to the present invention, two of a reduction in the signal intensity of the photoacoustic wave signals resulting from attenuation of the photoacoustic wave and a reduction in the signal intensity of the photoacoustic wave signals resulting from attenuation of the light from the light source portion may alternatively be corrected, and backprojection may alternatively be performed in consideration of the sensitivity caused by the incident direction of the photoacoustic wave with respect to the detection elements. Thus, a clearer image closer to an actual condition in a specimen can be obtained by backprojection.

While the correction coefficient Z1 expressed by the formula (5) is employed for correction in the aforementioned seventh embodiment, and the correction coefficient Z1 expressed by the formula (5) and the correction coefficient Z2 expressed by the formula (6) are employed for correction in the aforementioned ninth embodiment, the present invention is not restricted to this. According to the present invention, the formulae for the correction coefficients Z1 and Z2 may alternatively be simplified. In the case of the aforementioned seventh embodiment, for example, the correction coefficient Z1 may be simplified to Z1=h×t×2.3×(1+(k1×t×f)). In the case of the aforementioned ninth embodiment, the correction coefficient Z1×Z2 may be simplified to Z1×Z2=h×t×2.3×(1+(k1×t×f)+(k2×d)). Thus, the formulae for the correction coefficients are simplified, and hence the time for the correction processing can be reduced.

While the processing operations performed by the signal processing portion according to the present invention are described, using the flowcharts described in a flow-driven manner in which processing is performed in order along a processing flow for the convenience of illustration in each of the aforementioned first to ninth embodiments, the present invention is not restricted to this. According to the present invention, the processing operations performed by the signal processing portion may alternatively be performed in an event-driven manner in which processing is performed on an event basis. In this case, the processing operations performed by the signal processing portion may be performed in a complete event-driven manner or in a combination of an event-driven manner and a flow-driven manner.

What is claimed is:

1. A photoacoustic imager comprising:
a light source portion;
a detection portion that detects a photoacoustic wave signal caused by a photoacoustic wave generated from a detection object in a specimen that absorbs light applied from the light source portion; and
a signal processing portion that corrects a reduction in signal intensity of the photoacoustic wave signal resulting from attenuation of the photoacoustic wave and generates a photoacoustic wave image by prescribed signal processing.

2. The photoacoustic imager according to claim 1, wherein
the signal processing portion is configured to correct the reduction in the signal intensity of the photoacoustic wave signal resulting from the attenuation of the photoacoustic wave on the basis of at least one of a detection time required for the detection portion to detect the photoacoustic wave signal and a signal frequency of the photoacoustic wave signal.

3. The photoacoustic imager according to claim 2, wherein
the signal processing portion is configured to correct the reduction in the signal intensity of the photoacoustic wave signal resulting from the attenuation of the photoacoustic wave by increasing the signal intensity of the photoacoustic wave signal according to an increase in a value of at least one of the detection time and the signal frequency.

4. The photoacoustic imager according to claim 1, wherein
the prescribed signal processing comprises phasing addition, and
the signal processing portion is configured to correct the reduction in the signal intensity of the photoacoustic wave signal resulting from the attenuation of the photoacoustic wave and to generate the photoacoustic wave image by performing the phasing addition on the photoacoustic wave signal that is corrected.

5. The photoacoustic imager according to claim 4, wherein
the signal processing portion is configured to increase the signal intensity of the photoacoustic wave signal according to increases in values of a detection time required for the detection portion to detect the photoacoustic wave signal and a signal frequency of the photoacoustic wave signal by multiplying the photoacoustic wave signal by a correction coefficient Z1 expressed by a following formula (1), Z1=10^{k1×t×f} . . . (1), where the detection time is t, the signal frequency is f, a constant related to the detection time and the signal frequency is k1, a unit of the detection time t is μs, a unit of the signal frequency f is MHz, and the constant k1 is at least 0.002 and not more than 0.009.

6. The photoacoustic imager according to claim 4, wherein
the detection portion includes a detection element configured to receive the photoacoustic wave and detect the photoacoustic wave signal caused by the photoacoustic wave, and
the signal processing portion is configured to correct a reduction in the signal intensity of the photoacoustic wave signal resulting from sensitivity of the detection element on the basis of the sensitivity caused by an incident direction of the photoacoustic wave with respect to the detection element in addition to correcting the reduction in the signal intensity of the photoacoustic wave signal resulting from the attenuation of the photoacoustic wave.

7. The photoacoustic imager according to claim 1, wherein
the prescribed signal processing comprises processing employing a statistical method for making an approximation while repetitively performing
signal conversion processing for generating an evaluation image with which an evaluation is made by comparison with the photoacoustic wave signal and converting the evaluation image that is generated into a projection signal to be compared with the photoacoustic wave signal, and
processing for generating the evaluation image that is new by performing imaging processing for imaging a signal based on a result of comparison between the projection signal of the evaluation image and the photoacoustic wave signal, and
the signal processing portion is configured to correct signal intensity of the projection signal of the evaluation image to respond to the reduction in the signal intensity of the photoacoustic wave signal resulting from the attenuation of the photoacoustic wave during the signal conversion processing and to generate the photoacoustic wave image by the statistical method.

8. The photoacoustic imager according to claim 7, wherein
the signal processing portion is configured to correct the signal intensity of the projection signal of the evaluation image to respond to the reduction in the signal intensity of the photoacoustic wave signal resulting from the attenuation of the photoacoustic wave by reducing the signal intensity of the projection signal of the evaluation image according to an increase in a value of at least one of a detection time required for the detection portion to detect the photoacoustic wave signal and a signal frequency of the photoacoustic wave signal during the signal conversion processing.

9. The photoacoustic imager according to claim 1, wherein
the prescribed signal processing comprises a backprojection method, and
the signal processing portion is configured to correct the reduction in the signal intensity of the photoacoustic wave signal resulting from the attenuation of the photoacoustic wave and to generate the photoacoustic wave image by the backprojection method on the basis of the photoacoustic wave signal that is corrected.

10. The photoacoustic imager according to claim 9, wherein
the signal processing portion is configured to increase the signal intensity of the photoacoustic wave signal according to increases in values of a detection time required for the detection portion to detect the photoacoustic wave signal and a signal frequency of the photoacoustic wave signal by multiplying the photoacoustic wave signal by a correction coefficient Z1 expressed by a following formula (2), Z1=h×t×10^{k1×t×f} . . . (2), where a constant related to velocity of sound is h, the detection time is t, the signal frequency is f, a constant related to the detection time and the signal frequency is k1, a unit of the detection time t is μs, a unit of the signal frequency f is MHz, and the constant k1 is at least 0.002 and not more than 0.009.

11. The photoacoustic imager according to claim 1, wherein
the signal processing portion is configured to correct a reduction in the signal intensity of the photoacoustic wave signal resulting from attenuation of the light applied from the light source portion according to an increase in a distance from a position of the light applied from the light source portion to the specimen to a prescribed position in the specimen in addition to correcting the reduction in the signal intensity of the photoacoustic wave signal resulting from the attenuation of the photoacoustic wave.

12. The photoacoustic imager according to claim 11, wherein
the signal processing portion is configured to correct the reduction in the signal intensity of the photoacoustic wave signal resulting from the attenuation of the light applied from the light source portion according to the increase in the distance from the position of the light applied from the light source portion to the prescribed position in the specimen by multiplying the photoacoustic wave signal by a correction coefficient Z2 expressed by a following formula (3), Z2=10^{k2×d} . . . (3), where a constant related to the position of the light applied from the light source portion is k2 and the distance from the position of the light applied from the light source portion to the prescribed position in the specimen is d.

13. The photoacoustic imager according to claim 12, wherein
the constant k2 is at least 0.2 and not more than 0.8 when the position of the light applied from the light source portion is on a side closer to the detection portion and a unit of the distance d from the position of the light applied from the light source portion to the prescribed position in the specimen is cm, and
the constant k2 is at least −0.8 and not more than −0.2 when the position of the light applied from the light source portion is on a side opposite to the detection portion, the distance from the position of the light applied from the light source portion to the prescribed position in the specimen in a case where the position of the light applied from the light source portion is on the side closer to the detection portion is d, and the unit of the distance d from the position of the light applied from the light source portion to the prescribed position in the specimen is cm.

14. The photoacoustic imager according to claim 1, wherein
a plurality of detection elements configured to receive the photoacoustic wave and detect the photoacoustic wave signal caused by the photoacoustic wave are arranged in the detection portion, and
a width of the light source portion in an arrangement direction in which the plurality of detection elements are arranged is larger than a width of the plurality of detection elements in the arrangement direction.

15. The photoacoustic imager according to claim 1, wherein
the light source portion includes at least one of a light-emitting diode element, a semiconductor laser element, and an organic light-emitting diode element as a light source.

16. A photoacoustic imager comprising:
a light source portion that applies light to a specimen;
a detection portion that detects a photoacoustic wave signal caused by a photoacoustic wave generated by absorption of the light applied from the light source portion to the specimen by a detection object in the specimen; and
a signal processing portion that generates a photoacoustic wave image by processing employing a statistical method for making an approximation while repetitively performing signal conversion processing for generating an evaluation image with which an evaluation is made by comparison with the photoacoustic wave signal and converting the evaluation image that is generated into a projection signal to be compared with the photoacoustic wave signal and processing for generating the evaluation image that is new by performing imaging processing for imaging a signal based on a result of comparison between the projection signal of the evaluation image and the photoacoustic wave signal, wherein
the signal processing portion is configured to correct signal intensity of the projection signal of the evaluation image to respond to a reduction in signal intensity of the photoacoustic wave signal resulting from attenuation of the photoacoustic wave during the signal conversion processing.

17. The photoacoustic imager according to claim 16, wherein
the signal processing portion is configured to correct the signal intensity of the projection signal of the evaluation image to respond to the reduction in the signal intensity of the photoacoustic wave signal resulting from the attenuation of the photoacoustic wave by reducing the signal intensity of the projection signal of the evaluation image according to an increase in a value of at least one of a detection time required for the detection portion to detect the photoacoustic wave signal and a signal frequency of the photoacoustic wave signal during the signal conversion processing.

18. The photoacoustic imager according to claim 17, wherein
the signal processing portion is configured to reduce the signal intensity of the projection signal of the evaluation image according to increases in values of the detection time and the signal frequency by multiplying the projection signal of the evaluation image by a correction coefficient Z1 expressed by a following formula (4), Z1=10^{-(k1×t×f)} . . . (4), where the detection time is t, the signal frequency is f, a constant related to the detection time and the signal frequency is k1, a unit of the detection time t is μs, a unit of the signal frequency f is MHz, and the constant k1 is at least 0.002 and not more than 0.009.

19. The photoacoustic imager according to claim 16, wherein
the signal processing portion is configured to generate an initial evaluation image that is a first evaluation image by performing processing employing an analytical method on the photoacoustic wave signal.

20. A photoacoustic image construction method comprising:
detecting, by a detection portion, a photoacoustic wave signal caused by a photoacoustic wave generated from a detection object in a specimen that absorbs light applied from a light source portion; and
correcting, by a signal processing portion, a reduction in signal intensity of the photoacoustic wave signal resulting from attenuation of the photoacoustic wave and generating, by the signal processing portion, a photoacoustic wave image by prescribed signal processing.
